(19) United States
(12) Patent Application Publication
(10) Pub. No.: US 2026/0055215 A1
(43) Pub. Date: Feb. 26, 2026

(54) CATALYST SYSTEMS AND PROCESSES FOR CYCLIC POLY ALPHA-OLEFINS

(71) Applicant: EXXONMOBIL TECHNOLOGY AND ENGINEERING COMPANY, Baytown, TX (US)

(72) Inventors: Jo Ann M. CANICH, Baytown, TX (US); Alexander V. ZABULA, Baytown, TX (US); Jarod M. YOUNKER, Baytown, TX (US); Peijun JIANG, Baytown, TX (US); Laughlin G. MCCULLOUGH, Baytown, TX (US); Alex E. CARPENTER, Baytown, TX (US); Danielle G. SINGLETON, Baytown, TX (US); Torin J. DUPPER, Baytown, TX (US); Dwight L. VINCENT, Baytown, TX (US); Sarah A. KHEIR, Baytown, TX (US)

(21) Appl. No.: 19/112,165

(22) PCT Filed: Sep. 14, 2023
(86) PCT No.: PCT/US2023/074237

§ 371 Date: Mar. 14, 2025

Related U.S. Application Data
(60) Provisional application No. 63/407,608, filed on Sep. 16, 2022.

(51) Int. Cl. C08F 10/14; C08F 4/6592

(52) U.S. Cl. CPC C08F 10/14; C08F 4/65927; C08F 2410/01; C08F 2420/10

(57) ABSTRACT

The present disclosure relates to cyclic poly alpha-olefin (PAO) materials prepared from alpha-olefins, and processes for making them.

### CROSS-REFERENCE TO RELATED APPLICATION

This application claims the benefit of U.S. Provisional Patent Application No. 63/407,608, filed on Sep. 16, 2022, which is incorporated by reference herein in its entirety.

### TECHNICAL FIELD

The present disclosure relates to cyclic poly alpha-olefin (PAO) materials prepared from alpha-olefins, and processes for making them. In particular, the present disclosure relates to ethylenically unsaturated cyclic PAO materials and saturated cyclic PAO materials derived from polymerization of alpha-olefins in the presence of a catalyst system comprising a metallocene-compound specifically designed to yield a cyclic PAO composition high in dimer content.

### BACKGROUND

Poly alpha-olefins (PAOs) are typically produced from the oligomerization of linear alpha-olefins. These unsaturated poly alpha-olefins (uPAOs) can be used as intermediates for making various specialty chemicals because of the reactivity of the C═C double bond present in the molecular structure of the oligomer molecules. For example, various chemical functional groups can be bonded to the carbon backbone of a uPAO molecule when a chemical agent reactive with the C═C bond is allowed to contact the uPAO. The functional group thus introduced onto the PAO structure can bring about unique properties to the functionalized and saturated PAO molecules. Hydrogenated uPAOs are useful as lubricating oil compositions, such as those used in internal combustion engines, automotive grease oils, industrial grease oils, gear box oils, and the like.

### SUMMARY

One aspect of the disclosure relates to a process for making a poly alpha-olefin (PAO) from two or more different alpha-olefins, wherein at least one of the alpha-olefins is a cyclic alpha-olefin and at least one of the alpha-olefins is a linear or branched alpha-olefin. The process can include a step of contacting a feed comprising one or more C₆-C₃₂ cyclic alpha-olefins and one or more C₄-C₃₂ linear and/or branched alpha-olefins with a catalyst system comprising a metallocene compound in a polymerization reactor under polymerization conditions to effect a polymerization reaction to obtain a polymerization reaction mixture comprising a mixture of PAO molecules having vinylidenes, tri-substituted vinylenes, di-substituted vinylenes, and optionally vinyl unsaturation. The process can also include a step of obtaining an unsaturated PAO product from the polymerization reaction mixture, with the unsaturated PAO product comprising a mixture of PAO molecules having vinylidenes, tri-substituted vinylenes, di-substituted vinylenes, optionally vinyl unsaturation, and, optionally, is substantially free of the alpha-olefin feed. When cyclic alpha-olefins with ring unsaturation such as 4-vinylcyclohex-1-ene, are used as the cyclic alpha-olefin, the PAO product can also contain endocyclic di-substituted vinylenes. This type of unsaturation is referred to as cyclic di-substituted vinylenes.

Another aspect of the disclosure relates to a process for making alpha-olefin dimers and trimers from two or more alpha-olefins, wherein at least one alpha-olefin is a cyclic alpha-olefin and at least one alpha-olefin is a linear or branched alpha-olefin. The process can include a step of contacting a feed containing one or more C₆-C₃₂ cyclic alpha-olefins and one or more C₄-C₃₂ linear and/or branched alpha-olefins with a catalyst system comprising a metallocene compound in a polymerization reactor under polymerization conditions to effect a polymerization reaction to obtain a polymerization reaction mixture comprising dimer and/or trimer molecules having vinylidenes, tri-substituted vinylenes, di-substituted vinylenes and optionally vinyl unsaturation. The process can also include a step of obtaining an unsaturated dimer and/or trimer product from the polymerization reaction mixture, with the unsaturated dimer and/or trimer product having vinylidenes, tri-substituted vinylenes, di-substituted vinylenes, optionally vinyl unsaturation, and, optionally, is substantially free of the alpha-olefin feed. When cyclic alpha-olefins with ring unsaturation such as 4-vinylcyclohex-1-ene, are used as the cyclic alpha-olefin, the dimer and/or trimer product can contain endocyclic di-substituted vinylenes. This type of unsaturation is referred to as cyclic di-substituted vinylenes.

Another aspect of the disclosure relates to a process for making alpha-olefin dimers and/or trimers from two or more different alpha-olefins, wherein at least one alpha-olefin is a cyclic alpha-olefin and at least a second alpha-olefin is a linear or branched alpha-olefin, and the product comprises unsaturated dimers and/or trimers, respectively.

Another aspect of the disclosure relates to a process for making alpha-olefin dimers and/or trimers (preferably dimers) from two or more different alpha-olefins, wherein at least one of the alpha-olefins is a cyclic alpha-olefin and at least a second alpha-olefin is a linear or branched alpha-olefin, and the product produced has a selectivity for producing dimers of at least about 50% of the total product mixture, at least about 60% of the total product mixture, at least about 70% of the total product mixture, at least about 80% of the total product mixture, at least about 90% of the total product mixture, or at least about 95% of the total product mixture.

The present disclosure also relates to a process for the dimerization of cyclic alpha-olefins to produce cyclic dimers. In particular, the present disclosure relates to ethylenically unsaturated cyclic dimers and saturated cyclic dimers derived from dimerization of cyclic alpha-olefins in the presence of a catalyst system comprising a metallocene-compound specifically designed to yield a cyclic dimer composition having vinylidene, tri-substituted vinylene, di-substituted vinylene, and optionally vinyl unsaturation.

In any embodiment herein, the process can include the use of a metallocene compound (e.g., any described herein). In some embodiments, the metallocene compound is represented by formula (I), (II), (III), (IV), or (V), as described herein. In some embodiments, least one of R¹ and R³ is not hydrogen in formula (I) or (II).

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

F FIG. 1 depicts two reaction pathways in which 4-vinylcyclohex-1-ene (VCH) undergoes a chain transfer process and yields a bicyclic product.

FIG. 2 depicts two reaction pathways in which VCH undergoes a chain transfer process with an alpha-olefin represented as CH₂═CHR, where R can be a linear, branched, or cyclic aliphatic group.

### DETAILED DESCRIPTION

### Definitions

The term “alkyl” or “alkyl group” interchangeably refers to a saturated hydrocarbyl group consisting of carbon and hydrogen atoms. An alkyl group can be linear, branched, cyclic, or substituted cyclic, or a combination thereof. Wherever “linear, branched, or cyclic” is used, combinations thereof are included. For example, methylcyclohexyl is a combination, and included in the definition of an alkyl group.

The term “branched” is defined to mean a branched group that is not dendritic (i.e., branch on branch) or crosslinked. Typically, a branched group is a linear group that has one or more branches, including but not limited to those compounds represented by formulas F-V below.

The term “cyclic dimers” is defined to mean dimers formed from the dimerization of one or more C₆-C₃₂ cyclic alpha-olefins. Cyclic dimers are also generically referred to as “dimers.”

The term “cycloalkyl” or “cycloalkyl group” interchangeably refers to a saturated hydrocarbyl group wherein the carbon atoms form one or more ring structures.

The term “alkenyl” or “alkenyl group” interchangeably refers to a linear unsaturated hydrocarbyl group comprising a C═C bond therein.

The term “cycloalkenyl” or “cycloalkenyl group” interchangeably refers to cyclic hydrocarbyl group comprising a C═C bond in the ring.

The term “aryl” or “aryl group” interchangeably refers to a hydrocarbyl group comprising an aromatic ring structure therein.

The terms “aryloxy” and “aryloxide” mean an aryl group bound to an oxygen atom, such as an aryl ether group/radical connected to an oxygen atom and can include those where the aryl group is a C₆ to C₂₀ hydrocarbyl. Examples of suitable aryloxy radicals can include phenoxy, biphenoxy, naththoxy, and the like.

The terms “alkoxy” and “alkoxide” mean an alkyl group bound to an oxygen atom, such as an alkyl ether group/radical connected to an oxygen atom and can include those where the alkyl group is a C₁ to C₂₀ hydrocarbyl. The alkyl group may be straight chain, branched, or cyclic. The alkyl group may be saturated or partially unsaturated. Examples of suitable alkoxy radicals can include methoxy, ethoxy, n-propoxy, iso-propoxy, n-butoxy, iso-butoxy, sec-butoxy, tert-butoxy, and the like.

The terms “hydrocarbyl radical,” “hydrocarbyl group,” or “hydrocarbyl” interchangeably refers to a group consisting of hydrogen and carbon atoms only. A hydrocarbyl group can be saturated or unsaturated, linear or branched, cyclic or acyclic, aromatic or non-aromatic.

Unless otherwise indicated, a substituted group (such as substituted hydrocarbyl) means such a group in which at least one atom is replaced by a different atom or a group. For example, a substituted alkyl group can be an alkyl group in which at least one hydrogen atom is replaced by a hydrocarbyl group, a halogen, any other non-hydrogen group, and/or a least one carbon atom and hydrogen atoms bonded thereto is replaced by a different group. A substituted group can be a radical in which at least one hydrogen atom has been substituted with a heteroatom or heteroatom containing group, preferably with at least one functional group (e.g., halogen (Cl, Br, I, F), NR*₂, OR*, SeR*, TeR*, PR*₂, AsR*₂, SbR*₂, SR*, BR*₂, SiR*₃, GeR*₃, SnR*₃, PbR*₃, and the like) or where at least one heteroatom has been inserted within the hydrocarbyl radical, such as O, S, Se, Te, NR*, PR*, AsR*, SbR*, BR*, SiR*₂, GeR*₂, SnR*2, PbR*2, and the like, where R* is, independently, hydrogen, hydrocarbyl, or halocarbyl.

As used herein, aromatic refers to cyclic compounds, ligands or substituents (“ring”) that contain cyclic clouds of delocalized pi electrons above and below the plane of the “ring”, and the pi clouds must contain a total of 4π+2 pi electrons wherein n is an integer. As used herein, the term “aromatic” also refers to pseudoaromatic heterocycles which are heterocyclic substituents that have similar properties and structures (nearly planar) to aromatic heterocyclic ligands, but are not by definition aromatic.

Substituted hydrocarbyl radicals are radicals in which at least one hydrogen atom has been substituted with a heteroatom or heteroatom containing group, preferably with at least one functional group, such as halogen (Cl, Br, I, F), NR*₂, OR*, SeR*, TeR*, PR*₂, AsR*₂, SbR*₂, SR*, BR*₂, SiR*₃, GR*₃, SnR*₃, PbR*₃, and the like) or where at least one heteroatom has been inserted within the hydrocarbyl radical, such as halogen (Cl, Br, I, F), O, S, Se, Te, NR*, PR*, AsR*, SbR*, BR*, SiR*₂, GeR*₂, SnR*₂, PbR*₂, and the like, where R* is, independently, hydrogen or a hydrocarbyl.

In some embodiments, the hydrocarbyl radical is independently selected from methyl, ethyl, ethenyl and isomers of propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, propenyl, butenyl, pentenyl, hexenyl, heptenyl, octenyl, nonenyl, decenyl, undecenyl, dodecenyl, tridecenyl, tetradecenyl, pentadecenyl, hexadecenyl, heptadecenyl, octadecenyl, nonadecenyl, eicosenyl, heneicosenyl, docosenyl, tricosenyl, tetracosenyl, pentacosenyl, hexacosenyl, heptacosenyl, octacosenyl, nonacosenyl, triacontenyl, propynyl, butynyl, pentynyl, hexynyl, heptynyl, octynyl, nonynyl, decynyl, undecynyl, dodecynyl, tridecynyl, tetradecynyl, pentadecynyl, hexadecynyl, heptadecynyl, octadecynyl, nonadecynyl, eicosynyl, heneicosynyl, docosynyl, tricosynyl, tetracosynyl, pentacosynyl, hexacosynyl, heptacosynyl, octacosynyl, nonacosynyl, and triacontynyl. Also included are isomers of saturated, partially unsaturated and aromatic cyclic structures wherein the radical may additionally be subjected to the types of substitutions described above. Examples include phenyl, methylphenyl, benzyl, methylbenzyl, naphthyl, cyclohexyl, cyclohexenyl, methylcyclohexyl, and the like. “ ” Alkyl, alkenyl, and alkynyl radicals listed include all isomers including where appropriate cyclic isomers, for example, butyl includes n-butyl, 2-methylpropyl, 1-methylpropyl, tert-butyl, and cyclobutyl (and analogous substituted cyclopropyls); pentyl includes n-pentyl, cyclopentyl, 1-methylbutyl, 2-methylbutyl, 3-methylbutyl, 1-ethylpropyl, and neopentyl (and analogous substituted cyclobutyls and cyclopropyls); and butenyl includes E and Z forms of 1-butenyl, 2-butenyl, 3-butenyl, 1-methyl-1-propenyl, 1-methyl-2-propenyl, 2-methyl-1-propenyl, and 2-methyl-2-propenyl (and cyclobutenyls and cyclopropenyls). Cyclic compounds having substitutions include all isomer forms, for example, methylphenyl includes ortho-methylphenyl, meta-methylphenyl and para-methylphenyl; dimethylphenyl includes 2,3-dimethylphenyl, 2,4-dimethylphenyl, 2,5-dimethylphenyl, 2,6-diphenylmethyl, 3,4-dimethylphenyl, and 3,5-dimethylphenyl.

Silyl groups (also referred to as silyl, silyl radicals, and silyl substituents) are defined as SiR*₃ where R* is independently a hydrogen, hydrocarbyl or halocarbyl radical, and two or more R* may join together to form a substituted or unsubstituted saturated, partially unsaturated or aromatic cyclic or polycyclic ring structure. Silyl groups are bonded via a silicon atom.

Silylcarbyl radicals (e.g., hydrocarbyl groups, silylcarbyls, silylcarbyl groups or silylcarbyl substituents) are radicals in which one or more hydrocarbyl hydrogen atoms have been substituted with at least one SiR*₃ containing group or where at least one —Si(R*)₂— has been inserted within the hydrocarbyl radical where R* is independently a hydrogen, hydrocarbyl, or halocarbyl radical, and two or more R* may join together to form a substituted or unsubstituted saturated, partially unsaturated or aromatic cyclic or polycyclic ring structure. Silylcarbyl radicals can be bonded via a silicon atom or a carbon atom.

Substituted silylcarbyl radicals are silylcarbyl radicals in which at least one hydrogen atom has been substituted with at least one functional group such as NR*₂, OR*, SeR*, TeR*, PR*₂, AsR*₂, SbR*₂, SR*, BR*₂, GeR*₃, SnR*₃, PbR₃ and the like or where at least one non-hydrocarbon atom or group has been inserted within the silylcarbyl radical, such as —O—, —S—, —Se—, —Te—, —N(R*)—, ═N—, —P(R*)—, ═P—, —As(R*)—, ═As—, —Sb(R*)—, ═Sb—, —B(R*)—, ═B—, —Ge(R*)₂—, —Sn(R*)₂—, —Pb(R*)₂— and the like, where R* is independently a hydrogen, hydrocarbyl, or halocarbyl radical, and two or more R* may join together to form a substituted or unsubstituted saturated, partially unsaturated or aromatic cyclic or polycyclic ring structure.

Halocarbyl radicals are radicals in which one or more hydrocarbyl hydrogen atoms have been substituted with at least one halogen (e.g., F, Cl, Br, I) or halogen-containing group (e.g., CF₃).

Substituted halocarbyl radicals are radicals in which at least one halocarbyl hydrogen or halogen atom has been substituted with at least one functional group such as NR*₂, OR*, SeR*, TeR*, PR*₂, AsR*₂, SbR*₂, SR*, BR*₂, SiR*₃, GeR*₃, SnR*₃, PbR*₃, and the like or where at least one non-carbon atom or group has been inserted within the halocarbyl radical such as —O—, —S—, —Se—, —Te—, —N(R*)—, ═N—, —P(R*)—, ═P—, —As(R*)—, ═As—, —Sb(R*)—, ═Sb—, —B(R*)—, ═B—, —Si(R*)₂—, —Ge(R*)₂—, —Sn(R*)₂—, —Pb(R*)₂— and the like, where R* is independently a hydrogen, hydrocarbyl, or halocarbyl radical provided that at least one halogen atom remains on the original halocarbyl radical. Additionally, two or more R* may join together to form a substituted or unsubstituted saturated, partially unsaturated or aromatic cyclic or polycyclic ring structure.

The term “substituted phenyl,” or “substituted phenyl group” means a phenyl group having one or more hydrogen groups replaced by a hydrocarbyl, substituted hydrocarbyl, heteroatom or heteroatom containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*, —SiR*₃, —GeR*, —GeR*₃, —SnR*, —SnR*₃, —PbR*₃, and the like, where each R* is independently a hydrocarbyl, halogen, or halocarbyl radical. Preferably the “substituted phenyl” group is represented by the formula:

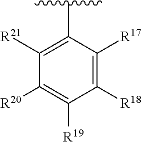

where each of R¹⁷, R¹⁸, R¹⁹, R²⁰, and R²¹ is independently selected from hydrogen, C₁-C₄₀ hydrocarbyl or C₁-C₄₀ substituted hydrocarbyl, a heteroatom, such as halogen, or a heteroatom-containing group (provided that at least one of R¹⁷, R¹⁸, R¹⁹, R²⁰, and R²¹ is not H), or a combination thereof.

A “fluorophenyl” or “fluorophenyl group” is a phenyl group substituted with one, two, three, four or five fluorine atoms.

The term “arylalkyl” means an aryl group where a hydrogen has been replaced with an alkyl or substituted alkyl group. For example, 3,5′-di-tert-butyl-phenyl indenyl is an indene substituted with an arylalkyl group. When an arylalkyl group is a substituent on another group, it is bound to that group via the aryl.

The term “alkylaryl” means an alkyl group where a hydrogen has been replaced with an aryl or substituted aryl group. For example, phenethyl indenyl is an indene substituted with an ethyl group bound to a benzene group. When an alkylaryl group is a substituent on another group, it is bound to that group via the alkyl.

Reference to an alkyl, alkenyl, alkoxide, or aryl group without specifying a particular isomer (e.g., butyl) expressly discloses all isomers (e.g., n-butyl, iso-butyl, sec-butyl, and tert-butyl), unless otherwise indicated.

The term “ring atom” means an atom that is part of a cyclic ring structure. Accordingly, a benzyl group has six ring atoms and tetrahydrofuran has 5 ring atoms.

Reference to an alkyl, alkenyl, alkoxide, or aryl group without specifying a particular isomer (e.g., butyl) expressly discloses all isomers (e.g., n-butyl, iso-butyl, sec-butyl, and tert-butyl), unless otherwise indicated.

The term “Cn” group or compound refers to a group or a compound comprising carbon atoms at total number thereof of n. A “Cm-Cn” group or compound refers to a group or compound comprising carbon atoms at a total number thereof in the range from m to n. Thus, a C₁-C₅₀ alkyl group refers to an alkyl group comprising carbon atoms at a total number thereof in the range from 1 to 50.

The term “olefin,” alternatively termed “alkene,” refers to a substituted or unsubstituted aliphatic hydrocarbon compound having a hydrocarbon chain containing at least one carbon-to-carbon double bond in the structure thereof. In some non-limiting embodiments, the alkene is an unsaturated hydrocarbon compound. In other non-limiting embodiments, the carbon-to-carbon double bond does not constitute a part of an aromatic ring. The olefin may be linear, branched, cyclic, or a combination thereof. For purposes of this specification and the claims appended thereto, when a polymer or copolymer is referred to as comprising an olefin, including but not limited to, ethylene, propylene, and butane, the olefin present in such polymer or copolymer is the polymerized form of the olefin (e.g., as a dimer, trimer, oligomer). For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. “Different” as used to refer to mer units indicates that the mer units differ from each other by at least one atom or are different isomerically. Thus, an “olefin” is intended to embrace all structural isomeric forms of olefins, unless it is specified to mean a single isomer or the context clearly indicates otherwise. An oligomer is a polymer having a low molecular weight, such as an Mn of 2,000 g/mol or less (preferably 1,000 g/mol or less), and/or a low number of mer units, such as 100 mer units or less, for example, 50 mer units or less. A dimer is a polymer with two mer units which may be the same or different. A trimer is a polymer with three mer units which may be the same or different. A tetramer is a polymer with four mer units which may be the same or different. Dimers, trimers and tetramers are sometimes referred to as oligomers.

The process to make polymers and oligomers including dimers, trimers and tetramers, is referred to as polymerization. In some instances, polymerization and oligomerization are used interchangeably in this document.

The term “alpha-olefin” refers to an olefin having a terminal carbon-to-carbon double bond in the structure thereof ((R^{a}R^{b})—C═CH₂, where R^{a} and R^{b} can be independently hydrogen or any hydrocarbyl group; preferably R^{a} is hydrogen and R^{b} is an alkyl group). A “linear alpha-olefin” is an alpha-olefin defined in this paragraph wherein R^{a} is hydrogen, and R^{b} is hydrogen or a linear alkyl group.

Non-limiting examples of α-olefins include ethylene, propylene, 1-butene, 1-pentene, 1-hexene, 1-heptene, 1-octene, 1-nonene, 1-decene, 1-undecene 1-dodecene, 1-tridecene, 1-tetradecene, 1-pentadecene, 1-hexadecene, 1-heptadecene, 1-octadecene, 1-nonadecene, 1-eicosene, 1-heneicosene, 1-docosene, 1-tricosene, 1-tetracosene, 1-pentacosene, 1-hexacosene, 1-heptacosene, 1-octacosene, 1-nonacosene, 1-triacontene, 4-methyl-1-pentene, 3-methyl-1-pentene, 5-methyl-1-nonene, 3,5,5-trimethyl-1-hexene, vinylcyclohexane, and vinylnorbornane.

Cyclic olefins contain a carbon-to-carbon double bond within a ring structure. Non-limiting examples of cyclic olefins and diolefins include cyclobutene, cyclopentene, cyclohexene, cycloheptene, cyclooctene, cyclononene, cyclodecene, norbornene, 4-methylnorbornene, 2-methylcyclopentene, 4-methylcyclopentene, norbornadiene, dicyclopentadiene, 5-ethylidene-2-norbornene, vinylcyclohexene, and 5-vinyl-2-norbornene.

Non-limiting examples of branched α-olefins include 4-methyl-1-pentene, 3-methyl-1-pentene, 5-methyl-1-nonene, and 3,5,5-trimethyl-1-hexene.

Non-limiting examples of cyclic α-olefins include vinylcyclobutane, vinylcyclopentane, vinylcyclohexane, 4-vinylcyclohex-1-ene (also referred as vinylcyclohexene), vinylcycloheptane, vinylcyclooctane, vinylcyclononane, vinylcyclodecane, vinylcycloundecane, vinylcyclododecane, 5-vinylnorbornane, 5-vinyl-2-norbornene, allylcyclohexane, and allylcyclooctane.

Non-limiting examples of aromatic cyclic α-olefins include styrene, para-methylstyrene, meta-methylstyrene, para-ethylstyrene, para-propylstyrene, para-butylstyrene, 3,5-diemethylstyrene, vinylnaphthylene, and the like.

Non-limiting examples of cyclic olefins which are not alpha-olefins, include cyclobutene, cyclopentene, cyclohexene, cycloheptene, cyclooctene, cyclononene, cyclodecene, norbornene, 4-methylnorbornene, 3-methylcyclopentene, 4-methylcyclopentene, 5-ethylidene-2-norbornene, and the like.

In unsaturated PAOs, the unsaturated end-groups can include different types of unsaturation, such as, vinyl, vinylidene, di-substituted vinylene, and tri-substituted vinylene.

The term “vinyl” means an olefin represented by the following formula:

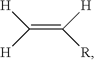

wherein R is a hydrocarbyl group, preferably a saturated hydrocarbyl group such as an alkyl group.

The term “vinylidene” means an olefin represented by the following formula:

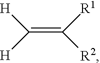

wherein R¹ and R² are each independently a hydrocarbyl group, preferably a saturated hydrocarbyl group such as alkyl group. Vinylidenes are 1,1-di-substituted vinylene groups.

The term “di-substituted vinylene” means:
(i) an olefin represented by the following formula:

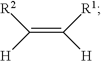

or
(ii) an olefin represented by the following formula:

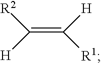

or
(iii) a mixture of (i) and (ii) at any proportion thereof, wherein R¹ and R², the same or different at each occurrence, are each independently a hydrocarbyl group, preferably a saturated hydrocarbyl group, such as an alkyl group. Di-substituted vinylenes, represent only 1,2-di-substituted vinylene groups and do not include vinylidenes which can also be referred to as 1,1-di-substituted vinylenes. The term “vinylene,” as used herein, is an alternative term for “di-substituted vinylene” only and not as a generic class of multiple vinylene species. In some non-limiting embodiments, the vinylene or di-substituted vinylene does not include a cyclic di-substituted vinylene.

The term “tri-substituted vinylene” means an olefin represented by the following formula:

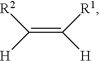

wherein R¹, R², and R³ are each independently a hydrocarbyl group (e.g., a saturated hydrocarbyl group such as alkyl group) or alternatively R¹ and R² can together form a non-aryl ring structure with R³ being a pendant hydrocarbyl group. The term “trisub,” as used herein, is an alternative term for “tri-substituted vinylene.”

“Cyclic di-substituted vinylenes” are found in cyclic olefins such as cyclopentene, or in some cyclic α-olefins such as 4-vinylcyclohex-1-ene which contain both vinyl and “cyclic di-substituted vinylene” unsaturation.

As used herein, “poly alpha-olefin(s)” (PAO(s)) are polymers of one or more alpha-olefin monomers, particularly an oligomer of one or more alpha-olefins. PAOs are polymeric, typically oligomeric, molecules produced from the polymerization reactions of alpha-olefin monomer molecules in the presence of a catalyst system, optionally further partially or fully hydrogenated to remove residual carbon-carbon double bonds therein or optionally further functionalized by reaction with some or all of the residual carbon-carbon bonds therein. Thus, the PAO can be a dimer, a trimer, a tetramer, or any other oligomer or polymer comprising two or more structure units derived from one or more alpha-olefin monomer(s). The PAO molecule can be highly regio-regular (stereo-regular), such that the bulk material may exhibit an isotacticity, or a syndiotacticity when measured by ¹³C NMR. The PAO molecule can be highly regio-irregular (stereo-irregular), such that the bulk material can be substantially atactic when measured by ¹³C NMR.

A PAO material made by using a metallocene-based catalyst system can be referred to as a metallocene-PAO (mPAO), and a PAO material made by using traditional non-metallocene-based catalysts (e.g., Lewis acids, supported chromium oxide, and the like) can be referred to as a conventional PAO (cPAO).

The term “carbon backbone” refers to the longest straight carbon chain in the molecule of the compound or the group in question. “Branches” or “pendant groups” interchangeably refer to any non-hydrogen group connected to the carbon backbone other than those attached to the carbon atoms at the very ends of the carbon backbone. As used herein, the term “length” of a pendant group is defined as the total number of carbon atoms in the longest carbon chain in the pendant group, counting from the first carbon atom attached to the carbon backbone and ending with the final carbon atom therein, without taking into consideration any substituents or pendant groups on the chain. In some embodiments, the pendant group is free of substituents comprising more than 2 carbon atoms (or more than 1 carbon atom), or is free of any substituent. A pendant group may contain a cyclic group or a portion thereof in the longest carbon chain, in which case half of the carbon atoms in the cyclic group are counted toward the length of the pendant group. Thus, by way of examples, a linear C₈ pendant group has a length of 8; each of the pendant groups PG-1 (cyclohexylmethylene) and PG-2 (phenylmethylene) has a length of 4; and each of the pendant groups PG-3 (o-heptylphenylmethylene) and PG-4 (p-heptylphenylmethylene) has a length of 11. Where a PAO molecule contains multiple pendant groups, the arithmetic average of the lengths of all such pendant groups is calculated as the average length of all pendant groups in the PAO molecule.

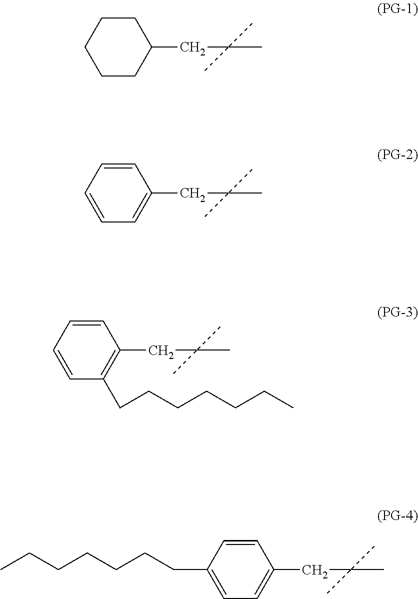

For nomenclature purposes, the following numbering schemes are used for cyclopentadienyl, indenyl, tetrahydro-s-indacenyl, tetrahydro-as-indacenyl, benz[f]indenyl, benz[e]indenyl ligands. Indenyl, tetrahydro-s-indacenyl, tetrahydro-as-indacenyl, benz[f]indenyl, benz[e]indenyl ligands are by definition substituted cylopentadienyl ligands. Tetrahydro-s-indacenyl, tetrahydro-as-indacenyl, benz[f]indenyl, benz[e]indenyl ligands are by definition substituted indenyl ligands. The numbering schemes are used to designate the positions of substituents and when applicable bridges, for example, a cyclopentadienyl ligand substituted with methyl groups in the 1 and 3 positions, would be named 1,3-dimethylcyclopentadienyl. Similarly, and two indenyl ligands bridged by a dimethylsilylene group in the 1 positions of each indenyl would be named dimethylsilylene-bis(inden-1-yl).

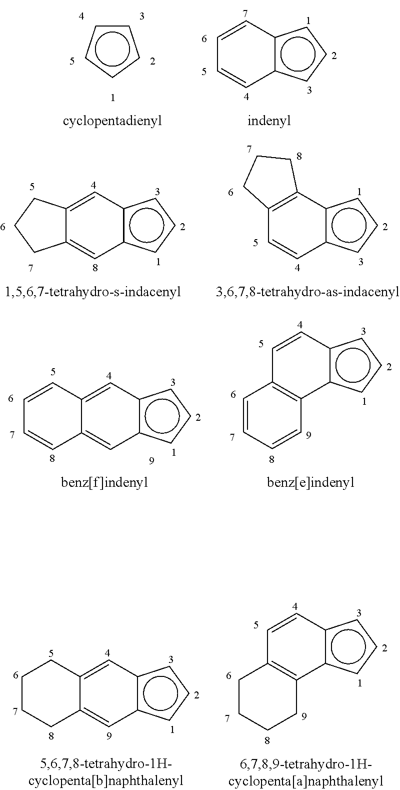

As described herein, a metallocene compound may have one or more optical isomers. Metallocene compounds identified herein by name or structure shall include all possible optical isomers thereof and mixtures of any such optical isomers. For example, metallocene compound Me₂Si(Me₄Cp)(3-PrInd)ZrMe₂ includes the following two optical isomers and mixtures thereof, even if only one structure is given when it is described:

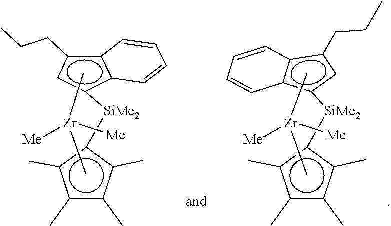

A “metallocene” catalyst compound is a transition metal catalyst compound having one, two or three, typically one or two, substituted or unsubstituted cyclopentadienyl ligands bound to the transition metal, typically a metallocene catalyst is an organometallic compound containing at least one π-bound cyclopentadienyl moiety (or substituted cyclopentadienyl moiety). Substituted cyclopentadienyl ligands include substituted or unsubstituted indenyl, fluorenyl, tetrahydro-s-indacenyl, tetrahydro-as-indacenyl, benz[f]indenyl, benz[e]indenyl, tetrahydrocyclopenta[b]naphthalene, tetrahydrocyclopenta[a]naphthalene, and the like.

Substituted cyclopentadienyl ligands by be bridged or unbridged, for example by a dimethylsilylene bridge as illustrated above. If a bridge is not specifically disclosed, then the cyclopentadienyl ligand is unbridged. Likewise, if a bridge is not specifically disclosed for a metallocene (aka pre-catalyst), then the metallocene is unbridged.

An unsymmetrical metallocene compound is a metallocene compound having two π-bound cyclopentadienyl moieties that differ by ring type such as by having one monocyclic arenyl ligand and one polycyclic arenyl ligand. For example, (cyclopentadienyl)(indenyl) zirconium dichloride would be considered unsymmetrical because it has one monocyclic arenyl ligand and one polycyclic arenyl ligand, while bis(indenyl) zirconium dichloride would be considered symmetrical since it has two polycyclic arenyl ligands.

As used herein, the term “monocyclic arenyl ligand” is used herein to mean a substituted or unsubstituted monoanionic C₅ to C₁₀₀ hydrocarbyl ligand that contains an aromatic five-membered single hydrocarbyl ring structure (also referred to as a cyclopentadienyl ring).

As used herein, the term “polycyclic arenyl ligand” is used herein to mean a substituted or unsubstituted monoanionic C₈ to C₁₀₃ hydrocarbyl ligand that contains an aromatic five-membered hydrocarbyl ring (also referred to as a cyclopentadienyl ring) that is fused to a partially unsaturated, or aromatic hydrocarbyl ring structures which may be fused to additional saturated, partially unsaturated, or aromatic hydrocarbyl rings.

Monocyclic arenyl ligands include substituted or unsubstituted cyclopentadienyls. Polycyclic arenyl ligands include substituted or unsubstituted, partially unsaturated or aromatic indenyls, fluorenyls, benz[f]indenyl, benz[e]indenyl, 5,6,7,8-tetrahydro-1H-cyclopenta[b]naphthalenyl, 6,7,8,9-tetrahydro-1H-cyclopenta[a]naphthalenyls, 1,5,6,7-tetrahydro-s-indacenyl, 3,6,7,8-tetrahydro-as-indacenyl, and the like.

Non-limiting examples of polycyclic arene ligands, named also as monoanionic ligands, include indenyl, 4,5-dihydroindenyl, 4,7-dihydroindenyl, 4,5,6,7-tetrahydroindenyl, benz[f]indenyl, benz[e]indenyl, 5,6,7,8-tetrahydro-1H-cyclopenta[b]naphthalenyl, 6,7,8,9-tetrahydro-1H-cyclopenta[a]naphthalenyls, 1,5,6,7-tetrahydro-s-indacenyl, 3,6,7,8-tetrahydro-as-indacenyl, 5,6-trimethyleneindenyl, 4,5-trimethyleneindenyl, 5,6-pentamethyleneindenyl, 4,5-pentamethyleneindenyl, 5,6-hexamethyleneindenyl, 4,5-hexamethyleneindenyl, 5,6-heptamethyleneindenyl, 4,5-heptamethyleneindenyl, 5,6-octamethyleneindenyl, 4,5-octa methyleneindenyl, 5,6-nonamethyleneindenyl, 4,5-nonamethyleneindenyl, 5,6-decamethylene indenyl, 4,5-decamethyleneindenyl, 5,6-undecamethyleneindenyl, 4,5-undecamethylene indenyl, 5,6-dodecamethyleneindenyl, 4,5-dodecamethyleneindenyl, 5,6-tridecamethylene indenyl, 4,5-tridecamethyleneindenyl, 5,6-tetradecamethyleneindenyl, 4,5-tetradecamethylene indenyl, 5,6-pentadecamethyleneindenyl, 4,5-pentadecamethyleneindenyl, 5,6-hexa decamethyleneindenyl, 4,5-hexadecamethyleneindenyl, 5,6-heptadecamethyleneindenyl, 4,5-heptadecamethyleneindenyl, 5,6-octadecamethyleneindenyl, 4,5-octadecamethyleneindenyl, 5,6-nonadecamethyleneindenyl, 4,5-nonadecamethyleneindenyl, 5,6-eicosamethyleneindenyl, 4,5-eicosamethyleneindenyl, (6Z,8Z,10Z)-cycloocta[e]indenyl, (5Z,7Z,9Z)-cycloocta[f]indenyl, (5E,7Z,9E,11Z,13E)-cyclododeca[f]indenyl, (6E,8Z,10E,12Z,14E)-cyclododeca[e]indenyl.

Partially hydrogenated polycyclic arene ligands retain the numbering scheme of the parent polycyclic arene ligand, namely the numbering schemes defined for indenyl, benz[f]indenyl, benz[e]indenyl, 5,6,7,8-tetrahydro-1H-cyclopenta[b]naphthalenyl, 6,7,8,9-tetrahydro-1H-cyclopenta[a]naphthalenyls, 1,5,6,7-tetrahydro-s-indacenyl, 3,6,7,8-tetrahydro-as-indacenyl

Unless specified otherwise, the term “substantially all” with respect to PAO molecules means at least 90 mol % (such as at least 95 mol %, at least 98 mol %, at least 99 mol %, or even 100 mol %).

Unless specified otherwise, the term “substantially free of” with respect to a particular component means the concentration of that component in the relevant composition is “ ” no greater than about 10 mol % (e.g., up to 5 mol %, up to 3 mol %, up to 1 mol %, or about 0%, within the bounds of the relevant measurement method), based on the total quantity of the relevant composition. Preferably “substantially free of” means no greater than 10 mol % (such as no greater than 5 mol %, no greater than 3 mol %, no greater than 1 mol %, or about 0%, based on the total quantity of the relevant composition.

The terms “catalyst” and “catalyst compound” are defined to mean a compound capable of initiating catalysis and/or of facilitating a chemical reaction with little or no poisoning/consumption. In the description herein, the catalyst may be described as a catalyst precursor, a pre-catalyst compound, a transition metal complex, or a transition metal compound, and these terms are used interchangeably. A catalyst compound may be used by itself to initiate catalysis or may be used in combination with an activator to initiate catalysis. When the catalyst compound is combined with an activator to initiate catalysis, the catalyst compound is often referred to as a pre-catalyst or catalyst precursor. A “catalyst system” includes at least one catalyst compound, at least one activator, an optional co-activator, and an optional support material, where the system can polymerize monomers to form a polymer.

A scavenger is a compound typically added to facilitate oligomerization/polymerization by scavenging impurities. Some scavengers may also act as activators and may be referred to as co-activators. A co-activator that is not a scavenger may be used in conjunction with an activator to form an active catalyst. In some embodiments, a co-activator can be pre-mixed with the catalyst compound to form an alkylated catalyst compound.

As used herein, a “lubricant” refers to a substance that can be introduced between two or more moving surfaces and lower the level of friction between two adjacent surfaces moving relative to each other. A lubricant “base stock” is a material, typically a fluid at the operating temperature of the lubricant, used to formulate a lubricant by admixing it with other components. Non-limiting examples of base stocks suitable in lubricants include API Group I, Group II, Group III, Group IV, Group V and Group VI base stocks. Fluids derived from Fischer-Tropsch process or Gas-to-Liquid (“GTL”) processes are examples of synthetic base stocks useful for making modern lubricants. GTL base stocks and processes for making them can be found, e.g., in PCT Pub. No. WO 2005/121280 and in U.S. Pat. Nos. 7,344,631; 6,846,778; 7,241,375; and 7,053,254, all of which are incorporated herein by reference.

All numerical values within the detailed description and the claims herein are modified by “about” or “approximately” the indicated value, and consider experimental error and variations that would be expected by a person having ordinary skill in the art.

In the present disclosure, all percentages of pendant groups, terminal carbon chains, and side chain groups are by mole, unless specified otherwise. Percent by mole is expressed as “mol %,” and percent by weight is expressed as “wt %.”

In the present disclosure, all molecular weight data are in the unit of g/mol (e.g., g·mol⁻¹), unless otherwise specified.

NMR spectroscopy provides key structural information about the synthesized polymers. Proton NMR (¹H-NMR) analysis can be used to determine the molecular weight of oligomer or polymer materials (including functionalized, hydrogenated, and uPAO materials). However, molecular weights of oligomer or polymer materials measured by 1H-NMR herein represent a number average molecular weight (Mn). In addition, ¹H-NMR analysis of the unsaturated PAO product can give a quantitative breakdown of the olefinic structure types (viz. vinyl, di-substituted vinylene, tri-substituted vinylene, and vinylidene). In some embodiments, compositions of mixtures of olefins comprising terminal olefins (vinyls and vinylidenes) and internal olefins (di-substituted vinylenes and tri-substituted vinylenes) are determined by using ¹H-NMR as described in the experimental section.

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, Mz) are g/mol (g mol⁻¹).

The following abbreviations may be used through this specification: Cp is cyclopentadiene or cyclopentadienyl; Ind is indene or indenyl, Flu is fluorene or fluorenyl, Me is methyl, Et is ethyl, Pr is propyl, iPr is isopropyl, n-Pr is normal propyl, cPr is cyclopropyl, Bu is butyl, nBu is normal butyl, iBu is isobutyl, sBu is sec-butyl, tBu is tertiary butyl, MeCy is methylcyclohexane, and Cy is cyclohexyl, Ph is phenyl, p-tBu is para-tertiary butyl, p-Me is para-methyl, o-biphenyl is an ortho-biphenyl moiety represented by the structure

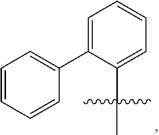 [SMILES: *c1ccccc1-c1ccccc1]

Cbz is Carbazole, Cy is cyclohexyl Oct is octyl, Ar* is 2,6-diisopropylphenyl, pMe is para-methyl, Bz or Bn are interchangeably benzyl (i.e., CH₂Ph), TMS is trimethylsilyl, TIBAL or TiBAl is triisobutylaluminum, TNOAL or TNOA or TnOAl is tri-n-octylaluminum, MAO is methylalumoxane, THF or thf is tetrahydrofuran, tol or Tol is toluene, dme is 1,2-dimethoxyethane, EtOAc is ethyl acetate, MCH is methylcyclohexane, VCH is 4-vinylcyclohex-1-ene, tol is toluene, and RT is room temperature (and is about 23° C. unless otherwise indicated).

The term “continuous” means a system that operates without interruption or cessation for a period of time, such as where reactants are continually fed into a reaction zone and products are continually or regularly withdrawn without stopping the reaction in the reaction zone. For example, a continuous process to produce a polymer would be one where the reactants are continually introduced into one or more reactors and polymer product is continually withdrawn.

A “solution polymerization” means a polymerization process in which the polymerization is conducted in a liquid polymerization medium, such as an inert solvent or monomer(s) or their blends. A solution polymerization is typically homogeneous. A homogeneous polymerization is one where the polymer product is dissolved in the polymerization medium. Such systems are typically not turbid as described in Oliveira, J. V. et al. (2000) “High-Pressure Phase Equilibria for Polypropylene-Hydrocarbon Systems,” Ind. Eng. Chem. Res., v.39 (12), pp. 4627-4633.

A “bulk polymerization” means a polymerization process in which the monomers and/or comonomers being polymerized are used as a solvent or diluent using little or no inert solvent or diluent. A small fraction of inert solvent might be used as a carrier for catalyst and scavenger. A bulk polymerization system contains less than about 25 wt % of inert solvent or diluent, such as less than about 10 wt %, such as less than about 1 wt %, such as 0 wt %.

### DESCRIPTION

Provided herein are processes for making a poly alpha-olefin (PAO) from two or more different alpha-olefins, wherein at least one alpha-olefin is a cyclic alpha-olefin and at least a second alpha-olefin is a linear or branched alpha-olefin. The process can include a step of contacting a feed comprising one or more C₆-C₃₂ cyclic alpha-olefins and one or more C₄-C₃₂ linear and/or branched alpha-olefins with a catalyst system comprising a metallocene compound in a polymerization reactor under polymerization conditions to effect a polymerization reaction to obtain a polymerization reaction mixture comprising a mixture of PAO molecules having vinylidenes, tri-substituted vinylenes, di-substituted vinylenes and optionally vinyl unsaturation.

The process can further include obtaining an unsaturated PAO product from the polymerization reaction mixture, wherein the unsaturated PAO product comprises a mixture of PAO molecules having vinylidenes, tri-substituted vinylenes, di-substituted vinylenes, optionally vinyl unsaturation, and optionally is substantially free of the alpha-olefin feed. When cyclic alpha-olefins with ring unsaturation such as 4-vinylcyclohex-1-ene, are used as the cyclic alpha-olefin, then the PAO product will also contain endocyclic di-substituted vinylenes. This type of unsaturation is referred to as cyclic di-substituted vinylenes.

Also provided herein are processes for making alpha-olefin dimers and trimers (preferably dimers) from two or more alpha-olefins, wherein at least one alpha-olefin is a cyclic alpha-olefin and at least one alpha-olefin is a linear or branched alpha-olefin. The process can include a step of contacting a feed containing one or more C₆-C₃₂ cyclic alpha-olefins and one or more C₄-C₃₂ linear and/or branched alpha-olefins with a catalyst system comprising a metallocene compound in a polymerization reactor under polymerization conditions to effect a polymerization reaction to obtain a polymerization reaction mixture comprising dimer and/or trimer molecules having vinylidenes, tri-substituted vinylenes, di-substituted vinylenes and optionally vinyl unsaturation. The process can also include a step of obtaining an unsaturated dimer and/or trimer product from the polymerization reaction mixture, with the unsaturated dimer and/or trimer product having vinylidenes, tri-substituted vinylenes, di-substituted vinylenes, optionally vinyl unsaturation, and, optionally, is substantially free of the alpha-olefin feed. When cyclic alpha-olefins with ring unsaturation such as 4-vinylcyclohex-1-ene, are used as the cyclic alpha-olefin, then the dimer and/or trimer product will also contain endocyclic di-substituted vinylenes. This type of unsaturation is referred to as cyclic di-substituted vinylenes.

Another aspect of the disclosure relates to a process for making alpha-olefin dimers and/or trimers (preferably dimers) from two or more different alpha-olefins, wherein at least one alpha-olefin is a cyclic alpha-olefin and at least a second alpha-olefin is a linear or branched alpha-olefin, and the product produced comprises molecules selected from:

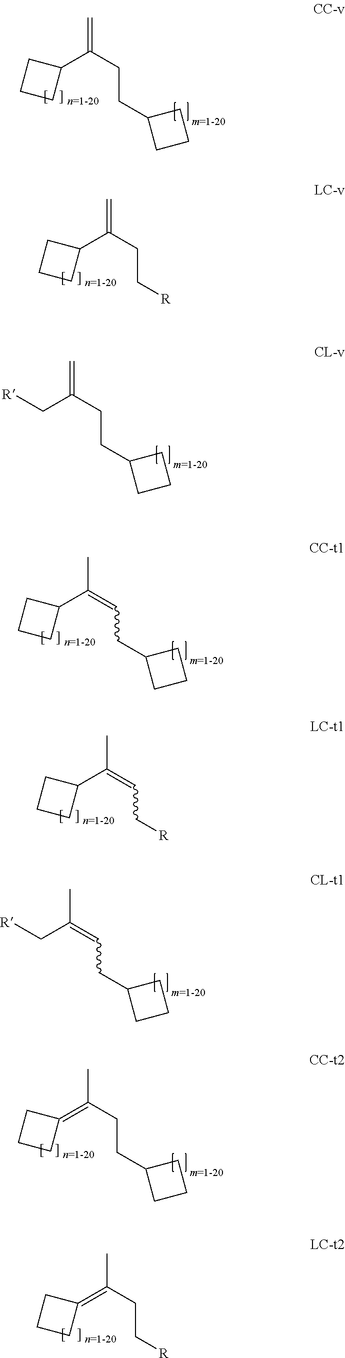

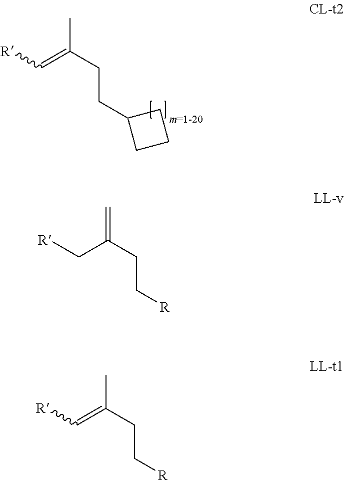

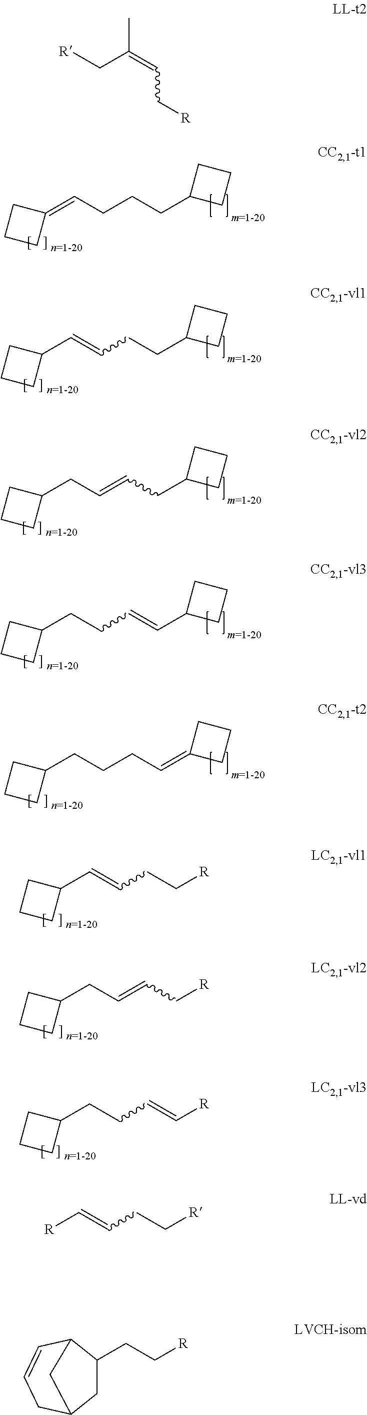

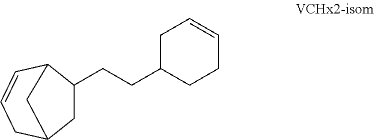 [SMILES: C1=CCC(CCC2CC3CC=CC2C3)CC1]

wherein cyclic monomer fragments (A) and (B) may independently be saturated if the cyclic alpha-olefin has a saturated ring structure, or partially unsaturated if the cyclic alpha-olefin has a partially unsaturated ring structure;

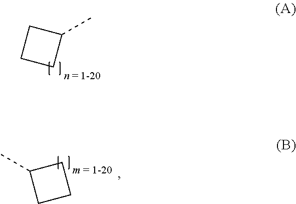

wherein n and m independently, indicate the number of additional carbon atoms in the ring structure and can be an integer from 1 to 20 (alternatively 1-12, alternatively 1-9, alternatively 1-5, alternatively 1-3), R is a C₂-C₃₀ hydrocarbyl group, R′ is a C₁-C₂₉ hydrocarbyl group, and wherein at least one of structures CL-v or LC-v are present in the product mixture.

Also provided herein are processes for making alpha-olefin dimers and/or trimers (preferably dimers) from two or more different alpha-olefins, wherein at least one of the alpha-olefins is a cyclic alpha-olefin and at least a second alpha-olefin is a linear or branched alpha-olefin, and the product produced has a selectivity for producing dimers of more than 50% of the total product mixture, alternatively more than 60% of the total product mixture, alternatively greater than 70% of the total product mixture, alternatively greater than 80% of the total product mixture, alternatively greater than 90% of the total product mixture, alternatively greater than 90% of the total product.

### Functionalization of Unsaturated PAO Products

The unsaturated PAO products of the present disclosure as described above, desirably produced by polymerization of alpha-olefin and/or olefinic monomers in the presence of a metallocene-compound-based catalyst system, can be advantageously used as a chemical intermediate for making many products, especially those comprising a PAO molecule moiety and one or more functional groups. The hydrocarbon molecules in the unsaturated PAO products, if prepared from the polymerization of olefins/alpha-olefins containing only one C═C double bond in their pre-polymerized molecules, can tend to comprise no more than one C═C bond each, with the rest of the molecular structure typically consisting of C—C bonds and C—H bonds.

The C═C bonds present in the molecules of the unsaturated PAO product of the present disclosure are highly reactive, and therefore can react with multiple, different types of chemical agents having useful functional groups, thereby creating a PAO molecule further comprising a functional group bonded thereto. The functional group can comprise, in turn, other functional groups, which can react with additional chemical agents, bringing additional or different functional groups to the final molecule. The hydrocarbon substrate (i.e., the PAO structure) of thus functionalized PAO can impart desired properties to the functionalized material, such as solubility in organic media or hydrophobicity, and the functional groups can impart other desired properties to the final material, such as polarity, hydrophilicity (thus, solubility in aqueous media), and the like, making the final material particularly useful where such dual properties are desired (e.g., detergents, adhesives, etc.).

US Publication No. 2014/0087986 discloses multiple methods for making functionalized PAO from unsaturated PAO products produced by polymerization of alpha-olefin monomers in the presence of a metallocene-compound-based catalyst system. The entirety of the disclosure of US 2014/0087986 is incorporated by reference herein.

It is highly desired that upon functionalization of the unsaturated PAO product, the C═C double bond in the reacted uPAO molecule becomes saturated (i.e., each carbon atom in the original C═C bond is then bonded to four atoms). This can be achieved by using functionalization agents reactive substantially only toward the C═C bonds, but substantially inert toward the C—C bonds and C—H bonds in the uPAO olefin molecules under the functionalization conditions. Given that each uPAO olefin molecule comprises typically only one C—C bond, the uPAO olefin molecule would then become saturated upon such functionalization reaction.

Upon functionalization of the C═C bond in the uPAO olefin molecule, the overall structure of the functionalized PAO molecule would be substantially similar to that of a hydrogenated PAO molecule where the C═C bond has been saturated by hydrogenation as described above. Assuming that the bond between the functional group(s) to the carbon atom(s) is not significantly less robust than the C—C and C—H bonds, and assuming the functional group(s) per se are not significantly less robust than a pendant group on the PAO molecule under the use conditions, one can expect a stable oligomeric/polymeric structure retaining at least some of the interesting and useful properties of a saturated PAO molecule, such as one or more of viscosity index, oxidation stability, shear stability, Bromine number, and the like. The retained properties can make the functionalized PAO material particularly useful in applications typical for the saturated PAO materials, such as lubricating oil compositions, and the like.

It is desirable that the functionalization agent used to functionalize the unsaturated PAO product is highly selective toward reacting with the C═C bond only, and is substantially inert with respect to the C—C bonds and C—H bonds on the uPAO molecules. This can ensure the production of functionalized PAO molecules each comprising one or two functional group(s) only, and a complete functionalization of substantially all of the uPAO molecules if desired. In applications such as lubricating oil compositions, because of the high reactivity of C═C bonds in the uPAO molecules, it may be desired that substantially all of the C═C bonds in the uPAO molecules are saturated before the functionalized PAO material is put into the oil compositions, either as a base stock or as an additive.

Additionally or alternatively, one may also functionalize the uPAO molecules by substituting one or more of the hydrogen atoms on the carbon backbone or one of the pendant groups with a functional group by using chemical agents known to be reactive with C—H bonds. Because a uPAO molecule typically comprise many C—H bonds at multiple locations, such reaction would be less selective than selective functionalization of C═C bonds by using a functionalization agent that is inert to the C—H bonds, and can result in very large number of very different molecules, and thus is less desirable than functionalization selective toward the C═C bonds only.

Additionally or alternatively, the uPAO products of the present disclosure can be functionalized by reaction between the unsaturated C═C bonds of the uPAO molecules and a chemical reagent. The chemical reagent may contain the moiety to be directly or indirectly reacted with the reactive portion(s) of the uPAO, optionally in the presence of an appropriate catalyst or facilitating agent. Alternatively, the chemical reagent may be a precursor to be directly or indirectly reacted with the reactive portion(s) of the uPAO, optionally in the presence of an appropriate catalyst or facilitating agent, followed by at least one other treatment and/or chemical reagent reaction, also optionally in the presence of the same or a different appropriate catalyst or facilitating agent, in order to effectuate a desired final functionality at the reactive portion(s) of the uPAO. Further alternatively, the chemical reagent may be a co-reactant to be pre-reacted or simultaneously reacted with another chemical reagent for direct or indirect reaction with the reactive portion(s) of the uPAO, optionally in the presence of an appropriate catalyst or facilitating agent.

Optionally, more than one type of functionality can be desired, such that the functionalization can occur simultaneously (effectuating a variety of functionalities in a single result), in series, in parallel (provided two parallel reactions do not countermand each other), or some combination thereof. Whether one or more functionalities are desired, the reaction can be of any variety capable of effectively accomplishing the functionalization, e.g., liquid-phase chemistry, gas-liquid interfacial chemistry, solid-liquid surface chemistry, gaseous oxidation, gaseous oxidation followed by some other functionalization mechanism, plasma oxidation, plasma oxidation followed by some other functionalization mechanism, radical formation, radical formation followed by some other functionalization mechanism, or the like. The ultimately desired functional group(s) can be tailored to the particular end-use application, e.g., including but not limited to moieties containing an oxygen atom, a nitrogen atom, a sulfur atom, a phosphorus atom, a boron atom, a silicon atom, a halogen atom, or a combination thereof. The extent to which functionalization can be accomplished is another variable that can be tailored to the particular end-use application. Functionalization (single or multiple) can be partial or substantially complete (i.e., in which substantially all the unsaturations of the uPAO can be converted into a functional moiety, such as a heteroatom-containing moiety).

The PAOs prepared herein may be functionalized by reacting a heteroatom containing group with the PAO with or without a catalyst. Examples include catalytic hydrosilylation, ozonolysis, hydroformylation, hydroamination, sulfonation, halogenation, hydrohalogenation, hydroboration, epoxidation, or Diels-Alder reactions with polar dienes, Friedel-Crafts reactions with polar aromatics, maleation with activators such as free radical generators (e.g. peroxides). The functionalized PAOs can be used in oil additives, as antifogging or wetting additives, surfactants for soaps, detergents, fabric softeners, antistatics, adhesion promoters and many other applications. Preferred uses include additives for lubricants and or fuels, preferably where the heteroatom containing group includes one or more of amines, aldehydes, alcohols, acids, anhydrides, sulphonates, particularly succinic acid, maleic acid and maleic anhydride.

In some embodiments the PAOs produced herein are functionalized as described in U.S. Pat. No. 6,022,929; Toyota, A. et al. (2002) Polymer Bulletin, v.48 (3), pp. 213-219; and Kropp, P. J. (1990) Journal Am. Chem. Soc., v.112, pp. 7433-7434. In some embodiments the functionalized PAOs produced herein are further functionalized (derivatized), such as described in U.S. Pat. No. 6,022,929; Toyota, A. et al. (2002) Polymer Bulletin, v.48 (3), pp. 213-219; Kropp, P. J. (1990) Journal Am. Chem. Soc., v.112, pp. 7433-7434; and PCT Pug. No. WO 2009/155472.

In preferred embodiments, the PAOs of the present disclosure can be functionalized (e.g. chemically modified with one or more functional groups (also referred to as a heteroatom containing group) typically containing heteroatoms such as P, O, S, N, Br, Cl, F, I and or Br (preferably N, O, Cl and or Br, preferably N and or O). Preferred functional groups are selected from the group consisting of acids, esters, anhydrides, acid-esters, oxycarbonyls, carbonyls, formyls, formylcarbonyls, hydroxyls, and acetyl halides. Particularly preferred functional groups include those represented by the formula: —C(O)—X, where the O is double bonded to the C and the X is hydrogen, nitrogen, hydroxy, oxyhydrocarbyl (e.g. ester), oxygen, the salt moiety —OM wherein M is a metal, e.g. alkali, alkaline earth, transition metal, copper, zinc and the like, oxyhetero, e.g. —O—Z wherein Z represents a heteroatom such as phosphorus boron, sulfur, which heteroatom may be substituted with hydrocarbyl or oxyhydrocarbyl groups, or two acyl groups may be joined through (X).

Preferred heteroatom containing groups include acyl groups derived from monounsaturated mono- or dicarboxylic acids and their derivatives, e.g. esters and salts.

More specifically, PAOs functionalized with mono- or dicarboxylic acid material, i.e., acid, anhydride, salt or acid ester are preferred, including the reaction product of the PAO with a monounsaturated carboxylic reactant comprising at least one member selected from the group consisting of (i) monounsaturated C₄ to C₁₀ dicarboxylic acid (preferably wherein (a) the carboxyl groups are vicinyl, (i.e. located on adjacent carbon atoms) and (b) at least one, preferably both, of said adjacent carbon atoms are part of said monounsaturation); (ii) derivatives of (i) such as anhydrides or C₁ to C₅ alcohol derived mono- or diesters of (i); (iii) monounsaturated C₃ to C₁₀ monocarboxylic acid wherein the carbon-carbon double bond is conjugated to the carboxyl group, i.e., of the structure —C═C—C(O)— (where O is double bonded to C), and (iv) derivatives of (iii) such as C₁ to C₅ alcohol derived monoesters of (iii). Upon reaction with the PAO, the double bond of the monounsaturated carboxylic reactant becomes saturated. Thus, for example, maleic anhydride reacted with the PAO becomes succinic anhydride, and acrylic acid becomes a propionic acid.

Suitable unsaturated acid materials thereof which are useful functional compounds, include acrylic acid, crotonic acid, methacrylic acid, maleic acid, maleic anhydride, fumaric acid, itaconic acid, itaconic anhydride, citraconic acid, citraconic anhydride, mesaconic acid, glutaconic acid, chloromaleic acid, aconitic acid, crotonic acid, methylcrotonic acid, sorbic acid, 3-hexenoic acid, 10-decenoic acid, 2-pentene-1,3,5-tricarboxylic acid, cinnamic acid, and lower alkyl (e.g. C₁ to C₄ alkyl) acid esters of the foregoing, e.g. methyl maleate, ethyl fumarate, methyl fumarate, etc. Particularly preferred are the unsaturated dicarboxylic acids and their derivatives, especially maleic acid, fumaric acid and maleic anhydride.

Typically, from about 0.7 to about 4.0 (e.g., 0.8 to 2.6), preferably from about 1.0 to about 2.0, and most preferably from about 1.1 to about 1.7 moles of said monounsaturated carboxylic reactant are charged to the reactor per mole of PAO charged.

Functionalization can be achieved by any suitable method. Useful methods include the reaction of an olefinic bond of the PAO with an unsaturated, preferably a monounsaturated, carboxylic reactant. Alternatively, the oligomer can be halogenated using chlorine or bromine-containing compounds. The halogenated PAO can then be reacted with the monounsaturated carboxylic acid. The PAO and the monounsaturated carboxylic reactant can also be contacted at elevated temperatures to cause a thermal “ene” reaction to take place. Alternatively, the monounsaturated carboxylic acid can be reacted with the PAO by free radical induced grafting. The PAO of the present disclosure can be functionalized by contact with a hydroxy aromatic compound in the presence of a catalytically effective amount of at least one acidic alkylation catalyst. The alkylated hydroxy aromatic compound can then be further reacted to form a derivative by Mannich Base condensation with an aldehyde and an amine reagent to yield a Mannich Base condensate. In yet another means to functionalize the PAO, the PAO may be contacted with carbon monoxide in the presence of an acid catalyst under Koch reaction conditions to yield the PAO substituted with carboxylic acid groups. In addition to the above methods of functionalization, the PAO of the present disclosure can be functionalized by methods of air oxidation, ozonolysis, hydroformylation, epoxidation and chloroamination (e.g., U.S. Pat. No. 6,022,929 Column 21, line 16 to column 33, line 27).

The poly alpha-olefins produced herein contain one or more unsaturated double bonds, rich in vinylidene content with some 1,2-disubstituted olefins. These unsaturated polymers are particularly suitable for further functionalization reactions. Examples of such functionalization includes alkylation with aromatics compounds, such as benzene, toluene, xylene, naphthalene, phenol or alkylphenols. The PAOs can also react with maleic anhydride to give PAO-succinic anhydride, which can be further converted with amines or alcohols to corresponding succinimide or succinate esters. These imides and esters are superior dispersants.

The functionalized PAO can in turn be derivatized with a derivatizing compound. (For purposes of this disclosure and the claims thereto the term functionalized PAO encompasses derivatized PAO.) The derivatizing compound can react with the functional groups of the functionalized PAO by means such as nucleophilic substitution, Mannich Base condensation, and the like. The derivatizing compound can be polar and/or contain reactive derivative groups. Preferred derivatizing compounds are selected from hydroxy containing compounds, amines, metal salts, anhydride containing compounds and acetyl halide containing compounds. The derivatizing compounds can comprise at least one nucleophilic group and preferably at least two nucleophilic groups. A typical derivatized PAO is made by contacting a functionalized PAO, i.e., substituted with a carboxylic acid/anhydride or ester, with a nucleophilic reagent, e.g., amine, alcohol, including polyols, amino alcohols, reactive metal compounds and the like (e.g., U.S. Pat. No. 6,022,929 column 33, line 27 to column 74, line 63). Alternately a derivatized PAO may be made by contacting a functionalized PAO, substituted with a carboxylic acid/anhydride or ester, with a nucleophilic reagent, e.g., amine, to make a quaternary ammonium compound or amine oxide.

The functionalized PAOs and/or derivatized PAOs have uses as lubricating additives which can act as dispersants, viscosity index improvers, or multifunctional viscosity index improvers. Additionally they may be used as disinfectants (functionalized amines) and or wetting agents.

The functionalized PAO prepared herein may be used in oil additivation, lubricants, fuels and many other applications. Preferred uses include additives for lubricants and or fuels.

In particular embodiments herein, the PAOs disclosed herein, or functionalized/derivatized analogs thereof, are useful as additives, preferably in a lubricant.

The functionalized PAOs and/or derivatized PAOs produced herein have uses as lubricating additives which can act as dispersants, viscosity index improvers, or multifunctional viscosity index improvers. Additionally they may be used as disinfectants (functionalized amines) and or wetting agents.

The functionalized PAOs and/or derivatized PAOs described herein are useful for viscosity index improvers for lubricating oil compositions, adhesive additives, antifogging and wetting agents, ink and paint adhesion promoters, coatings, tackifiers and sealants, and the like. In addition, such PAOs may be functionalized and derivatized to make multifunctional viscosity index improvers which also possess dispersant properties (e.g., U.S. Pat. No. 6,022,929).

The functionalized PAOs and/or derivatized PAOs described herein may be combined with other additives (such as viscosity index improvers, corrosion inhibitor, oxidation inhibitor, dispersant, lube oil flow improver, detergents, demulsifiers, rust inhibitors, pour point depressant, anti-foaming agents, antiwear agents, seal swellant, friction modifiers, and the like (described, for example, in U.S. Pat. No. 6,022,929 at columns 60, line 42-column 78, line 54 and the references cited therein) to form compositions for many applications, including but not limited to lube oil additive packages, lube oils, and the like.

Compositions containing these additives are typically are blended into a base oil in amounts which are effective to provide their normal attendant function. Representative effective amounts of such additives are illustrated as follows:

| | (Typical) | (Preferred) |
|---|---|---|
| Compositions | wt %* | wt %* |
| V.I. Improver | 1-12 | 1-4 |
| Corrosion Inhibitor | 0.01-3 | 0.01-1.5 |
| Oxidation Inhibitor | 0.01-5 | 0.01-1.5 |
| Dispersant | 0.1-10 | 0.1-5 |
| Lube Oil Flow Improver | 0.01-2 | 0.01-1.5 |
| Detergents and Rust inhibitors | 0.01-6 | 0.01-3 |
| Pour Point Depressant | 0.01-1.5 | 0.01-1.5 |
| Anti-Foaming Agents | 0.001-0.1 | 0.001-0.01 |
| Antiwear Agents | 0.001-5 | 0.001-1.5 |
| Seal Swellant | 0.1-8 | 0.1-4 |
| Friction Modifiers | 0.01-3 | 0.01-1.5 |
| Lubricating Base Oil | Balance | Balance |

*Wt %'s are based on active ingredient content of the additive, and/or upon the total weight of any additive-package, or formulation which will be the sum of the A.I. weight of each additive plus the weight of total oil or diluent.

When other additives are employed, it may be desirable, although not necessary, to prepare additive concentrates comprising concentrated solutions or dispersions of the subject additives of this disclosure (in concentrate amounts hereinabove described), together with one or more of said other additives (said concentrate when constituting an additive mixture being referred to herein as an additive-package) whereby several additives can be added simultaneously to the base oil to form the lubricating oil composition. Dissolution of the additive concentrate into the lubricating oil may be facilitated by solvents and by mixing accompanied with mild heating, but this is not essential. The subject functionalized or derivatized PAOs of the present disclosure can be added to small amounts of base oil or other compatible solvents along with other desirable additives to form additive-packages containing active ingredients in collective amounts of typically from about 2.5 to about 90%, and preferably from about 15 to about 75%, and most preferably from about 25 to about 60% by weight additives in the appropriate proportions with the remainder being base oil.

The final formulations may employ typically about 10 wt % of the additive-package with the remainder being base oil.

In another embodiment, the PAOs described herein can be used in any process, blend or product disclosed in PCT Pub. No. WO 2009/0155472 or U.S. Pat. No. 6,022,929, which are incorporated by reference herein.

In a preferred embodiment, this disclosure relates to a fuel comprising any PAO produced herein. In a preferred embodiment, this disclosure relates to a lubricant comprising any PAO produced herein.

### The Catalyst System

The catalyst system useful herein comprises an unsymmetric metallocene catalyst compound activated by one or more non-aromatic-hydrocarbon soluble activators, and may further include a solvent, a support, one or more scavengers, and/or the like.

The typical activator-to-catalyst ratio, e.g., all NCA activators-to-catalyst ratio is about a 1:1 molar ratio. Alternate preferred ranges include from 0.1:1 to 100:1, alternately from 0.5:1 to 200:1, alternately from 1:1 to 500:1 alternately from 1:1 to 1000:1, for example, from 0.5:1 to 10:1, preferably 1:1 to 5:1.

Solvents useful for combining the catalyst compound and activator and/or for introducing the catalyst system into the reactor, include, but are not limited to, aliphatic solvents, such as butanes, pentanes, hexanes, heptanes, octanes, nonanes, decanes, undecanes, dodecanes, tridecanes, tetradecanes, pentadecanes, hexadecanes, or a combination thereof; preferable solvents can include normal paraffins (such as NORPAR® solvents available from ExxonMobil Chemical Company in Houston, TX), isoparaffin solvents (such as ISOPAR®) solvents available from ExxonMobil Chemical Company in Houston, TX), and combinations thereof. These solvents or diluents may typically be pre-treated in same manners as the feed olefins.

Preferably the solvent is selected from C₄ to C₁₀ linear, branched or cyclic alkanes.

Preferably the solvent is essentially free of all aromatic solvents.

Preferably the solvent is essentially free of toluene.

Preferably the solvent is selected from one or more C₆ to C₃₂ alpha olefins, such as one or more C₈ to C₁₆ alpha olefins.

Preferably the solvent is essentially free of all non-alpha-olefin solvents.

Aliphatic hydrocarbon solvents can include, but are not limited to, isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof. In some embodiments, aromatics are present in the solvent at less than 1 wt %, such as less than 0.5 wt %, such as at 0 wt % based upon the weight of the solvents.

The activators of the present disclosure can be dissolved in one or more additional solvents provided such solvents are non-aromatic. Additional solvent includes halogenated or partially halogenated hydrocarbons solvents.

In some embodiments, the aliphatic solvent is isohexane and/or methylcyclohexane.

In some embodiments, the solvent is one or more C₆ to C₃₂ alpha olefins, such as one or more C₈ to C₁₆ alpha olefins, and no additional solvents are used.

In some embodiments, the solvent is 1-octene, 1-decene, 1-dodecene, or 1-tetradecene, or a combination of any two or more.

Processes with a Metallocene Compound

Also provided herein are processes for making a poly alpha-olefin (PAO) from two or more different alpha-olefins, wherein at least one of the alpha-olefins is a cyclic alpha-olefin and at least a second alpha-olefin is a linear or branched alpha-olefin. The process can include a step of contacting a feed comprising one or more C₆-C₃₂ cyclic alpha-olefins and one or more C₄-C₃₂ linear and/or branched alpha-olefins with a catalyst system comprising a metallocene compound in a polymerization reactor under polymerization conditions to effect a polymerization reaction to obtain a polymerization reaction mixture comprising a mixture of PAO molecules having vinylidenes, tri-substituted vinylenes, di-substituted vinylenes and optionally vinyl unsaturation; and obtaining an unsaturated PAO product from the polymerization reaction mixture, wherein the unsaturated PAO product comprises a mixture of PAO molecules having vinylidene, tri-substituted vinylene, di-substituted vinylene, and optionally vinyl unsaturation, wherein the metallocene compound is represented by formula (I):

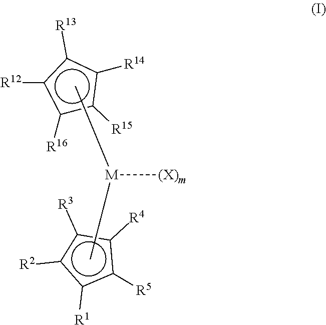

wherein:
   R¹, R², and R³ are each independently hydrogen or a substituted or unsubstituted linear, branched, or cyclic C₁-C₂₀ hydrocarbyl or silylcarbyl group;
   R⁴ and R⁵ are each independently a substituted or unsubstituted linear, branched, or cyclic C₁-C₃₀ hydrocarbyl or silylcarbyl group where R⁴ and R⁵, taken together with the carbon atoms in the first cyclopentadienyl ring to which they are directly connected, collectively form one or more substituted or unsubstituted rings annelated to the first cyclopentadienyl ring;
   R¹², R¹³, R¹⁴, R¹⁵, and R¹⁶ are each independently a hydrogen or a substituted or unsubstituted linear, branched, or cyclic C₁-C₂₀ hydrocarbyl, silylcarbyl, or germanyl group, and at least four of R¹², R¹³, R¹⁴, R¹⁵, and R¹⁶ are not hydrogen;
   M is a Group 3, 4, or 5 transition metal having an integer coordination number of v, wherein v is 3, 4, or 5;
   each X is independently a halogen, a hydride, an amide, an alkoxide, a sulfide, a phosphide, a diene, an amine, a phosphine, an ether, or a C₁-C₂₀ substituted or unsubstituted linear, branched, or cyclic hydrocarbyl group, or optionally two or more X moieties may together form a fused ring or ring system; and
   m is an integer equal to v-2, e.g., 1, 2, or 3.

In some embodiments, the metallocene compound has a structure represented by formula (II):

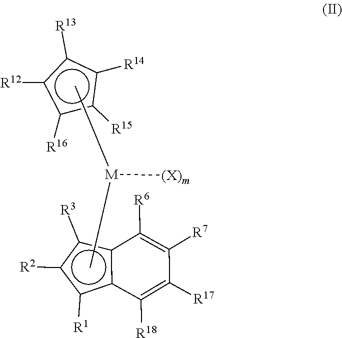

wherein:
   R¹, R², and R³ are each independently hydrogen or a substituted or unsubstituted linear, branched, or cyclic C₁-C₂₀ hydrocarbyl group;
   R⁶, R⁷, R¹⁷, and R¹⁸ are each independently hydrogen, a substituted or unsubstituted linear, branched, or a cyclic C₁-C₃₀ hydrocarbyl group, or R⁶ and R⁷, R⁷ and R¹⁷, or R¹⁷ and R¹⁸, taken together with the carbon atoms in the indenyl ring to which they are directly connected, collectively form one or more substituted or unsubstituted rings annelated to the indenyl ring;
   R¹², R¹³, R¹⁴, and R¹⁵ are each independently a substituted or unsubstituted linear, branched, or cyclic C₁-C₂₀ hydrocarbyl group;
   R¹⁶ is hydrogen or a substituted or unsubstituted linear, branched, or cyclic C₁-C₂₀ hydrocarbyl group or silylcarbyl group;
   each X is independently a halogen, a hydride, an amide, an alkoxide, a sulfide, a phosphide, a diene, an amine, a phosphine, an ether, a C₁-C₂₀ substituted or unsubstituted linear, branched, or cyclic hydrocarbyl group, or two or more X moieties together form a fused ring or ring system;
   M is a transition metal, preferably a Group 3, 4, or 5 transition metal having an integer coordination number of v, for example, v is 3, 4, or 5; and
   m is an integer equal to v-2, for example, m is 1, 2, or 3.

In some embodiments, the metallocene compound is represented by formula (III):

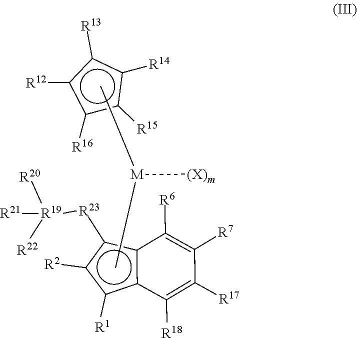

wherein:
   R¹ and R² are hydrogen;
   R²³ and R¹⁹ comprise Group 14 atoms, such as C, Ge, or Si (e.g., R²³ is C and R¹⁹ is C or Si);
   R²⁰, R²¹, and R²² are independently hydrogen or a substituted or unsubstituted linear, branched, or cyclic C₁-C₂₀ hydrocarbyl group and at least two of R²⁰, R²¹, and R²² are independently a substituted or unsubstituted linear, branched, or cyclic C₁-C₂₀ hydrocarbyl group;
   R⁶, R⁷, R¹⁷, and R¹⁸ are each independently hydrogen, a substituted or unsubstituted linear, branched, or cyclic C₁-C₃₀ hydrocarbyl group, or R⁶ and R⁷, R⁷ and R¹⁷, or R¹⁷ and R¹⁸, taken together with the carbon atoms in the indenyl ring to which they are directly connected, collectively form one or more substituted or unsubstituted rings annelated to the indenyl ring;
   R¹², R¹³, R¹⁴, R¹⁵, and R¹⁶ are each independently a substituted or unsubstituted linear, branched, or cyclic C₁-C₂₀ hydrocarbyl group;
   each X is independently a halogen, a hydride, an amide, an alkoxide, a sulfide, a phosphide, a diene, an amine, a phosphine, an ether, or a C₁-C₂₀ substituted or unsubstituted linear, branched, or cyclic hydrocarbyl group, or two or more X moieties together form a fused ring or ring system;
   M is a Group 3, 4, or 5 transition metal having an integer coordination number of v, for example, v is 3, 4 or 5; and
   m is an integer equal to v-2, for example, 1, 2, or 3.

In some embodiments, the metallocene compound is represented by formula (IV):

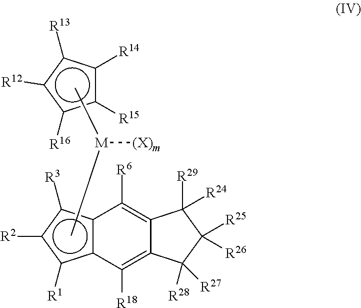

wherein:
   R¹ and R² are hydrogen;
   R³ is a substituted or unsubstituted linear, branched, or cyclic C₁-C₂₀ hydrocarbyl group;
   R⁶ and R¹⁸ are each independently hydrogen, or a substituted or unsubstituted linear, branched, or cyclic C₁-C₃₀ hydrocarbyl group;
   R²⁴, R²⁵, R²⁶, R²⁷, R²⁸, and R²⁹ are each independently hydrogen, or a substituted or unsubstituted linear, branched, or cyclic C₁-C₈ hydrocarbyl group;
   R¹², R¹³, R¹⁴, R¹⁵, and R¹⁶ are each independently a substituted or unsubstituted linear, branched, or cyclic C₁-C₂₀ hydrocarbyl group;
   each X is independently a halogen, a hydride, an amide, an alkoxide, a sulfide, a phosphide, a diene, an amine, a phosphine, an ether, or a C₁-C₂₀ substituted or unsubstituted linear, branched, or cyclic hydrocarbyl group, or two or more X moieties together form a fused ring or ring system;
   M is a Group 3, 4, or 5 transition metal having an integer coordination number of v, for example, v is 3, 4 or 5; and
   m is an integer equal to v-2, for example, m is 1, 2, or 3.

In some embodiments, the metallocene compound is represented by formula (V):

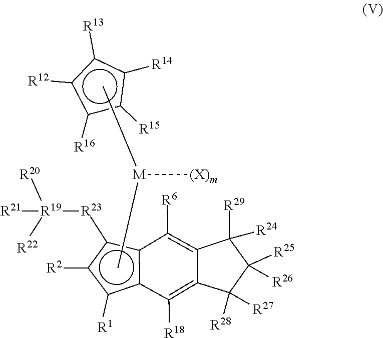

wherein:
   R¹ and R² are hydrogen;
   R²³ and R¹⁹ are each independently Group 14 atoms, for example, C, Ge, or Si (e.g., R²³ is C and R¹⁹ is C or Si);
   R²⁰, R²¹, and R²² are each independently hydrogen or a substituted or unsubstituted linear, branched, or cyclic C₁-C₂₀ hydrocarbyl group and at least two of R²⁰, R²¹, and R²² are independently a substituted or unsubstituted linear, branched, or cyclic C₁-C₂₀ hydrocarbyl group;
   R⁶ and R¹⁸ are each independently hydrogen, or a substituted or unsubstituted linear, branched, or cyclic C₁-C₃₀ hydrocarbyl group;
   R²⁴, R²⁵, R²⁶, R²⁷, R²⁸, and R²⁹ are each independently hydrogen, or a substituted or unsubstituted linear, branched, or cyclic C₁-C₈ hydrocarbyl group;
   R¹², R¹³, R¹⁴, R¹⁵, and R¹⁶ are each independently a substituted or unsubstituted linear, branched, or cyclic C₁-C₂₀ hydrocarbyl group;
   each X is independently a halogen, a hydride, an amide, an alkoxide, a sulfide, a phosphide, a diene, an amine, a phosphine, an ether, or a C₁-C₂₀ substituted or unsubstituted linear, branched, or cyclic hydrocarbyl group, or two or more X moieties together form a fused ring or ring system;
   M is a Group 3, 4, or 5 transition metal having an integer coordination number of v, for example v is 3, 4 or 5; and
   m is an integer equal to v-2, for example, m is 1, 2, or 3.

In some embodiments of formulas (I), (II), (III), (IV), and (V), M is Zr, Hf, or a combination thereof.

In some embodiments of formulas (I), (II), (III), (IV), and (V), M is Hf.

In some embodiments of formulas (I), (II), (III), (IV), and (V), X is independently a halogen or a substituted or unsubstituted linear, branched, or cyclic C₁-C₆ hydrocarbyl group.

In some embodiments of formulas (I), (II), (III), (IV), and (V), X, is independently methyl, ethyl, benzyl or trimethylsilylmethylene.

In some embodiments of formulas (I), (II), (III), (IV), and (V), at least four of R¹², R¹³, R¹⁴, R¹⁵, and R¹⁶ are each independently a substituted or unsubstituted linear, branched, or cyclic C₁-C₈ hydrocarbyl group (e.g., methyl or ethyl).

In some embodiments of formulas (I), (II), (III), (IV) and (V), R¹², R¹³, R¹⁴, R¹⁵, and R¹⁶ are each independently a substituted or unsubstituted linear, branched, or cyclic C₁-C₄ hydrocarbyl group (e.g., methyl or ethyl).

In some embodiments of formulas (I) and (II), a first one of R¹, R², and R³ is a substituted or unsubstituted linear, branched, or cyclic C₁-C₂₀ hydrocarbyl group: a second one of R¹, R², and R³ is hydrogen; and a third one of R¹, R², and R³ is hydrogen, a substituted or unsubstituted linear, branched, or cyclic C₁-C₂₀ hydrocarbyl group.

In some embodiments of formulas (I) and (II), R² is hydrogen, and one of R¹ and R³ is a substituted or unsubstituted linear, branched, or cyclic C₁-C₆ hydrocarbyl group, and the other one of R¹ and R³ is a hydrogen.

In some embodiments of formulas (I) and (II), one or both of R¹ and R³ is a substituted or unsubstituted linear, branched, or cyclic C₁-C₆ hydrocarbyl group, and R² is hydrogen.

In some embodiments of formulas (I) and (II), one of R¹ and R³ comprise an alpha Group 14 atom directly attached to the indenyl ring, a beta Group 14 atom attached to the alpha atom, and two or more (e.g., three) substituted or unsubstituted linear, branched, or cyclic C₁-C₈ hydrocarbyl groups attached to the beta atom.

In some embodiments of formulas (I), (II), and (IV), R¹ and R² are hydrogen, and R³ is a substituted or unsubstituted linear, branched, or cyclic C₁-C₈ hydrocarbyl group (e.g., methyl, ethyl, n-propyl, iso-butyl, trimethylsilylmethylene, or neopentyl).

In some embodiments of formula (II), R¹, R², and R³ are hydrogen; R¹², R¹³, R¹⁴, and R¹⁵, are independently methyl or ethyl; and R¹⁶ is hydrogen, methyl, ethyl, propyl, or butyl.

In some embodiments of formulas (II) or (III), R⁶ and R⁷, R⁷ and R¹⁷, or R¹⁷ and R¹⁸, taken together with the respective carbon atoms in the indenyl ring to which they are directly connected, form a ring annelated to the indenyl ring. In some embodiments, the ring annelated to the indenyl ring comprises one or more saturated carbon atoms.

In some embodiments of formulas (II) or (III), R⁶ and R¹⁸ are hydrogen and R⁷ and R¹⁷ taken together with the respective carbon atoms in the indenyl ring to which they are directly connected, form a 5- or 6-membered ring annulated to the indenyl ring.

In some embodiments of formulas (II), (III), (IV) or (V), R⁶ and R¹⁸ are hydrogen.

In some embodiments of formulas (III) or (V), R²³ is CH₂ (methylene), R¹⁹ is C or Si (preferably C), and R²⁰, R²¹, and R²² are independently hydrogen or a C₁-C₁₀ hydrocarbyl group, and at least two of R²⁰, R²¹, and R²² are not hydrogen.

In some embodiments of formulas (III) or (V), R²³ is CH₂ (methylene); R¹⁹ is C; and R²⁰, R²¹, and R²² are independently selected from hydrogen, methyl, ethyl, propyl or butyl, and at least two of R²⁰, R²¹, and R²² are not hydrogen.

In some embodiments of formulas (IV) or (V), R²⁴, R²⁷, R²⁸, and R²⁹ are hydrogen; and R²⁵ and R²⁶ are independently hydrogen, or a substituted or unsubstituted linear, branched, or cyclic C₁-C₈ hydrocarbyl group.

In some embodiments of formulas (IV) or (V), R²⁴, R²⁷, R²⁸, and R²⁹ are hydrogen; and R²⁵ and R²⁶ are independently hydrogen, methyl, or ethyl.

In some embodiments of formulas (IV) or (V), R²⁴, R²⁷, R²⁸, and R²⁹ are independently hydrogen or a substituted or unsubstituted linear, branched, or cyclic C₁-C₈ hydrocarbyl group; and R²⁵ and R²⁶ are hydrogen.

In some embodiments of formulas (IV) or (V), R²⁴, R²⁷, R²⁸, and R²⁹ are methyl and R²⁵ and R²⁶ are hydrogen.

In some embodiments, the metallocene compound is selected from structures A through E depicted below. In some embodiments, the metallocene compound is selected from structures A through D.

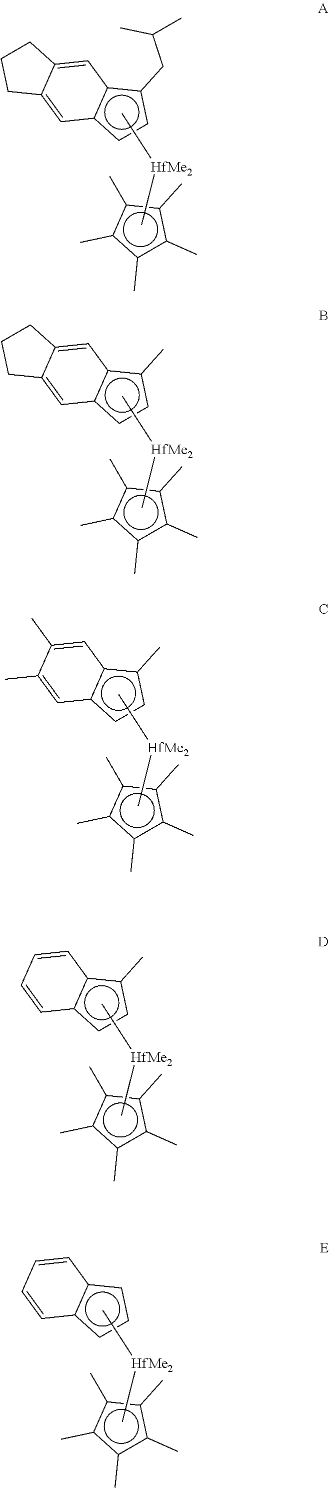

Catalyst compounds that are particularly useful in this disclosure include one or more of: (pentamethylcyclopentadienyl)(1-methyl-1,5,6,7-tetrahydro-s-indacenyl)hafnium dimethyl, (pentamethylcyclopentadienyl)(1-ethyl-1,5,6,7-tetrahydro-s-indacenyl)hafnium dimethyl, (pentamethylcyclopentadienyl)(1-n-propyl-1,5,6,7-tetrahydro-s-indacenyl)hafnium dimethyl, (pentamethylcyclopentadienyl)(1-isopropyl-1,5,6,7-tetrahydro-s-indacenyl)hafnium dimethyl, (pentamethylcyclopentadienyl)(1-n-butyl-1,5,6,7-tetrahydro-s-indacenyl)hafnium dimethyl, (pentamethylcyclopentadienyl)(1-isobutyl-1,5,6,7-tetrahydro-s-indacenyl)hafnium dimethyl, (pentamethylcyclopentadienyl)(1,6,6-trimethyl-1,5,6,7-tetrahydro-s-indacenyl)hafnium dimethyl, (pentamethylcyclopentadienyl)(1-isobutyl-6,6-dimethyl-1,5,6,7-tetrahydro-s-indacenyl)hafnium dimethyl, (pentamethylcyclopentadienyl)(1-methyl-6,6-diethyl-1,5,6,7-tetrahydro-s-indacenyl)hafnium dimethyl, (pentamethylcyclopentadienyl)(1,6,6-triethyl-1,5,6,7-tetrahydro-s-indacenyl)hafnium dimethyl, (pentamethylcyclopentadienyl)(1-isobutyl-6,6-diethyl-1,5,6,7-tetrahydro-s-indacenyl)hafnium dimethyl, (pentamethylcyclopentadienyl)(1-methylindenyl)hafnium dimethyl, (pentamethylcyclopentadienyl)(1-isobutylindenyl)hafnium dimethyl, (pentamethylcyclopentadienyl)(1-methyl-3,6,7,8-tetrahydro-as-indacenyl)hafnium dimethyl, (pentamethylcyclopentadienyl)(1-isobutyl-3,6,7,8-tetrahydro-as-indacenyl)hafnium dimethyl, (pentamethylcyclopentadienyl)(1-methyl-5,6,7,8-tetrahydro-1H-cyclopenta[b]naphthalene)hafnium dimethyl, (pentamethylcyclopentadienyl)(1-isobutyl-5,6,7,8-tetrahydro-1H-cyclopenta[b]naphthalene)hafnium dimethyl, (pentamethylcyclopentadienyl)(1-methyl-6,7,8,9-tetrahydro-1H-cyclopenta[a]naphthalene)hafnium dimethyl, (pentamethylcyclopentadienyl)(1-isobutyl-6,7,8,9-tetrahydro-1H-cyclopenta[a]naphthalene)hafnium dimethyl, (pentamethylcyclopentadienyl)(1,5,6-trimethylindenyl)hafnium dimethyl, and (pentamethylcyclopentadienyl)(1-isobutyl-5,6-dimethyllindenyl)hafnium dimethyl.

In some embodiments of the disclosure related to dimerizing cyclic alpha-olefins, the metallocene is chosen from any of formulas (I), (II), (III), (IV), or (V); provided that at least one of R¹ and R³ is not hydrogen in formulas (I) and (II). In formulas (I), (II), and (IV), R¹ and R² are preferably hydrogen; and R³ is preferably methyl, ethyl, and isomers of propyl, butyl, pentyl, hexyl, heptyl, octyl, nonyl, decyl, undecyl and dodecyl, preferably methyl, ethyl, n-propyl, isopropyl, n-butyl, sec-butyl and isobutyl.

### Activators and Activation of the Metallocene Compound

### Non-Coordinating Anion (NCA) Activators

Noncoordinating anion (NCA) means an anion either that does not coordinate to the catalyst metal cation or that does coordinate to the metal cation, but only weakly. The term NCA is also defined to include multicomponent NCA-containing activators, such as N,N-dioctadecylanilinium tetrakis(perfluoronaphthyl)borate, that contain an acidic cationic group and the non-coordinating anion. The term NCA is also defined to include neutral Lewis acids, such as tris(pentafluoronaphthyl)boron, that can react with a catalyst to form an activated species by abstraction of an anionic group. An NCA coordinates weakly enough that a neutral Lewis base, such as an olefinically or acetylenically unsaturated monomer can displace it from the catalyst center. Any metal or metalloid that can form a compatible, weakly coordinating complex may be used or contained in the non-coordinating anion. Suitable metals can include aluminum, gold, and platinum. Suitable metalloids can include boron, aluminum, phosphorus, and silicon. The term non-coordinating anion activator includes neutral activators, ionic activators, and Lewis acid activators.

“Compatible” non-coordinating anions can be those which are not degraded to neutrality when the initially formed complex decomposes. Further, the anion will not transfer an anionic substituent or fragment to the cation so as to cause it to form a neutral transition metal compound and a neutral by-product from the anion. Non-coordinating anions useful in accordance with the present disclosure are those that are compatible, stabilize the transition metal cation in the sense of balancing its ionic charge at +1, and yet retain sufficient lability to permit displacement during polymerization.

In some embodiments, activators comprise non-coordinating anions.

Advantageously, the activators of the present disclosure are soluble in non-aromatic-hydrocarbon solvents, such as aliphatic solvents.

In some embodiments, a 20 wt % mixture of the activator compound in n-hexane, isohexane, cyclohexane, methylcyclohexane, or a combination thereof, forms a clear homogeneous solution at 25° C., preferably a 30 wt % mixture of the activator compound in n-hexane, isohexane, cyclohexane, methylcyclohexane, or a combination thereof, forms a clear homogeneous solution at 25° C.

In some embodiments, the activators described herein have a solubility of more than 10 mM (or more than 20 mM, or more than 50 mM) at 25° C. (stirred 2 hours) in methylcyclohexane.

In some embodiments, the activators described herein have a solubility of more than 1 mM (or more than 10 mM, or more than 20 mM) at 25° C. (stirred 2 hours) in isohexane.

In some embodiments, the activators described herein have a solubility of more than 10 mM (or more than 20 mM, or more than 50 mM) at 25° C. (stirred 2 hours) in methylcyclohexane and a solubility of more than 1 mM (or more than 10 mM, or more than 20 mM) at 25° C. (stirred 2 hours) in isohexane.

The present disclosure relates to a catalyst system comprising a metallocene transition metal compound and an activator compound as described herein, to the use of such activator compounds for activating a transition metal compound in a catalyst system for polymerizing olefins, and to processes for polymerizing olefins, the process comprising contacting under polymerization conditions one or more olefins with a catalyst system comprising a metallocene transition metal compound and such activator compounds, where aromatic solvents, such as toluene, are absent (e.g. present at zero mol %, alternately present at less than 1 mol %, preferably the catalyst system, the polymerization reaction and/or the polymer produced are free of “detectable aromatic hydrocarbon solvent,” such as toluene. For purposes of the present disclosure, “detectable aromatic hydrocarbon solvent” means 0.1 mg/m² or more as determined by gas phase chromatography. For purposes of the present disclosure, “detectable toluene” means 0.1 mg/m² or more as determined by gas phase chromatography.

The poly alpha-olefins produced herein preferably contain 0 ppm (alternately less than 1 ppm) of aromatic hydrocarbon. Preferably, the poly alpha-olefins produced herein contain 0 ppm (alternately less than 1 ppm) of toluene.

The catalyst systems used herein preferably contain 0 ppm (alternately less than 1 ppm) of aromatic hydrocarbon. Preferably, the catalyst systems used herein contain 0 ppm (alternately less than 1 ppm) of toluene.

Non-aromatic-hydrocarbon soluble activator compounds useful herein include those represented by the Formula (VI):

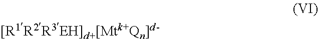

wherein:
   E is nitrogen or phosphorous;
   d is 1, 2 or 3; k is 1, 2, or 3; n is 1, 2, 3, 4, 5, or 6; n−k=d (preferably d is 1, 2 or 3; k is 3; n is 4, 5, or 6);
   R^{1′}, R^{2′}, and R^{3′} are independently C₁ to C₅₀ hydrocarbyl group optionally substituted with one or more alkoxy groups, silyl groups, a halogen atoms, or halogen containing groups,
   wherein R^{1′}, R^{2′}, and R^{3′} together comprise 15 or more carbon atoms;
   Mt is an element selected from group 13 of the Periodic Table of the Elements, such as B or P; and
   each Q is independently a hydride, bridged or unbridged dialkylamido, halide, alkoxide, aryloxide, hydrocarbyl, substituted hydrocarbyl, halocarbyl, substituted halocarbyl, or halosubstituted-hydrocarbyl radical.

Non-aromatic-hydrocarbon soluble activator compounds useful herein include those represented by the Formula (VII):

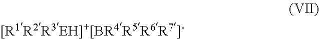

wherein:
   E is nitrogen or phosphorous;
   R^{1′} is a methyl group;
   R^{2′} and R^{3′} are independently is C₄-C₅₀ hydrocarbyl group optionally substituted with one or more alkoxy groups, silyl groups, a halogen atoms, or halogen containing groups wherein R^{2′} and R^{3′} together comprise 14 or more carbon atoms;
   B is boron;
and R^{4′}, R^{5′}, R^{6′}, and R^{7′} are independently hydride, bridged or unbridged dialkylamido, halide, alkoxide, aryloxide, hydrocarbyl, substituted hydrocarbyl, halocarbyl, substituted halocarbyl, or halosubstituted-hydrocarbyl radical.

Non-aromatic-hydrocarbon soluble activator compounds useful herein include those represented by the Formula (VIII) or Formula (IX):

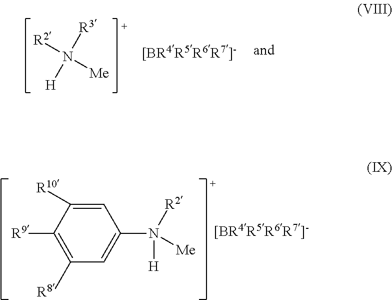

wherein:
   N is nitrogen;
   R^{2′} and R^{3′} are independently is C₆-C₄₀ hydrocarbyl group optionally substituted with one or more alkoxy groups, silyl groups, a halogen atoms, or halogen containing groups wherein R^{2′} and R^{3′} (if present) together comprise 14 or more carbon atoms;
   R^{8′}, R^{9′}, and R^{10′} are independently a C₄-C₃₀ hydrocarbyl or substituted C₄-C₃₀ hydrocarbyl group;
   B is boron;
   and R^{4′}, R^{5′}, R^{6′}, and R^{7′} are independently hydride, bridged or unbridged dialkylamido, halide, alkoxide, aryloxide, hydrocarbyl, substituted hydrocarbyl, halocarbyl, substituted halocarbyl, or halosubstituted-hydrocarbyl radical.

Optionally, in any of Formulas (VI), (VII), (VIII), or (IX) herein, R^{4′}, R^{5′}, R^{6′} and R^{7′} are pentafluorophenyl.

Optionally, in any of Formulas (VI), (VII), (VIII), or (IX) herein, R^{4′}, R^{5′}, R^{6′}, and R^{7′} are pentafluoronaphthyl.

Optionally, in any embodiment of Formula (IX) herein, R^{8′} and R^{10′} are hydrogen atoms and R^{9′} is a C₄-C₃₀ hydrocarbyl group which is optionally substituted with one or more alkoxy groups, silyl groups, a halogen atoms, or halogen containing groups.

Optionally, in any embodiment of Formula (IX) herein, R^{9′} is a C₈-C₂₂ hydrocarbyl group which is optionally substituted with one or more alkoxy groups, silyl groups, a halogen atoms, or halogen containing groups.

Optionally, in any embodiment of Formula (VIII) or (IX) herein, R^{2′} and R^{3′} are independently a C₁₂-C₂₂ hydrocarbyl group.

Optionally, R^{1′}, R^{2′} and R^{3′} together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 38 or more carbon atoms, such as 40 or more carbon atoms, such as 15 to 100 carbon atoms, such as 25 to 75 carbon atoms).

Optionally, R^{2′} and R^{3′} together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 38 or more carbon atoms, such as 40 or more carbon atoms, such as 15 to 100 carbon atoms, such as 25 to 75 carbon atoms).

Optionally, R^{8′}, R^{9′}, and R^{10′} together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 38 or more carbon atoms, such as 40 or more carbon atoms, such as 15 to 100 carbon atoms, such as 25 to 75 carbon atoms).

Optionally, when Q is a fluorophenyl group, then R^{2′} is not a C₁-C₄₀ linear alkyl group (alternately R^{2′} is not an optionally substituted C₁-C₄₀ linear alkyl group).

Optionally, each of R^{4′}, R^{5′}, R^{6′}, and R^{7′} is an aryl group (such as phenyl or naphthyl), wherein at least one of R^{4′}, R^{5′}, R^{6′}, and R^{7′} is substituted with at least one fluorine atom, preferably each of R^{4′}, R^{5′}, R^{6′}, and R^{7′} is a perfluoroaryl group (such as perfluorophenyl or perfluoronaphthyl).

Optionally, each Q is an aryl group (such as phenyl or naphthyl), wherein at least one Q is substituted with at least one fluorine atom, preferably each Q is a perfluoroaryl group (such as perfluorophenyl or perfluoronaphthyl).

Optionally, R^{1′} is a methyl group; R^{2′} is C₆-C₅₀ aryl group; and R^{3′} is independently C₁-C₄₀ linear alkyl or C₅-C₅₀-aryl group.

Optionally, each of R^{2′} and R^{3′} is independently unsubstituted or substituted with at least one of halide, C₁-C₃₅ alkyl, C₅-C₁₅ aryl, C₆-C₃₅ arylalkyl, C₆-C₃₅ alkylaryl, wherein R², and R³ together comprise 20 or more carbon atoms.

Optionally, each Q is independently a hydride, bridged or unbridged dialkylamido, halide, alkoxide, aryloxide, hydrocarbyl, substituted hydrocarbyl, halocarbyl, substituted halocarbyl, or halosubstituted-hydrocarbyl radical, provided that when Q is a fluorophenyl group, then R^{2′} is not a C₁-C₄₀ linear alkyl group, preferably R^{2′} is not an optionally substituted C₁-C₄₀ linear alkyl group (alternately when Q is a substituted phenyl group, then R^{2′} is not a C₁-C₄₀ linear alkyl group, preferably R^{2′} is not an optionally substituted C₁-C₄₀ linear alkyl group). Optionally, when Q is a fluorophenyl group (alternately when Q is a substituted phenyl group), then R^{2′} is a meta- and/or para-substituted phenyl group, where the meta and para substituents are, independently, an optionally substituted C₁ to C₄₀ hydrocarbyl group (such as a C₆ to C₄₀ aryl group or linear alkyl group, a C₁₂ to C₃₀ aryl group or linear alkyl group, or a C₁₀ to C₂₀ aryl group or linear alkyl group), an optionally substituted alkoxy group, or an optionally substituted silyl group. Optionally, each Q is a fluorinated hydrocarbyl group having 1 to 30 carbon atoms, more preferably each Q is a fluorinated aryl (such as phenyl or naphthyl) group, and most preferably each Q is a perflourinated aryl (such as phenyl or naphthyl) group. Examples of suitable [Mt^{k+}Qₙ]^{d-} also include diboron compounds as disclosed in U.S. Pat. No. 5,447,895, which is fully incorporated herein by reference. Optionally, at least one Q is not substituted phenyl. Optionally all Q are not substituted phenyl. Optionally at least one Q is not perfluorophenyl. Optionally all Q are not perfluorophenyl.

In some embodiments of the disclosure, R^{1′} is not methyl, R^{2′} is not C₁₈ alkyl and R^{3′} is not C₁₈ alkyl, alternately R^{1′} is not methyl, R^{2′} is not Cis alkyl and R^{3′} is not Cis alkyl and at least one Q is not substituted phenyl, optionally all Q are not substituted phenyl.

Useful cation components in Formulas (V) to (VIII) include those represented by the formula:

| | |
|---|---|
| 10 | 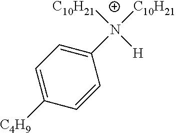 |
| 11 | 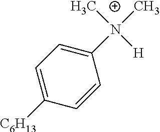 |
| 12 | 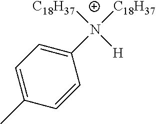 |
| 13 | 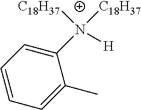 |
| 14 | 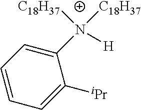 |
| 15 | 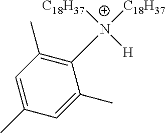 |
| 16 | 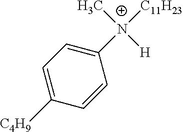 |
| 17 | 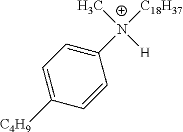 |
| 18 | 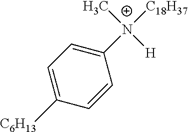 |
| 19 | 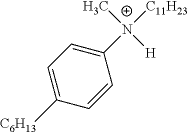 |
| 20 | 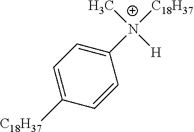 |
| 21 | 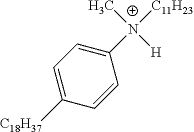 |
| 22 | 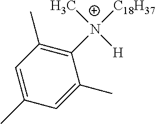 |
| 23 | 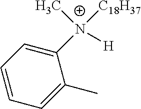 |
| 24 | 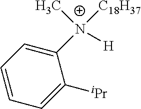 |
| 25 | 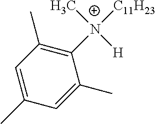 |
| 26 | 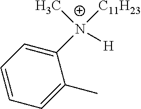 |
| 27 | 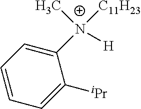 |
| 29 | 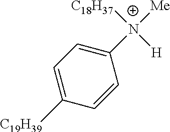 |
| 28 | 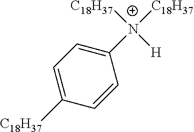 |
| 30 | 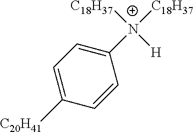 |
| 31 | 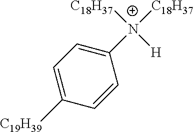 |
| 32 | 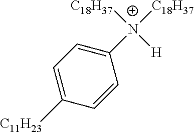 |
| 33 | 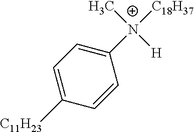 |
| 34 | 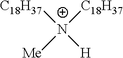 |
| 35 | 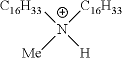 |
| 36 | 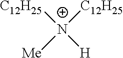 |

Useful cation components in Formulas (VI) to (IX) include those represented by the formula:

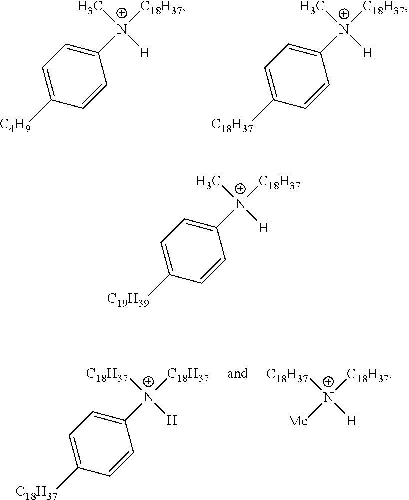

The anion component of the activators described herein includes those represented by the formula [Mt^{k+}Qₙ]⁻ wherein k is 1, 2, or 3; n is 1, 2, 3, 4, 5, or 6 (preferably 1, 2, 3, or 4), (preferably k is 3; n is 4, 5, or 6, preferably when M is B, n is 4); Mt is an element selected from Group 13 of the Periodic Table of the Elements, preferably boron or aluminum, and Q is independently a hydride, bridged or unbridged dialkylamido, halide, alkoxide, aryloxide, hydrocarbyl, substituted hydrocarbyl, halocarbyl, substituted halocarbyl, and halosubstituted-hydrocarbyl radicals, said Q having up to 20 carbon atoms with the proviso that in not more than 1 occurrence is Q a halide. Preferably, each Q is a fluorinated hydrocarbyl group, optionally having 1 to 20 carbon atoms, more preferably each Q is a fluorinated aryl group, and most preferably each Q is a perfluorinated aryl group. Preferably at least one Q is not substituted phenyl, such as perfluorophenyl, preferably all Q are not substituted phenyl, such as perfluorophenyl.

In one embodiment, the borate activator comprises tetrakis(heptafluoronaphth-2-yl)borate.

In one embodiment, the borate activator comprises tetrakis(pentafluorophenyl)borate.

Preferred anions for use in the non-coordinating anion activators described herein include those represented by Formula 7 below:

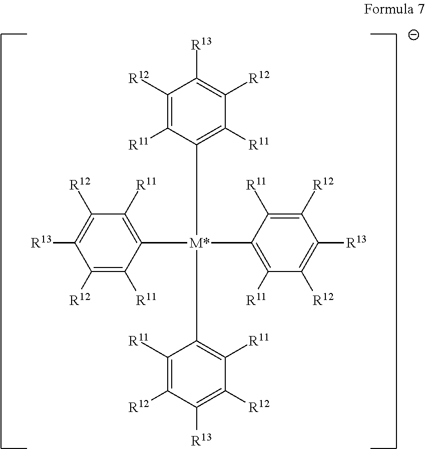

wherein:
   M* is a group 13 atom, preferably B or Al, preferably B;
   each R¹¹ is, independently, a halide, preferably a fluoride;
   each R¹² is, independently, a halide, a C₆ to C₂₀ substituted aromatic hydrocarbyl group or a siloxy group of the formula —O—Si—R^{a}, where R^{a} is a C₁ to C₂₀ hydrocarbyl or hydrocarbylsilyl group, preferably R¹² is a fluoride or a perfluorinated phenyl group;
   each R¹³ is a halide, a C₆ to C₂₀ substituted aromatic hydrocarbyl group or a siloxy group of the formula —O—Si—R^{a}, where R^{a} is a C₁ to C₂₀ hydrocarbyl or hydrocarbylsilyl group, preferably R¹³ is a fluoride or a C₆ perfluorinated aromatic hydrocarbyl group;
wherein R¹² and R¹³ can form one or more saturated or unsaturated, substituted or unsubstituted rings, preferably R¹² and R¹³ form a perfluorinated phenyl ring. Preferably the anion has a molecular weight of greater than 700 g/mol, and, preferably, at least three of the substituents on the M* atom each have a molecular volume of greater than 180 cubic A.

“Molecular volume” is used herein as an approximation of spatial steric bulk of an activator molecule in solution. Comparison of substituents with differing molecular volumes allows the substituent with the smaller molecular volume to be considered “less bulky” in comparison to the substituent with the larger molecular volume. Conversely, a substituent with a larger molecular volume may be considered “more bulky” than a substituent with a smaller molecular volume.

Molecular volume may be calculated as reported in Girolami, G. S. (1994) “A Simple “Back of the Envelope” Method for Estimating the Densities and Molecular Volumes of Liquids and Solids,” Journal of Chemical Education, v.71 (11), pp. 962-964. Molecular volume (MV), in units of cubic Å, is calculated using the formula: MV=8.3Vₛ, where Vₛ is the scaled volume. Vₛ is the sum of the relative volumes of the constituent atoms, and is calculated from the molecular formula of the substituent using Table A below of relative volumes. For fused rings, the Vₛ is decreased by 7.5% per fused ring. The Calculated Total MV of the anion is the sum of the MV per substituent, for example, the MV of perfluorophenyl is 183 Å³, and the Calculated Total MV for tetrakis(perfluorophenyl)borate is four times 183 Å³, or 732 Å³.

TABLE A

| Element | Relative Volume |
|---|---|
| H | 1 |
| 1^{st} short period, Li to F | 2 |
| 2^{nd} short period, Na to Cl | 4 |
| 1^{st} long period, K to Br | 5 |
| 2^{nd} long period, Rb to I | 7.5 |
| 3^{rd} long period, Cs to Bi | 9 |

Exemplary anions useful herein and their respective scaled volumes and molecular volumes are shown in Table B below. The dashed bonds indicate bonding to boron.

TABLE B

| | | Molecular | | MIV | Calculated |
|---|---|---|---|---|---|
| | | Formula of | | Per | Total |
| | | Each | | subst. | MV |
| Ion | Structure of Boron Substituents | Substituent | V_{S} | (Å³) | (Å³) |
| tetrakis(perfluorophenyl)borate | 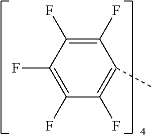 | C₆F₅ | 22 | 183 | 732 |
| tris(perfluorophenyl)- (perfluoronaphthyl)borate | 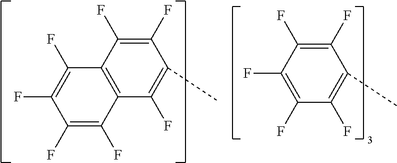 | C₆F₅ C₁₀F₇ | 22 34 | 183 261 | 810 |
| (perfluorophenyl)tris- (perfluoronaphthyl)borate | 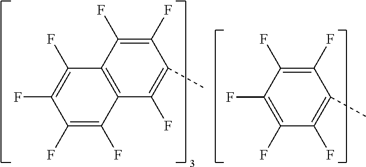 | C₆F₅ C₁₀F₇ | 22 34 | 183 261 | 966 |
| tetrakis(perfluoronaphthyl)borate | | C₁₀F₇ | 34 | 261 | 1044 |
| tetrakis(perfluorobiphenyl)borate | | C₁₂F₉ | 42 | 349 | 1396 |
| [(C₆F₃(C₆F₅)₂)₄B] | | C₁₈F₁₃ | 62 | 515 | 2060 |

The activators may be added to a polymerization in the form of an ion pair using, for example, [M2HTH]+[NCA]− in which the di(hydrogenated tallow)methylamine (“M2HTH”) cation reacts with a basic leaving group on the transition metal complex to form a transition metal complex cation and [NCA]−. Alternatively, the transition metal complex may be reacted with a neutral NCA precursor, such as B(C₆F₅)₃, which abstracts an anionic group from the complex to form an activated species. Useful activators include di(hydrogenated tallow)methylammonium[tetrakis(pentafluorophenyl)borate] (i.e., [M2HTH]B(C₆F₅)₄) and di(octadecyl)tolylammonium[tetrakis(pentafluorophenyl)borate] (i.e., [DOdTH]B(C₆F₅)₄).

Activator compounds that are particularly useful in this disclosure include one or more of:
N,N-di(hydrogenated tallow)methylammonium[tetrakis(perfluorophenyl)borate],
N-methyl-4-nonadecyl-N-octadecylanilinium[tetrakis(perfluorophenyl)borate],
N-methyl-4-hexadecyl-N-octadecylanilinium[tetrakis(perfluorophenyl)borate],
N-methyl-4-tetradecyl-N-octadecylanilinium[tetrakis(perfluorophenyl)borate],
N-methyl-4-dodecyl-N-octadecylanilinium[tetrakis(perfluorophenyl)borate],
N-methyl-4-decyl-N-octadecylanilinium[tetrakis(perfluorophenyl)borate],
N-methyl-4-octyl-N-octadecylanilinium[tetrakis(perfluorophenyl)borate],
N-methyl-4-hexyl-N-octadecylanilinium[tetrakis(perfluorophenyl)borate],
N-methyl-4-butyl-N-octadecylanilinium[tetrakis(perfluorophenyl)borate],
N-methyl-4-octadecyl-N-decylanilinium[tetrakis(perfluorophenyl)borate],
N-methyl-4-nonadecyl-N-dodecylanilinium[tetrakis(perfluorophenyl)borate],
N-methyl-4-nonadecyl-N-tetradecylanilinium[tetrakis(perfluorophenyl)borate],
N-methyl-4-nonadecyl-N-hexadecylanilinium[tetrakis(perfluorophenyl)borate],
N-ethyl-4-nonadecyl-N-octadecylanilinium[tetrakis(perfluorophenyl)borate],
N-methyl-N,N-dioctadecylammonium[tetrakis(perfluorophenyl)borate],
N-methyl-N,N-dihexadecylammonium[tetrakis(perfluorophenyl)borate],
N-methyl-N,N-ditetradecylammonium[tetrakis(perfluorophenyl)borate],
N-methyl-N,N-didodecylammonium[tetrakis(perfluorophenyl)borate],
N-methyl-N,N-didecylammonium[tetrakis(perfluorophenyl)borate],
N-methyl-N,N-dioctylammonium[tetrakis(perfluorophenyl)borate],
N-ethyl-N,N-dioctadecylammonium[tetrakis(perfluorophenyl)borate],
N,N-di(octadecyl)tolylammonium[tetrakis(perfluorophenyl)borate],
N,N-di(hexadecyl)tolylammonium[tetrakis(perfluorophenyl)borate],
N,N-di(tetradecyl)tolylammonium[tetrakis(perfluorophenyl)borate],
N,N-di(dodecyl)tolylammonium[tetrakis(perfluorophenyl)borate],
N-octadecyl-N-hexadecyl-tolylammonium[tetrakis(perfluorophenyl)borate],
N-octadecyl-N-hexadecyl-tolylammonium[tetrakis(perfluorophenyl)borate],
N-octadecyl-N-tetradecyl-tolylammonium[tetrakis(perfluorophenyl)borate],
N-octadecyl-N-dodecyl-tolylammonium[tetrakis(perfluorophenyl)borate],
N-octadecyl-N-decyl-tolylammonium[tetrakis(perfluorophenyl)borate],
N-hexadecyl-N-tetradecyl-tolylammonium[tetrakis(perfluorophenyl)borate],
N-hexadecyl-N-dodecyl-tolylammonium[tetrakis(perfluorophenyl)borate],
N-hexadecyl-N-decyl-tolylammonium[tetrakis(perfluorophenyl)borate],
N-tetradecyl-N-dodecyl-tolylammonium[tetrakis(perfluorophenyl)borate],
N-tetradecyl-N-decyl-tolylammonium[tetrakis(perfluorophenyl)borate],
N-dodecyl-N-decyl-tolylammonium[tetrakis(perfluorophenyl)borate],
N-methyl-N-octadecylanilinium[tetrakis(perfluorophenyl)borate],
N-methyl-N-hexadecylanilinium[tetrakis(perfluorophenyl)borate],
N-methyl-N-tetradecylanilinium[tetrakis(perfluorophenyl)borate],
N-methyl-N-dodecylanilinium[tetrakis(perfluorophenyl)borate],
N-methyl-N-decylanilinium[tetrakis(perfluorophenyl)borate], and
N-methyl-N-octylanilinium[tetrakis(perfluorophenyl)borate].

Additional useful activators and the synthesis thereof, are described in U.S. Pat. No. 11,414,436 (U.S. Ser. No. 16/394,166, filed Apr. 25, 2019), 11,117,908 (U.S. Ser. No. 16/394,186, filed Apr. 25, 2019), and 11,041,031 (U.S. Ser. No. 16/394,197, filed Apr. 25, 2019), each of which is incorporated by reference herein.

In embodiments, the activator is not (and the cation portion of Formula (VI), (VII), (VIII) and (IX) is not the cation in the formulas below):

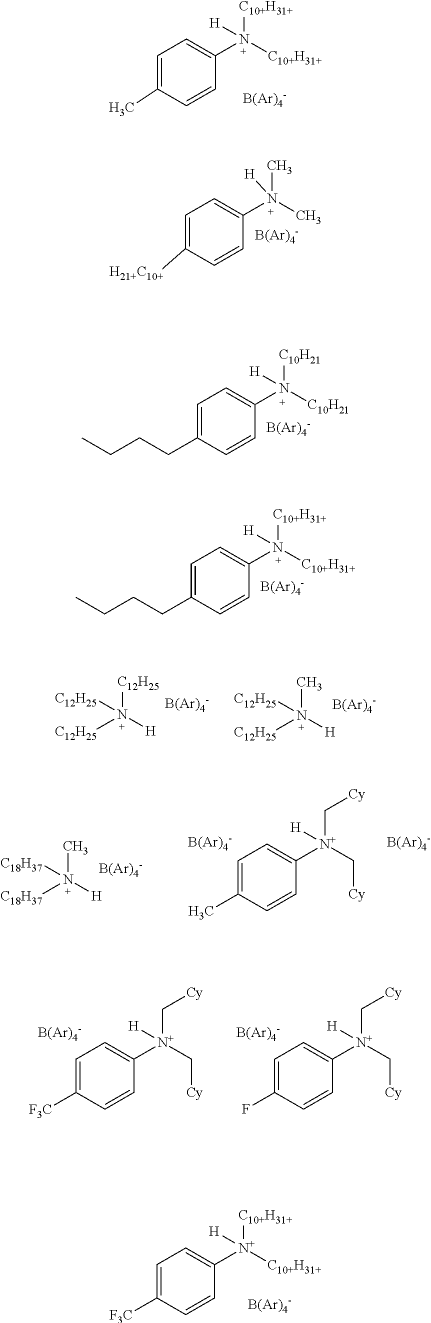

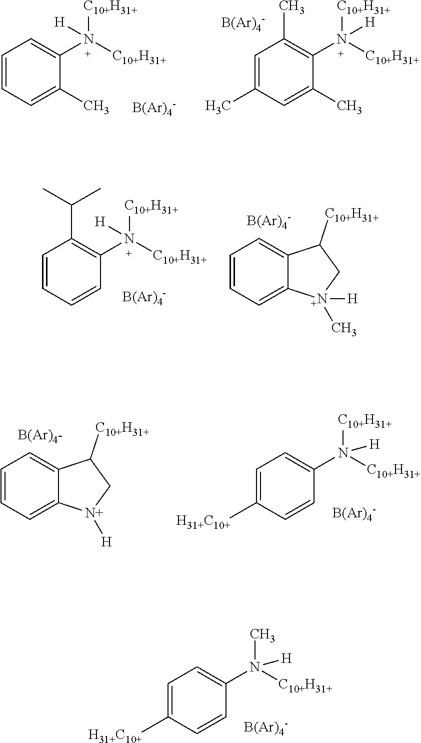

In at least one embodiment, the general synthesis of the activators can be performed using a two-step process. In the first step, an amine or phosphine is dissolved in a solvent (e.g., hexane, cyclohexane, methylcyclohexane, ether, dichloromethane, toluene) and an excess (e.g., 1.2 molar equivalents) of hydrogen chloride is added to form a chloride salt. This salt is typically isolated by filtration from the reaction medium and dried under reduced pressure. The isolated chloride is then heated to reflux with about one molar equivalent of an alkali metal metallate or metalloid (such as a borate or aluminate) in a solvent (e.g., cyclohexane, dichloromethane, methylcyclohexane) to form the desired borate or aluminate along with byproduct alkali metal chloride, the latter of which can typically be removed by filtration.

In at least one embodiment, the general synthesis of the ammonium borate activators can be performed using a two-step process. In the first step, an amine is dissolved in a solvent (e.g. hexane, cyclohexane, methylcyclohexane, ether, dichloromethane, toluene) and an excess (e.g., 1.2 molar equivalents) of hydrogen chloride is added to form an ammonium chloride salt. This salt is typically isolated by filtration from the reaction medium and dried under reduced pressure. The isolated ammonium chloride is then heated to reflux with about one molar equivalent of an alkali metal borate in a solvent (e.g. cyclohexane, dichloromethane, methylcyclohexane) to form the ammonium borate along with byproduct alkali metal chloride, the latter of which can typically be removed by filtration.

A co-activator is a compound capable of alkylating the transition metal complex, such that when used in combination with an activator, an active catalyst is formed. Co-activators can include alumoxanes such as methylalumoxane, modified alumoxanes such as modified methylalumoxane, and aluminum alkyls such trimethylaluminum, tri-isobutylaluminum, triethylaluminum, and tri-isopropylaluminum, tri-n-hexylaluminum, tri-n-octylaluminum, tri-n-decylaluminum or tri-n-dodecylaluminum. Co-activators are typically used in combination with Lewis acid activators and ionic activators when the pre-catalyst is not a dihydrocarbyl or dihydride complex. Sometimes co-activators are also used as scavengers to deactivate impurities in feed or reactors

Additional useful activators include N,N-dimethylanilinium tetrakis(perfluorophenyl)borate, N,N-dimethylanilinium tetrakis(3,5-bis(trifluoromethyl)phenyl) borate, triphenylcarbenium tetrakis(3,5-bis(trifluoromethyl)phenyl)borate, triphenyl carbenium tetrakis(perfluorophenyl)borate, trimethylammonium tetrakis(perfluorophenyl) borate, and tri-n-butylammonium tetrakis(perfluorophenyl)borate.

The typical activator-to-catalyst compound ratio is from about a 1:1 molar ratio. Alternate preferred ranges include from 0.1:1 to 100:1, alternately from 0.5:1 to 50:1. A particularly useful range is from 0.5:1 to 10:1, preferably 1:1 to 5:1. Often a slight excess of activator is used, for example an activator-to-catalyst compound ratio of 1.1:1.

Examples of suitable activators and the synthesis thereof are described in US Pat. Pub. No. 2019/0330139, U.S. Pat. Nos. 11,117,908, and 11,041,031, which are incorporated by reference herein.

### Optional Scavengers and Co-Activators

In addition to activator compounds, scavengers or co-activators may be used. A scavenger is a compound that is typically added to facilitate polymerization by scavenging impurities. Some scavengers may also act as activators and may be referred to as co-activators. A co-activator, that is not a scavenger, may also be used in conjunction with an activator in order to form an active catalyst. In some embodiments a co-activator can be pre-mixed with the transition metal compound to form an alkylated transition metal compound.

Co-activators can include alumoxanes such as methylalumoxane, modified alumoxanes such as modified methylalumoxane, and aluminum alkyls (also referred to as an alkyl-aluminum) such trimethylaluminum, tri-isobutylaluminum, triethylaluminum, and tri-isopropylaluminum, tri-n-hexylaluminum, tri-n-octylaluminum, tri-n-decylaluminum or tri-n-dodecylaluminum. Co-activators are typically used in combination with Lewis acid activators and ionic activators when the pre-catalyst is not a dihydrocarbyl or dihydride complex. Sometimes co-activators are also used as scavengers to deactivate impurities in feed or reactors.

Aluminum alkyl or organoaluminum compounds which may be utilized as scavengers or co-activators include, for example, trimethylaluminum, triethylaluminum, triisobutylaluminum, tri-n-hexylaluminum, tri-n-octylaluminum, and dialkyl zinc, such as diethyl zinc.

A scavenger can be an additional component of a catalyst system described herein. A scavenger is a compound that can be added to facilitate oligomerization or polymerization by scavenging impurities. Some scavengers may also act as activators and may be referred to as co-activators. A co-activator which is not a scavenger may also be used in conjunction with an activator in order to form an active catalyst with a transition metal compound. In some embodiments, a co-activator can be pre-mixed with the transition metal compound to form an alkylated transition metal compound, also referred to as an alkylated catalyst compound or alkylated metallocene. To the extent scavengers facilitate the metallocene compound in performing the intended catalytic function, scavengers, if used, are sometimes considered as a part of the catalyst system.

U.S. Pat. No. 9,409,834 (e.g., at line 37, column 33 to line 61, column 34) provides detailed description of scavengers useful in the process of the present disclosure for making PAO. The relevant portions in this patent on scavengers, their identities, quantity, and manner of use are incorporated herein in their entirety.

Particularly useful scavengers include tri-n-octylaluminum, triethylaluminum, triisobutylaluminum, tri-n-hexylaluminum, and the like.

### Polymerization/Oligomerization Reaction and Process, as Well as Process for Preparing PAO

In some embodiments of the process, the polymerization reaction exhibits a selectivity toward a combination of greater than or equal to about 60 mol % vinylidenes and trisubstituted vinylenes (alternatively greater than 70 mol %, alternatively greater than 80 mol %), and less than or equal to about 10 mol % vinyls, based on total moles of vinyls, vinylidenes, di-substituted vinylenes (excluding cyclic di-substituted vinylenes), and tri-substituted vinylenes in the unsaturated PAO product.

In some embodiments of the process, the polymerization reaction exhibits a selectivity toward greater than or equal to about 50 mol % vinylidenes (alternatively greater than 60 mol %, alternatively greater than 70 mol %, alternatively greater than 80 mol %), and less than or equal to about 10 mol % vinyls, based on total moles of vinyls, vinylidenes, di-substituted vinylenes (excluding cyclic di-substituted vinylenes), and tri-substituted vinylenes in the unsaturated PAO product.

In some embodiments of the process, the polymerization reaction exhibits a selectivity toward dimer formation of greater than 50% (alternatively greater than 60%, alternatively greater than 70%, alternatively greater than 80%, alternatively greater than 90%, alternatively greater than 95%) based on the total amount of dimers, trimer, tetramers and higher oligomers as measured by GC-MS.

In some embodiments of the process, the polymerization reaction exhibits a selectivity toward dimer and trimer formation of greater than 70% (alternatively greater than 80%, alternatively greater than 85%, alternatively greater than 90%, alternatively greater than 95%, alternatively greater than 97%) based on the total amount of dimers, trimer, tetramers and higher oligomers as measured by GC-MS.

In some embodiments the process further comprises: a) contacting the unsaturated PAO product with hydrogen to convert at least a portion of the unsaturated PAO product to a hydrogenated PAO product: b) contacting the unsaturated PAO product with a chemical reagent to convert at least a portion of the unsaturated PAO product to a functionalized PAO product: or a combination thereof.

In some embodiments of the process, the feed comprises one or more cyclic C₆-C₃₂ alpha-olefins selected from vinylcyclobutane, vinylcyclopentane, vinylcyclohexane, 4-vinylcyclohex-1-ene (also referred to as vinylcyclohexene), vinylcycloheptane, vinylcyclooctane, vinylcyclononane, vinylcyclodecane, vinylcycloundecane, vinylcyclododecane, 5-vinylnorbornane, 5-vinyl-2-norbornene, allylcyclohexane, and allylcyclooctane. Preferred cyclic C₆-C₁₄ alpha-olefins include vinylcyclobutane, vinylcyclopentane, vinylcyclohexane, and 4-vinylcyclohex-1-ene. Most preferred cyclic C₆-C₃₂ alpha-olefins include vinylcyclohexane and 4-vinylcyclohex-1-ene with 4-vinylcyclohex-1-ene being most preferred.

In some embodiments of the process, the feed comprises one or more cyclic C₆-C₃₂ alpha-olefins and one or more C₄-C₃₂ linear or C₅-C₃₂ branched alpha-olefins selected from 1-butene, 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, 1-heneicosene, 1-docosene, 1-tricosene, 1-tetracosene, 1-pentacosene, 1-hexacosene, 1-heptacosene, 1-octacosene, 1-nonacosene, 1-triacontene, 4-methyl-1-pentene, 3-methyl-1-pentene, 5-methyl-1-nonene, and 3,5,5-trimethyl-1-hexene. Preferred C₄-C₃₂ linear or C₅-C₃₂ branched alpha-olefins include 1-butene, 1-pentene, 1-hexene, 1-heptene, 1-octene, 1-nonene, 1-decene, 4-methyl-1-pentene, 3-methyl-1-pentene, 5-methyl-1-nonene, and 3,5,5-trimethyl-1-hexene. Most preferred C₄-C₃₂ linear or C₅-C₃₂ branched alpha-olefins include 1-butene, 1-pentene, 1-hexene, 1-heptene, 1-octene, 4-methyl-1-pentene, and 3-methyl-1-pentene. More highly preferred C₄-C₃₂ linear or C₅-C₃₂ branched alpha-olefins include 1-pentene, 4-methyl-1-pentene, and 1-hexene.

In some embodiments, the C₆-C₃₂ cyclic alpha-olefins are C₆-C₂₀ cyclic alpha-olefins, alternatively C₆-C₁₄ cyclic alpha-olefins, alternatively C₈-C₁₂ cyclic alpha-olefins.

In some embodiments, the C₈-C₁₂ cyclic alpha-olefins are non-conjugated dienes.

In some embodiments, the linear alpha olefins are C₄-C₂₀ linear alpha-olefins, alternatively C₄-C₁₂ linear alpha-olefins, alternatively C₄-C₈ linear alpha-olefins, alternatively C₅-C₈ linear alpha olefins, alternatively C₅-C₆ linear alpha olefins.

In some embodiments, the branched alpha-olefins are C₅-C₂₀ branched alpha-olefins, alternatively C₅-C₁₂ branched alpha-olefins, alternatively C₅-C₁₀ branched alpha-olefins, alternatively C₆-C₉ branched alpha olefins, alternatively C₆-C₈ branched alpha olefins.

The selection between making products rich in dimer vs. higher molecular weight PAOs is dependent on a combination of the catalyst choice and the reactor conditions used, in particular reactor temperature. Preferred metallocenes for producing dimer are those of formula (III) and (V). Preferred reactor temperatures for producing dimer are from about 100-200° C., more preferably from about 110-180° C., alternatively from about 120-170° C., alternatively from about 130-160° C., alternatively from about 140-155° C.

In some embodiments, the reaction conditions comprise a reactor temperature of about 120° C. or greater (preferably 130° C. or greater, alternatively 140° C. or greater), and a reactor pressure from 15 psia to 1600 psia.

In some embodiments, the process for producing cyclic dimers from one more cyclic alpha-olefin includes: contacting a feed comprising one or more C₆-C₃₂ cyclic alpha-olefin with a catalyst system comprising a metallocene compound in a polymerization reactor under polymerization conditions to effect a polymerization reaction to obtain a polymerization reaction mixture, the polymerization reaction mixture comprising cyclic dimer molecules having vinylidenes, tri-substituted vinylenes, di-substituted vinylenes and optionally vinyl unsaturation, and obtaining an unsaturated cyclic dimer product from the polymerization reaction mixture. In some embodiments, the metallocene compound is selected from formulas (I), (II), (III), (IV), or (V). In some embodiments, the metallocene compound is selected from formulas (I) or (II), wherein at least one of R¹ and R³ is not hydrogen.

In one non-limiting embodiment, this disclosure relates to a continuous solution and/or bulk process to produce the cyclic dimers comprising: (a) contacting at least one C₄-C₂₄ cyclic alpha-olefin with a metallocene catalyst, a non-coordinating anion activator, and optionally an alkyl-aluminum compound; (b) under polymerization conditions where a reaction temperature is in a range of 100° C. to 160° C., a reactor pressure is less than 50 atmospheres, a residence time of from 20 minutes to 3 hours; and optionally solvent free, except the solvent used for the catalyst and scavenger solution, and wherein the olefin feed is substantially free of linear and branched alpha-olefins; and (c) obtaining the dimeric products, optionally hydrogenating the dimers.

In another non-limiting embodiment, this disclosure relates to a solution and/or bulk process in a batch or semi-batch reactor to produce cyclic dimers. In some embodiments, the process comprises: (a) contacting at least one C₄-C₂₄ cyclic alpha-olefin with a metallocene catalyst, a non-coordinating anion activator, and optionally an alkyl-aluminum compound; (b) under polymerization conditions where a reaction temperature is in a range of 100° C. to 160° C., a reactor pressure is less than 50 atmospheres, and a residence time is from 20 minutes to 24 hours; wherein the catalyst and activator are fed separately in the reactor; wherein all the catalyst can be fed in a single dose at the beginning of the reaction or staged during the reaction and optional solvent free except the solvent used for catalyst and scavenger solution, and wherein the olefin feed is substantially free of linear and branched alpha-olefins; and (c) obtaining the dimeric products, optionally hydrogenating the oligomers.

Many polymerization/oligomerization processes and reactor types used for metallocene-catalyzed polymerization or oligomerization such as bulk, solution, and slurry polymerization or oligomerization processes can be used in this disclosure. The polymerization/oligomerization processes may be carried out in batch mode, semi-batch mode or as a continuous polymerization process. The term “batch” refers to processes in which the complete reaction mixture is withdrawn from the reactor vessel at the conclusion of the polymerization reaction. Semi-batch, allows for the addition of more monomer feed and/or catalyst at one or more intervals during the run, and in some cases, the withdrawal of a portion of the reaction mixture. In contrast, in a continuous polymerization process, one or more reactants (i.e. feed, catalyst, optional scavenger) are introduced continuously to the reactor vessel and the reactor content comprising the polymeric product is withdrawn concurrently or near concurrently. When a continuous polymerization process is used, the polymerization/oligomerization processes may be carried out in a continuous stirred tank reactor, a plug flow reactor (sometimes called continuous tubular reactor) or a reactor with any monomer concentration distribution pattern between CSTR and plug flow. The polymerization/oligomerization processes may be carried out in a single reactor or multiple reactors. When multiple reactors are employed, the reactors can be arranged in either series or parallel configuration or in any combination of series and parallel configuration. The polymerization/oligomerization reactors can be operated either in liquid full mode or partial liquid filled mode with gas phase head space. If a solid or supported catalyst is used, a slurry or continuous fixed bed or plug flow process may be suitable.

Olefin feed may be treated to remove catalyst poisons, such as peroxides, oxygen, or nitrogen-containing organic compounds or acetylenic compounds before being supplied to the polymerization reactor. For example, the feed olefins may be treated with an activated molecular sieve, such as 3 Å, 4 Å, 8 Å, or 13 Å molecular sieve, and/or in combination with an activated alumina or an activated de-oxygenate catalyst.

In any embodiment, solvent or diluent may be present in the reactor. Suitable diluents/solvents for conducting the polymerization reaction include non-coordinating, inert liquids. In particular embodiments, the reaction mixture for the polymerization reactions disclosed herein may include at least one hydrocarbon solvent. Examples include straight and branched-chain hydrocarbons, such as butane, isobutane, pentane, isopentane, hexanes, isohexane, heptane, octane, decanes, dodecane, and mixtures thereof; cyclic and alicyclic hydrocarbons, such as cyclohexane, cycloheptane, methylcyclohexane, methylcycloheptane, and mixtures thereof, such as can be found commercially (Isopar™); halogenated and perhalogenated hydrocarbons, such as perfluorinated C₄₋₁₀ alkanes, chlorobenzene, and mixtures thereof; and aromatic and alkyl-substituted aromatic compounds, such as benzene, toluene, mesitylene, ethylbenzene, xylene, and mixtures thereof. Mixtures of any of the foregoing hydrocarbon solvents may also be used. Suitable solvents also include liquid olefins which may act as monomers or co-monomers including 1-butene, 1-hexene, 1-pentene, 3-methyl-1-pentene, 4-methyl-1-pentene, 1-octene, 1-decene, 4-vinylcyclohex-1-ene and mixtures thereof. Preferable solvents/diluents can include methylcyclohexane, toluene, xylenes, ethylbenzene, normal paraffins (such as NORPAR® solvents available from ExxonMobil Chemical Company in Houston, TX), isoparaffin solvents (such as ISOPAR® solvents available from ExxonMobil Chemical Company in Houston, TX), and combinations thereof. These solvents or diluents may typically be pre-treated in the same manners as the feed olefins.

In some embodiments of the disclosure, non-aromatic diluents/solvents are preferred, Suitable non-aromatic diluents/solvents for polymerization include non-coordinating, inert liquids. Examples include straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (Isopar™); perhalogenated hydrocarbons, such as perfluorinated C₄ to C₁₀ alkanes. Suitable solvents also include liquid olefins which may act as monomers or comonomers including C₄ to C₃₂ alpha-olefins such as 1-butene, 1-hexene, 1-pentene, 3-methyl-1-pentene, 4-methyl-1-pentene, 1-octene, 1-decene, 1-dodecene, 1-tetradecene, 1-hexadecene, 1-octadecene, and mixtures thereof. In a preferred embodiment, aliphatic hydrocarbon solvents are used as the solvent, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof. In an alternative preferred embodiment the solvents used are C₅ to C₁₈ alpha-olefins, alternatively C₅ to C₁₆ alpha-olefins, alternatively C₆ to C₁₄ alpha-olefins, or mixtures thereof. Mixtures of any of the above listed solvents may be used.

In another embodiment, the solvent is not aromatic, preferably aromatics are present in the solvent at less than 3 wt %, preferably less than 2 wt %, preferably less than 1 wt %, preferably less than 0.5 wt %, preferably less than 0.1 wt % based upon the weight of the solvents. Preferably, the solvent or mixture of solvents is aromatic free.

Preferably the solvent is selected from C₄ to C₁₀ linear, branched or cyclic alkanes. Preferably the solvent is essentially free of all aromatic solvents. In other embodiments of the disclosure, preferably the solvent is selected from one or more C₅ to C₃₂ alpha olefins, such as one or more C₅ to C₁₆ alpha olefins. Preferably the solvent is essentially free of all non-alpha-olefin solvents.

In some embodiment, hydrogen may be added to the reactor to improve catalyst performance and to influence the properties of the resulting oligomers. When present, the amount of hydrogen can be kept at such a level to improve catalyst productivity, but preferably not induce too much (preferably any significant) hydrogenation of olefins, especially the feed alpha-olefins (the reaction of alpha-olefins into saturated paraffin can be very detrimental to the efficiency of the process). The amount of hydrogen partial pressure is thus preferred to be kept low, e.g., less than 350 kPa, less than 170 kPa, less than 70 kPa, or less than 35 kPa; additionally or alternatively, the concentration of hydrogen in the reactant phase, in the reactor and/or feed, can be less than 10,000 ppm (by wt.), e.g., less than 1000 ppm, less than 500 ppm, less than 100 ppm, less than 50 ppm, less than 25 ppm, or less than 10 ppm.

Alternatively, the polymerization/oligomerization process is free of hydrogen. Polymerization or oligomerization in absence of hydrogen may be advantageous to provide polymers or oligomers with high degree of unsaturated double bonds. These double bonds can be easily converted into functionalized fluids with multiple performance features. Examples for converting oligomers and/or polymers can be found in preparation of ashless dispersants, e.g., by reacting the polymers with maleic anhydride to give PAO-succinic anhydride which can then reacted with amines, alcohols, and/or polyether alcohols to convert into dispersants, such as disclosed in the book “Lubricant Additives: Chemistry and Application,” ed. By Leslie R. Rudnick, p. 143-170.

Typically, one or more metallocene compounds, one or more activators, and one or more monomers are contacted to produce the invented polymers or oligomers. Preferably, the catalyst, activator, or optional co-activator is a soluble compound, the reaction can be carried out in a solution polymerization processes. Even if one of the components is not completely soluble in the reaction medium or in the feed stream, either at the beginning of the reaction or during or at later stages of the reaction, a solution type operation may still be applicable. In any instance, the catalyst system components, dissolved or suspended in solvents, such as in aromatic solvents or in aliphatic solvent, or in the monomer feed stream, can be fed into the reactor under inert atmosphere (usually nitrogen or argon blanketed atmosphere) to allow the polymerization or oligomerization to take place.

The catalyst and activator may be delivered as solution in a solvent or in the olefin feed stream, either separately to the reactor (activated in-line just prior to the reactor or activated in the reactor), or pre-activated and delivered as an activated solution to the reactor. In some embodiments, the metallocene compound can be activated in the reactor in the presence of olefin. In another alternative, the pre-catalyst metallocene can be pre-mixed with the activator and/or the co-activator, and this activated catalyst solution can then be charged into reactor. Alternatively, the metallocene compound (such as a dichloride form of the metallocene compound) may be pre-treated with an alkylaluminum reagent, especially triisobutylaluminum, tri-n-hexylaluminum, and/or tri-n-octylaluminum, followed by charging into the reactor containing other catalyst system component and the feed olefins, or followed by pre-activation with the other catalyst system component to give the fully activated catalyst, which can then be fed into the reactor containing feed olefins.

In preferred embodiments, where all solvent is the olefin monomer, the pre-catalyst is dissolved in the monomer feed in a first feed vessel and the activator is mixed in the monomer feed in a second feed vessel. The pre-catalyst solution and the activator solution are then fed into the reactor separately, and catalyst activation occurs in the reactor. If used, the scavenger can be fed in independently, or with the activator feed, the pre-catalyst feed, or the monomer feed if a separate monomer feed is being used. Alternatively, the pre-catalyst and activator are premixed separately in inert solvent and premixed solutions are then fed into the reactor. Catalyst activation occurs in the reactor.

The metallocene compound and activator can also be delivered in suspension or dry powder form. Most single-site catalysts and activators received from the manufacturer are in finely divided solid or “powder” form. The solid catalyst and/or activator can be milled to a fine powder if not originally in such form. The catalysts and activators can be delivered into a solution or slurry polymerization reactor as a slurry in an aliphatic hydrocarbon solvent, oil or wax, or in a dry powder form without sacrificing catalyst utilization efficiency. The catalysts and/or activators can be mixed with an aliphatic hydrocarbon solvent or mixture of solvents to form a suspension, mixed with high viscosity material or wax to form a thick suspension or delivered as a dry powder using a powder feeder. The catalyst is then dissolved in polymerization media inside the polymerization reactor and initiates the polymerization. The catalyst may be directly added to the polymerization reactor and subsequently contacted with an activator, or it may be first contacted with the activator and the resulting mixture subsequently added to the polymerization reactor.

In any embodiment, the catalyst, activator and when required, co-activator, may also be delivered as supported catalysts. For supported catalysts, the active ingredients of such catalysts and/or activator are supported on solid, insoluble supports. When a solid supported catalyst is used, a polymerization/oligomerization process generally operates in the similar temperature, pressure, and residence time range as described for the solution processes. The residual catalyst can be separated from the product by filtration, centrifuge, or settlement. The fluid is then distilled to remove solvent, any unreacted components and light product. A portion or all of the solvent and unreacted component or light components can be recycled for reuse.

Any of polymerization/oligomerization processes and reactor types used for metallocene-catalyzed polymerization or oligomerization such as bulk, solution, and slurry polymerization or oligomerization processes can be used in this disclosure. Each of these processes can be carried out in a continuous stirred tank reactor or plug flow reactor with a single reactor or more than one reactors operated in series or parallel configuration. For a single reactor operation, monomer, or several monomers, catalyst/activator, optional co-activator, optional scavenger, and optional modifiers are all fed into a single reactor. Operation and the properties of the resulting products are affected by the process conditions and the composition of the reactor medium. In another embodiment, these processes can be carried out in multiple reactors in series reactor operation, in which the above components can be added to each of two or more reactors connected in series. The catalyst system components can be added to the first reactor in the series. The catalyst system component may alternatively be added to both reactors. In one embodiment, the same catalyst is used in both the first reactor and the second reactor. Alternatively, the catalyst used in the first reactor is different from one used in the second reactor. All the content including oligomer produced, unreacted monomer(s), and active catalyst in the first reactor can be transferred into the second reactor. Alternatively, only part of the content in the first reactor is transferred into the second reactor. Oligomers produced in each reactor can have different molecular weight and/or composition. The differences in molecular weight and/or composition are determined by end-use requirements. The molecular weight and composition can be controlled through process conditions in each reactor such as monomer concentration and polymerization temperature. This can be realized by controlling the process conditions such as monomer feed rate, catalyst feed rate and heat removal mechanism. Preferably the monomer concentration and temperature in each reactor can be controlled independently. In one embodiment, co-oligomers (oligomers from two or more alpha-olefins) are produced in the first reactor of the series configuration. In another embodiment, these processes can be carried out in multiple reactors with parallel configuration. The advantage of parallel operation is the independent control of the properties of the resulting products. In one embodiment, co-oligomers are produced in each reactor of the parallel operation. In another embodiment, homo-oligomers are produced in one reactor and co-oligomers are produced in another reactor of the parallel operation. For example, 1-hexene/VCH co-oligomer is produced in one reactor and VCH oligomer is produced in another reactor. In one embodiment, the same catalyst is used in all reactors. Alternatively, the catalyst used in one reactor is different from the one used in another reactor of the parallel configuration. Parallel operation also provides additional freedom in process optimization such as maximizing the desired products and process efficiency.

Many of polymerization/oligomerization processes and reactor types used for metallocene-catalyzed polymerization or oligomerization such as bulk, solution, and slurry polymerization or oligomerization processes can be used in this disclosure. Each of these processes may also be employed in batch or semi-batch mode operation. For batch mode of polymerization or oligomerization, all the components are added into a reactor and allowed to react to a pre-designed degree of conversion, either to partial conversion or full conversion. Subsequently, the catalyst can be deactivated by any possible means, such as exposure to air or water, or by addition of alcohols or solvents containing deactivating agents.

The polymerization or oligomerization can additionally or alternatively be carried out in a semi-batch operation, where feeds and catalyst system components can be continuously and/or simultaneously added to the reactor so as to maintain a constant concentration ratio of catalyst to olefin(s). When all feeds and catalyst system components are added, the reaction may be allowed to proceed to a pre-determined stage. The reaction can then be discontinued by catalyst deactivation in the same manner as described for batch operation. Monomer(s) and catalyst can also be fed in stages for manipulation of the properties of oligomers produced and temperature control. In one embodiment, all of the monomers are fed into the reactor prior to the onset of polymerization. The catalyst is fed into the reactor in stages, preferably less than 50% of the catalyst is fed at the beginning. Alternatively, one of olefin monomer can be fed in stage so oligomers with different composition can be produced.

Any of polymerization/oligomerization processes and reactor types used for metallocene-catalyzed polymerization or oligomerization such as bulk, solution, and slurry polymerization or oligomerization processes can be used in this disclosure. In any embodiments, the temperature in any reactor used herein can be from −10° C. to 250° C., e.g., from 30° C. to 220° C., preferably from 50° C. to 200° C., from 60° C. to 200° C., from 70° C. to 200° C., from 100° C. to 200° C., from 110° C. to 180° C., from 120° C. to 170° C., from 130° C. to 160° C., or from 140° C. to 155° C. Alternatively, the polymerization reaction conditions comprise a temperature of 80° C. or greater, 100° C. or greater, 120° C. or greater, 130° C. or greater, 140° C. or greater. Temperature control in the reactor can generally be obtained by balancing the heat of polymerization and with reactor cooling by reactor jackets or cooling coils or a cooled side-stream of reactant to cool the contents of the reactor, auto refrigeration, pre-chilled feeds, vaporization of liquid medium (diluent, monomers, or solvent) or combinations of the above. Adiabatic reactors with pre-chilled feeds may additionally or alternatively be used. Agitation of the reactor content is commonly practiced to reduce or avoid concentration or temperature gradients.

In any embodiments, the pressure in any reactor used herein can be from 0.1 to 120 atmospheres, e.g., from 0.5 to 75 atmospheres or from 1 to 50 atmospheres. The monomer(s), metallocene(s) and activator(s) can be contacted in the reactor for a residence time of 1 second to 100 hours, e.g., 30 seconds to 50 hours, 2 minutes to 24 hours, or 10 minute to 24 hours, or 10 minute to 12 hours, or 10 minute to 6 hours, or 10 minute to 3 hours or 10 minute to 2 hours.

Molecular weight distribution or polydispersity of the oligomers produced is important for some applications. For most metallocene catalysts, the molecular weight of the oligomers is sensitive to the process conditions such as reactor temperature and monomer concentration. In order to produce a product with narrow molecular weight distribution, good temperature control and intensive mixing are recommended to minimize the fluctuations of the temperature and monomer concentration. A process with low monomer conversion (high monomer concentration) in the reactor can also reduce the dependence of molecular weight on the monomer concentration, thereby narrowing the molecular weight distribution.

The oligomers described in this disclosure can have a vinyl, or vinylidene, or di-substituted vinylene, or tri-substituted vinylene chain end, depending the catalyst type and chain termination mechanisms. For some applications, the types of the unsaturated chain end of the oligomer are important. Process conditions such as reaction temperature and H₂ concentration can be used to adjust the level of the unsaturated chain end for a given catalyst system. For example, with some catalyst systems, high reaction temperature favors production of oligomers with vinylidene and tri-substituted vinylene chain end.

When the polymerization or oligomerization reaction is progressed to the pre-determined stage, such as above 20% or above 30% or above 40% or above 50% or above 60% or above 70% or above 80% or above 90% of olefin conversion, the reactor effluent is withdrawn from the reactor. The reaction effluent contains active catalysts. These active components can preferably be deactivated and/or removed. Typically, the reaction can be deactivated by addition of stoichiometric amount or excess of air, water, alcohol, isopropanol, etc. Any of the usual catalyst deactivation methods or aqueous wash methods can be used to remove the catalyst system component. The mixture can then be washed with dilute sodium hydroxide or with water to remove catalyst system components. The residual organic layer may then be subjected to distillation to remove solvent and unreacted monomers, which can optionally be recycled for reuse.

The reactor products produced herein are usually a mixture of many different oligomers. Extraction or fractionation may be carried out to separate the product into multiple fractions with differing boiling point ranges, corresponding to differing molecular weight range and differing degree of polymerization. The unreacted monomers can be recycled back to the reactor. The oligomeric fractions can be also hydrogenated, depending on the applications.

In a preferred embodiment, this disclosure relates to a continuous solution and a bulk process to produce the oligomers comprising: (a) contacting at least one alpha-olefin monomer and at least one cyclic alpha-olefin having 4 to 24 carbon atoms with a metallocene catalyst, a non-coordinating anion activator, and optionally an alkyl-aluminum compound; (b) under polymerization conditions where the reaction temperature is in a range of 70° C. to 160° C., and reactor pressure is less than 50 atmospheres, a residence time of from 20 minutes to 3 hours; and optionally solvent free except the solvent used for the catalyst and scavenger solution; (c) obtaining the oligomeric products (unsaturated PAO), optionally fractionating the oligomers and hydrogenating the oligomers.

In another preferred embodiment, this disclosure relates to a solution and/or bulk process in a batch or semi-batch reactor to produce the oligomers comprising: (a) contacting at least one alpha-olefin monomer and at least one cyclic alpha-olefin having 4 to 24 carbon atoms with a metallocene catalyst, a non-coordinating anion activator, and optionally an alkyl-aluminum compound; (b) under polymerization conditions where the reaction temperature is in a range of 70° C. to 160° C., and reactor pressure is less than 50 atmospheres, a residence time is from 20 minutes to 24 hours; catalyst and activator are fed separately in the reactor; all the catalyst can be fed in a single dose at the beginning of the reaction or staged during the reaction and optional solvent free except the solvent used for catalyst and scavenger solution; (c) obtaining the oligomeric products (unsaturated PAO), optionally fractionating the oligomers and hydrogenating the oligomers.

While long or short residence times may be used, the choice is dependent on the choice of catalyst, concentration of monomers, the reaction temperature and the desired conversion level. While residence times as short at 1 minute and as long as 48 hours may be used, preferred residence times range from 20 minutes to 2 hours in a continuous process, and from 20 minutes to 12 hours in a batch or semi-batch process.

### Feed

In some embodiments of the process, the feed comprises one or more cyclic C₆-C₃₂ alpha-olefins selected from vinylcyclobutane, vinylcyclopentane, vinylcyclohexane,

4-vinylcyclohex-1-ene (also referred to as vinylcyclohexene), vinylcycloheptane, vinylcyclooctane, vinylcyclononane, vinylcyclodecane, vinylcycloundecane, vinylcyclododecane, 5-vinylnorbornane, 5-vinyl-2-norbornene, allylcyclohexane, and allylcyclooctane. In some embodiments of the process, the feed comprises one or more cyclic C₆-C₁₄ alpha-olefins selected from vinylcyclobutane, vinylcyclopentane, vinylcyclohexane, and 4-vinylcyclohex-1-ene. In some embodiments of the process, the feed comprises one or more C₆-C₃₂ alpha-olefins selected from vinylcyclohexane and 4-vinylcyclohex-1-ene. In some embodiments of the process, the feed comprises 4-vinylcyclohex-1-ene.

In some embodiments of the process, the feed comprises one or more cyclic C₆-C₃₂ alpha-olefins and one or more C₄-C₃₂ linear or C₅-C₃₂ branched alpha-olefins selected from 1-butene, 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, 1-heneicosene, 1-docosene, 1-tricosene, 1-tetracosene, 1-pentacosene, 1-hexacosene, 1-heptacosene, 1-octacosene, 1-nonacosene, 1-triacontene, 4-methyl-1-pentene, 3-methyl-1-pentene, 5-methyl-1-nonene, and 3,5,5-trimethyl-1-hexene. In some embodiments of the process, the feed comprises one or more C₄-C₃₂ linear alpha-olefins or C₅-C₃₂ branched alpha-olefins selected from 1-butene, 1-pentene, 1-hexene, 1-heptene, 1-octene, 1-nonene, 1-decene, 4-methyl-1-pentene, 3-methyl-1-pentene, 5-methyl-1-nonene, and 3,5,5-trimethyl-1-hexene. In some embodiments of the process, the feed comprises one or more C₄-C₃₂ linear alpha-olefins or C₅-C₃₂ branched alpha-olefins selected from 1-butene, 1-pentene, 1-hexene, 1-heptene, 1-octene, 4-methyl-1-pentene, and 3-methyl-1-pentene. In some embodiments of the process, the feed comprises one or more C₄-C₃₂ linear alpha-olefins or C₅-C₃₂ branched alpha-olefins selected from 1-pentene, 4-methyl-1-pentene, and 1-hexene.

In some embodiments, the C₆-C₃₂ cyclic alpha-olefins are C₆-C₂₀ cyclic alpha-olefins (e.g., C₆-C₁₄ cyclic alpha-olefins or C₈-C₁₂ cyclic alpha-olefins).

In some embodiments, the C₈-C₁₂ cyclic alpha-olefins are non-conjugated dienes.

In some embodiments, the linear alpha olefins are C₄-C₂₀ linear alpha-olefins (e.g., C₄-C₁₂ linear alpha-olefins, C₄-C₈ linear alpha-olefins, C₅-C₈ linear alpha olefins, or C₅-C₆ linear alpha olefins).

In some embodiments, the branched alpha-olefins include C₅-C₂₀ branched alpha-olefins (e.g., C₅-C₁₂ branched alpha-olefins, C₅-C₁₀ branched alpha-olefins, C₆-C₉ branched alpha olefins, or C₆-C₈ branched alpha olefins).

uPAO Product and Product by Process

In some embodiments of the process, the polymerization reaction exhibits a selectivity toward a combination of at least about 60 mol % vinylidenes and tri-substituted vinylenes (e.g., at least about 70 mol % or at least about 80 mol %), and up to about 10 mol % vinyls, based on total moles of vinyls, vinylidenes, di-substituted vinylenes (excluding cyclic di-substituted vinylenes), and tri-substituted vinylenes in the unsaturated PAO product.

In some embodiments of the process, the polymerization reaction exhibits a selectivity toward at least about 50 mol % vinylidenes (e.g., at least about 60 mol %, at least about 70 mol %, or at least about 80 mol %), and less than or equal to about 10 mol % vinyls, based on total moles of vinyls, vinylidenes, di-substituted vinylenes (excluding cyclic di-substituted vinylenes), and tri-substituted vinylenes in the unsaturated PAO product.

In some embodiments of the process, the polymerization reaction exhibits a selectivity toward dimer formation of at least about 50% (e.g., at least about 60%, at least about 70%, at least about 80%, at least about 90%, or at least about 95%) based on the total amount of dimers, trimer, tetramers, and higher oligomers as measured by GC-MS.

In some embodiments of the process, the polymerization reaction exhibits a selectivity toward dimer and trimer formation of at least about 70% (e.g., at least about 80%, at least about 85%, at least about 90%, at least about 95%, or at least about 97%) based on the total amount of dimers, trimer, tetramers, and higher oligomers as measured by GC-MS.

In some embodiments the process further comprises: a) contacting the unsaturated PAO product with hydrogen to convert at least some of the unsaturated PAO product to a hydrogenated PAO product: b) contacting the unsaturated PAO product with a chemical reagent to convert at least some of the unsaturated PAO product to a functionalized PAO product: or both a) and b).

The selection between making products rich in dimer vs. higher molecular weight PAOs depends at least in part on a combination of the catalyst choice and the reactor conditions (e.g., reactor temperature). In some embodiments, metallocenes for producing dimer include metallocene compounds represented by formula (III) and formula (V). Suitable reactor temperatures for producing dimers can range from about 100° C. to about 200° C. (e.g., about 110° C. to about 180° C., about 120° C. to about 170° C., about 130° C. to about 160° C., or from about 140° C. to about 155° C.).

In some embodiments, the reaction conditions include a reactor temperature of at least about 120° C. (e.g., at least about 130° C. or at least about 140° C.) and a reactor pressure in a range of about 15 psia to about 1600 psia.

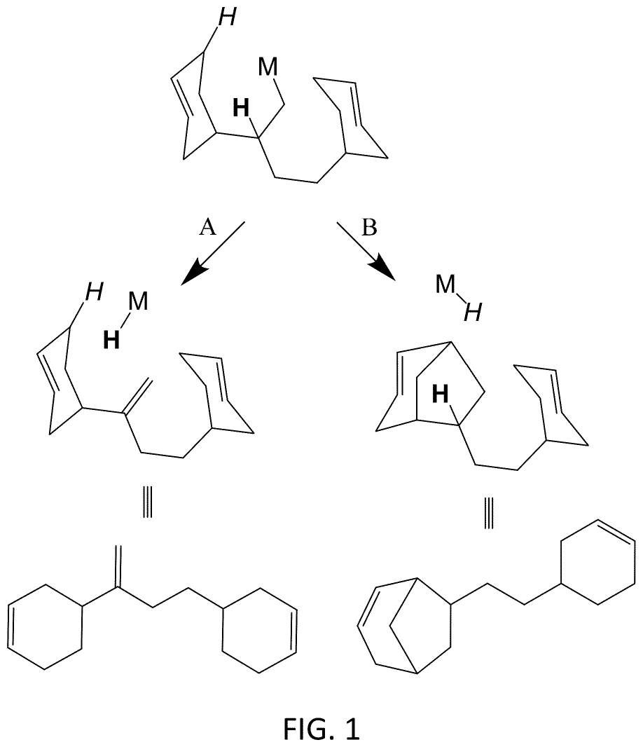

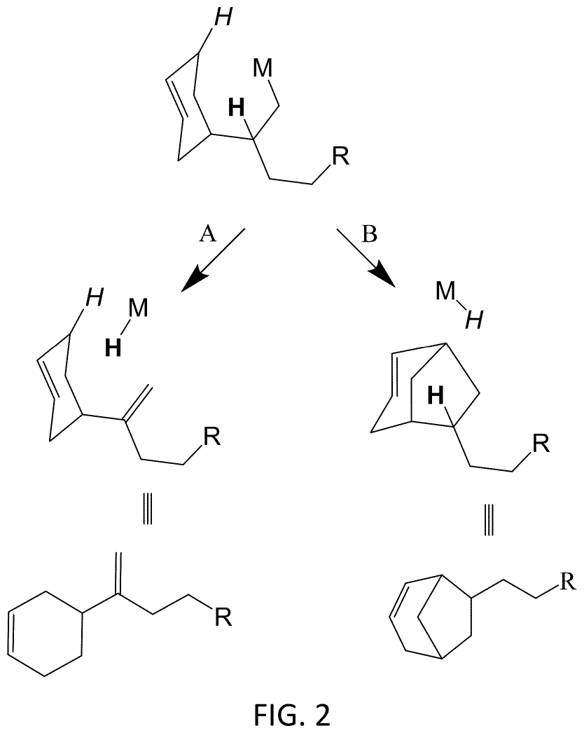

In some embodiments, 4-vinylcyclohex-1-ene (VCH) is used together with other cyclic alpha-olefins or other linear or branched alpha-olefins. VCH, a diene, is capable of undergoing a chain transfer process which leads to a bicyclic product. FIG. 1 depicts two reaction pathways in which VCH undergoes a chain transfer process and yields a bicyclic product. Pathway A illustrates a beta-hydride chain termination pathway, where M represents the catalyst active site. The beta-H (dark gray) is transferred to M, yielding a dimeric product containing vinylidene unsaturation. In pathway B, M interacts with the double bond of the last inserted VCH monomer, leading to close proximity of the epsilon-hydride (light gray). The epsilon-hydride transfers to the metal, yielding a bicyclic ring structure. This latter chain transfer pathway does not occur with ring saturated alpha-olefins such as vinylcyclohexane. A similar pathway is illustrated in FIG. 2, where the first inserted alpha-olefin is represented as CH₂═CHR, where R can be a linear, branched, or cyclic aliphatic group.

In some embodiments of the disclosure, the PAO product comprises a mixture of unsaturated dimers selected from the compounds depicted below.

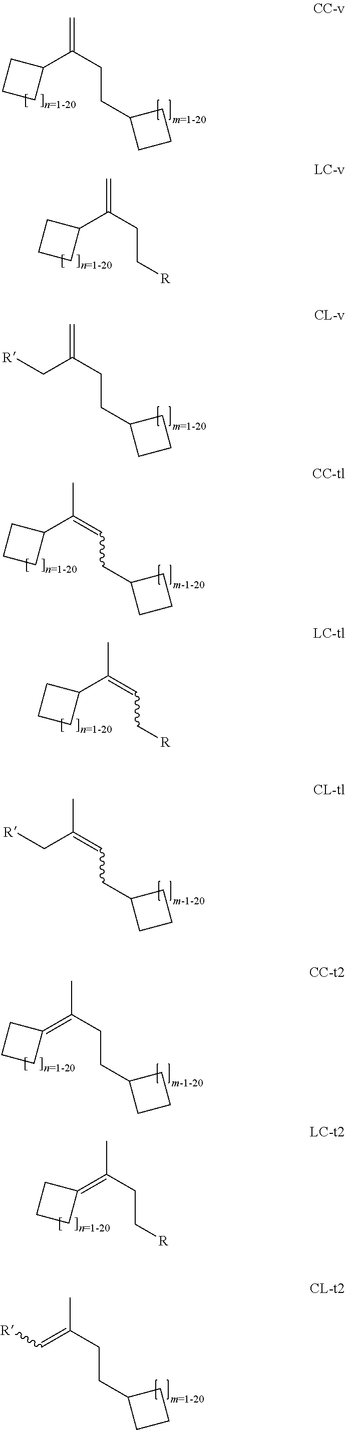

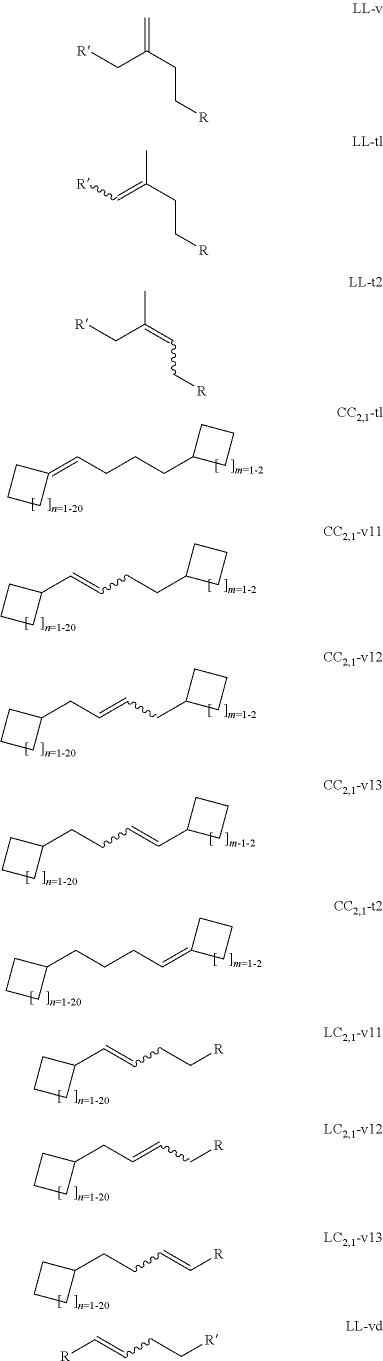

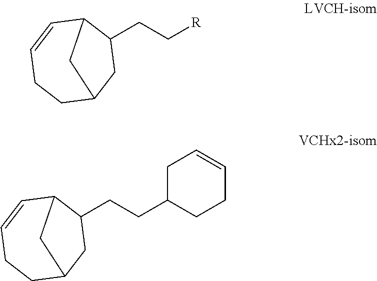

wherein cyclic monomer fragments (A) and (B) are independently saturated if the cyclic alpha-olefin has a saturated ring structure or partially unsaturated if the cyclic alpha-olefin has a partially unsaturated ring structure; and

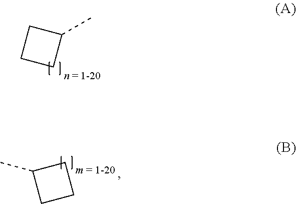

wherein n and m independently indicate the number of additional carbon atoms in the ring structure and can be an integer from 1 to 20 (e.g., 1-12, 1-9, 1-5, or 1-3), R is a C₂-C₃₀ hydrocarbyl group, R′ is a C₁-C₂₉ hydrocarbyl group, and at least one of structures CL-v or LC-v are present in the PAO product mixture. Note that the wavy bond in the structures indicates that both E and Z isomers are included.

In some embodiments, independently, n and m are preferably 1-5, more preferably 2-4, and most preferably 3. In some embodiments, R is preferably a C₂-C₈ hydrocarbyl group, more preferably a C₂-C₆ hydrocarbyl group, alternatively a C₂-C₄ hydrocarbyl group, alternatively a C₃-C₄ hydrocarbyl group. In some embodiments, R′ is preferably a C₁-C₇ hydrocarbyl group, more preferably a C₁-C₈ hydrocarbyl group, alternatively a C₁-C₃ hydrocarbyl group, alternatively a C₂-C₃ hydrocarbyl group. In some embodiments of the disclosure, n and m independently represent an integer from 1 to 5, R is a C₂-C₈ hydrocarbyl group, and R′ is a C₁-C₇ hydrocarbyl group. In some embodiments of the disclosure, n and m are 3, R is a C₃-C₈ hydrocarbyl group, and R′ is a C₂-C₇ hydrocarbyl group, and the cyclic monomer fragments (A) and (B), have a partially unsaturated ring structure.

In some embodiments of the disclosure, CC-v and CL-v and/or LC-v are present in the PAO product. In some embodiments of the disclosure, LL-v and CL-v and/or LC-v are present in the PAO product. In some embodiments of the disclosure, CC-v, LL-v, and CL-v and/or LC-v are present in the PAO product.

In some embodiments of the disclosure, CC-v is selected from the following structures, wherein each q is, independently, an integer:

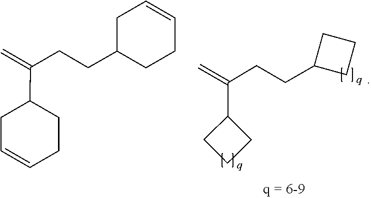

In some embodiments of the disclosure, CC-t1 is selected from the following structures, wherein each q is, independently, an integer:

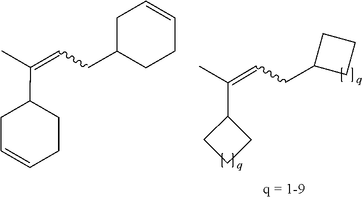

In some embodiments of the disclosure, in the CC-t1 structure illustrated above, q is preferably 1-5, more preferably 2-3.

In some embodiments of the disclosure, CC-12 is selected from the following structures, wherein each q is, independently, an integer.

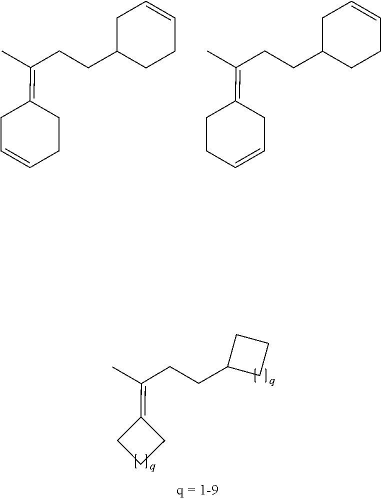

In some embodiments of the disclosure, in the CC-12 structure illustrated above, q is preferably 1-5, more preferably 2-3.

In some embodiments of the disclosure, LC-v is selected from the following structures, wherein p is integer.

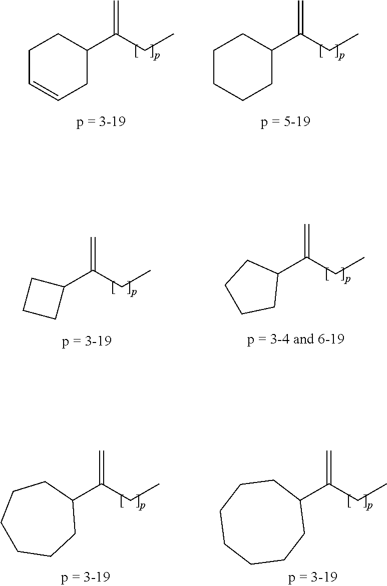

In some embodiments of the disclosure, in the LC-v structures illustrated above where p=3-19, p is preferably 3-11, more preferably 4-7, most preferably 4-5, with 5 being most preferred. For the structure with p-5-19, p is preferably 5. For the structure with p-3-4 and 6-19, p is preferably 3-4 and 6-7, most preferably 4.

In some embodiments of the disclosure, LC-t1 is selected from the following structures, wherein p is an integer:

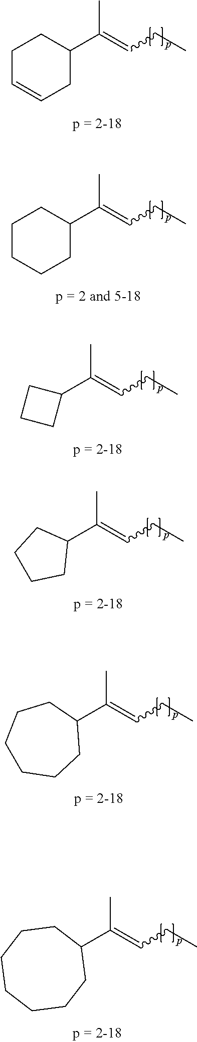

In some embodiments of the disclosure, in the LC-t1 structures illustrated above where p=2-18, p is preferably 2-10, more preferably 3-6, most preferably 3-4, with 4 being most preferred. For the structure with p=2 and 5-20, p is preferably 2 and 5-10, most preferably 2, 5 and 6.

In some embodiments of the disclosure, LC-t2 is selected from the following structures, wherein p is an integer:

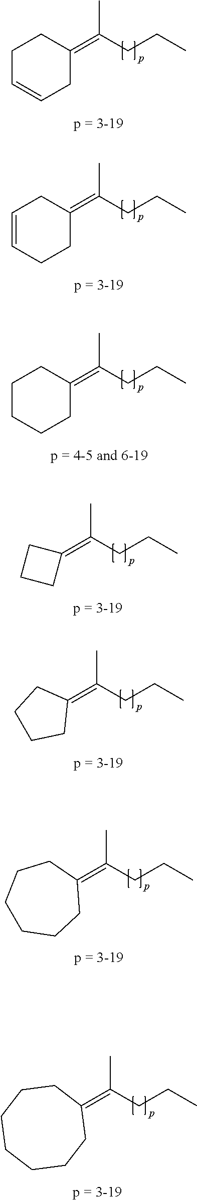

In some embodiments of the disclosure, in the LC-12 structures illustrated above where p=3-19, p is preferably 3-11, more preferably 4-7, most preferably 4-5, with 5 being most preferred. For the structure with p=4-5 and 6-19, p is preferably 3 and 6-7, most preferably 3 and 7.

In some embodiments of the disclosure, CL-v is selected from the following structures wherein p is an integer.

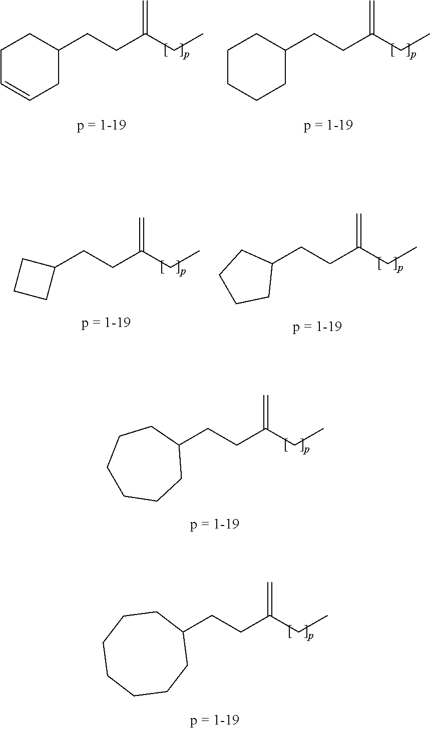

In some embodiments of the disclosure, in the CL-v structures illustrated above p is preferably 1-9, more preferably 2-5, most preferably 2-3, with 3 being most preferred.

In some embodiments of the disclosure, CL-t1 is selected from the following structures, wherein p is an integer:

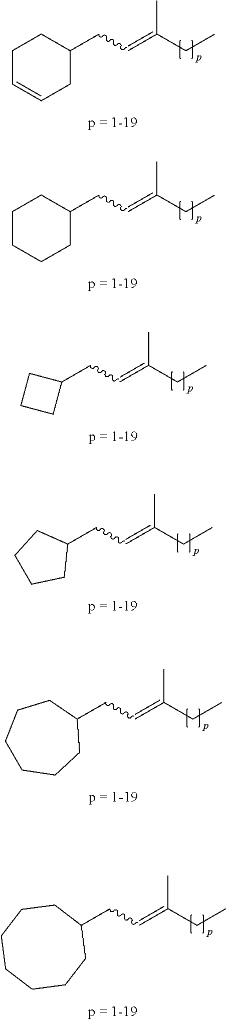

In some embodiments of the disclosure, in the CL-t1 structures illustrated above p is preferably 1-9, more preferably 2-5, most preferably 2-3, with 3 being most preferred.

In some embodiments of the disclosure, CL-t2 is selected from the following structures, wherein p is an integer:

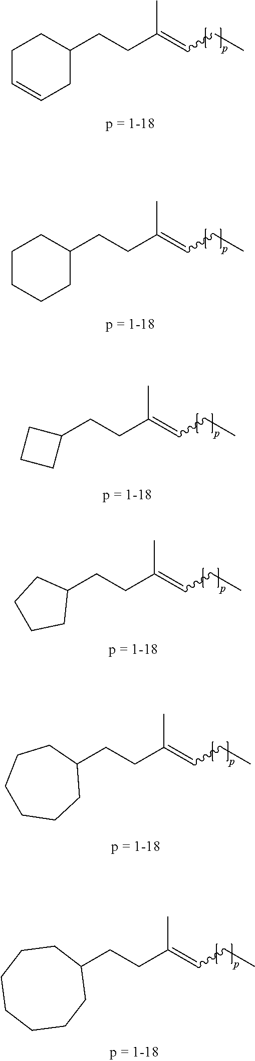

In some embodiments of the disclosure, in the CL-t2 structures illustrated above p is preferably 1-8, more preferably 1-4, most preferably 1-2, with 2 being most preferred.

In some embodiments of the disclosure, the following structures are preferred, wherein p is an integer:

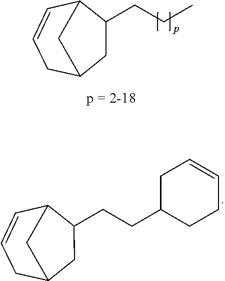

In some embodiments of the disclosure, in the structures illustrated above p is preferably 2-8, more preferably 3-6, most preferably 3-4, with 4 being most preferred.

In an embodiment of the disclosure, the PAO product comprises 7-(2-(cyclohex-3-en-1-yl)ethyl)bicyclo[3.2.1]oct-2-ene.

In an embodiment of the disclosure, the PAO product comprises 7-hexylbicyclo[3.2.1]oct-2-ene.

In an embodiment of the disclosure, the PAO product comprises 7-pentylbicyclo[3.2.1]oct-2-ene.

In an embodiment of the disclosure, the PAO product comprises 4,4′-(but-3-ene-1,3-diyl)dicyclohex-1-ene.

In an embodiment of the disclosure, the PAO product comprises 4-(oct-1-en-2-yl)cyclohex-1-ene.

In an embodiment of the disclosure, the PAO product comprises oct-1-en-2-ylcyclohexane.

In an embodiment of the disclosure, the PAO product comprises 4-(hept-1-en-2-yl)cyclohex-1-ene.

In an embodiment of the disclosure, the PAO product comprises hept-1-en-2-ylcyclohexane.

In an embodiment of the disclosure, the PAO product comprises 4-(non-1-en-2-yl)cyclohex-1-ene.

In an embodiment of the disclosure, the PAO product comprises non-1-en-2-ylcyclohexane.

In an embodiment of the disclosure, the PAO product comprises 4-(hex-1-en-2-yl)cyclohex-1-ene.

In an embodiment of the disclosure, the PAO product comprises 4-(6-methylhept-1-en-2-yl)cyclohex-1-ene.

In an embodiment of the disclosure, the PAO product comprises (6-methylhept-1-en-2-yl)cyclohexane.

In some embodiments, the PAO is a mixture of unsaturated dimers produced from two different alpha-olefins wherein at least one alpha-olefin is a cyclic alpha-olefin (C) and at least a second alpha-olefin is a linear or branched alpha-olefin (L). The unsaturated dimers produced are represented by the formulas CC, CL, and LL. The dimer product distribution may vary and depends at least in part on the molar ratio of C and L used in the oligomerization reaction. In some embodiments, the ratio of C and L used in the process are chosen such that the percentage of CL produced, based on CC+CL+LL equaling 100%, is at least about 20%, at least about 30%, at least about 40%, at least about 50%, at least about 60%, at least about 70%, or at least about 80%. In some embodiments, the percentage of CC produced, based on CC+CL+LL equaling 100%, is 0%, more typically at least 1%, and up to about 35%, up to about 30%, up to about 25%, up to about 20%, up to about 15%, up to about 10%, or up to about 5%. In some embodiments, the percentage of LL produced, based on CC+CL+LL equaling 100%, is at least about 10% and up to about 80%, up to about 70%, up to about 60%, up to about 50%, up to about 40%, up to about 30%, or up to about 20%. All percentages relative to CC, CL and LL ratios are based on GC-MS as described in the experimental section.

In an embodiment of the disclosure, the PAO product comprises 4,4′-(but-3-ene-1,3-diyl)dicyclohex-1-ene (VCHx2), 4-(oct-1-en-2-yl)cyclohex-1-ene (VCH-hex) and 5-methyleneundecane (hex-hex). In some embodiments, the mole percentage of VCH-hex based on the total moles of VCHx2+VCH-hex+hex-hex equaling 100% is at least about 20%, at least about 30%, at least about 40%, at least about 50%, at least about 60%, at least about 70%, or at least about 80%. In some embodiments, the mole percentage of VCHx2 produced, based on VCHx2+VCH-hex+hex-hex equaling 100%, is at least about 0%, more typically at least 1%, and up to about 35%, up to about 30%, up to about 25%, up to about 20%, up to about 15%, up to about 10%, or up to about 5%. In some embodiments, the mole percentage of hex-hex produced, based on VCHx2+VCH-hex+hex-hex equaling 100%, is at least about 10% and up to about 80%, up to about 70%, up to about 60%, up to about 50%, up to about 40%, up to about 30%, or up to about 20%. All percentages and relative ratios are based on GC-MS as described in the experimental section.

In an embodiment of the disclosure, the PAO product comprises but-3-ene-1,3-diyldicyclohexane (VCH′x2), oct-1-en-2-ylcyclohexane (VCH′-hex) and 5-methyleneundecane (hex-hex). In some embodiments, the mole percentage of VCH′-hex based on the total moles of VCH′x2+VCH′-hex+hex-hex equaling 100% is at least about 20%, at least about 30%, at least about 40%, at least about 50%, at least about 60%, at least about 70%, or at least about 80%. In some embodiments, the mole percentage of VCH x2 produced, based on VCH x2+VCH′-hex+hex-hex equaling 100%, is 0%, more typically at least about 1%, and up to about 35%, up to about 30%, up to about 25%, up to about 20%, up to about 15%, up to about 10%, or up to about 5%. In some embodiments, the mole percentage of hex-hex produced, based on VCH x2+VCH′-hex+hex-hex equaling 100%, is at least about 10% and up to about 80%, up to about 70%, up to about 60%, up to about 50%, up to about 40%, up to about 30%, or up to about 20%. All percentages and relative ratios are based on GC-MS as described in the experimental section.

In an embodiment of the disclosure, the PAO product comprises 4,4′-(but-3-ene-1,3-diyl)dicyclohex-1-ene (VCHx2), 4-(hept-1-en-2-yl)cyclohex-1-ene (VCH-pent) and 4-methylenenonane (pent-pent). In some embodiments, the mole percentage of VCH-pent based on the total moles of VCHx2+VCH-pent+pent-pent equaling 100% is at least about 20%, at least about 30%, at least about 40%, at least about 50%, at least about 60%, at least about 70%, or at least about 80%. In some embodiments, the mole percentage of VCHx2 produced, based on VCHx2+VCH-pent+pent-pent equaling 100%, is 0%, more typically at least about 1%, and up to about 35%, up to about 30%, up to about 25%, up to about 20%, up to about 15%, up to about 10%, or up to about 5%. In some embodiments, the mole percentage of pent-pent produced, based on VCHx2+VCH-pent+pent-pent equaling 100%, is at least about 10% and up to about 80%, up to about 70%, up to about 60%, up to about 50%, up to about 40%, up to about 30%, or up to about 20%. All percentages and relative ratios are based on GC-MS as described in the experimental section.

In an embodiment of the disclosure, the PAO product comprises but-3-ene-1,3-diyldicyclohexane (VCH x2), hept-1-en-2-ylcyclohexane (VCH′-pent), and 4-methylenenonane (pent-pent). In some embodiments, the mole percentage of VCH′-pent based on the total moles of VCH x2+VCH′-pent+pent-pent equaling 100% is at least about 20%, at least about 30%, at least about 40%, at least about 50%, at least about 60%, at least about 70%, or at least about 80%. In some embodiments, the mole percentage of VCH′x2 produced, based on VCH x2+VCH′-pent+pent-pent equaling 100%, is 0%, more typically at least about 1%, and up to about 35%, up to about 30%, up to about 25%, up to about 20%, up to about 15%, up to about 10%, or up to about 5%. In some embodiments, the mole percentage of pent-pent produced, based on VCH x2+VCH′-pent+pent-pent equaling 100%, is at least about 10% and up to about 80%, up to about 70%, up to about 60%, up to about 50%, up to about 40%, up to about 30%, or up to about 20%. All percentages and relative ratios are based on GC-MS as described in the experimental section.

In an embodiment of the disclosure, the PAO product comprises 4,4′-(but-3-ene-1,3-diyl)dicyclohex-1-ene (VCHx2), 4-(non-1-en-2-yl)cyclohex-1-ene (VCH-hept) and 6-methylenetridecane (hept-hept). In some embodiments, the mole percentage of VCH-hept based on the total moles of VCHx2+VCH-hept+hept-hept equaling 100% is at least about 20%, at least about 30%, at least about 40%, at least about 50%, at least about 60%, at least about 70%, or at least about 80%. In some embodiments, the mole percentage of VCHx2 produced, based on VCHx2+VCH-hept+hept-hept equaling 100%, is 0%, more typically at least about 1%, and up to about 35%, up to about 30%, up to about 25%, up to about 20%, up to about 15%, up to about 10%, or up to about 5%. In some embodiments, the mole percentage of hept-hept produced, based on VCHx2+VCH-hept+hept-hept equaling 100%, is at least about 10% and up to about 80%, up to about 70%, up to about 60%, up to about 50%, up to about 40%, up to about 30%, or up to about 20%. All percentages and relative ratios are based on GC-MS as described in the experimental section.

In an embodiment of the disclosure, the PAO product comprises but-3-ene-1,3-diyldicyclohexane (VCH′x2), non-1-en-2-ylcyclohexane (VCH′-hept) and 6-methylenetridecane (hept-hept). In some embodiments, the mole percentage of VCH′-hept based on the total moles of VCH x2+VCH′-hept+hept-hept equaling 100% is at least about 20%, at least about 30%, at least about 40%, at least about 50%, at least about 60%, at least about 70%, or at least about 80%. In some embodiments, the mole percentage of VCH x2 produced, based on VCH′x2+VCH′-hept+hept-hept equaling 100%, is 0%, more typically at least about 1%, and up to about 35%, up to about 30%, up to about 25%, up to about 20%, up to about 15%, up to about 10%, or up to about 5%. In some embodiments, the mole percentage of hept-hept produced, based on VCH x2+VCH′-hept+hept-hept equaling 100%, is at least about 10% and up to about 80%, up to about 70%, up to about 60%, up to about 50%, up to about 40%, up to about 30%, or up to about 20%. All percentages and relative ratios are based on GC-MS as described in the experimental section.

In an embodiment of the disclosure, the PAO product comprises 4,4′-(but-3-ene-1,3-diyl)dicyclohex-1-ene (VCHx2), 4-(hex-1-en-2-yl)cyclohex-1-ene (VCH-but) and 3-methyleneheptane (but-but). In some embodiments, the mole percentage of VCH-but based on the total moles of VCHx2+VCH-but+but-but equaling 100% is at least about 20%, at least about 30%, at least about 40%, at least about 50%, at least about 60%, at least about 70%, or at least about 80%. In some embodiments, the mole percentage of VCHx2 produced, based on VCHx2+VCH-but+but-but equaling 100%, is 0%, more typically at least about 1%, and up to about 35%, up to about 30%, up to about 25%, up to about 20%, up to about 15%, up to about 10%, or up to about 5%. In some embodiments, the mole percentage of but-but produced, based on VCHx2+VCH-but+but-but equaling 100%, is at least about 10% and up to about 80%, up to about 70%, up to about 60%, up to about 50%, up to about 40%, up to about 30%, or up to about 20%. All percentages and relative ratios are based on GC-MS as described in the experimental section.

In an embodiment of the disclosure, the PAO product comprises but-3-ene-1,3-diyldicyclohexane (VCH x2), hex-1-en-2-ylcyclohexane (VCH′-but) and 3-methyleneheptane (but-but). In some embodiments, the mole percentage of VCH′-but based on the total moles of VCH x2+VCH′-but+but-but equaling 100% is at least about 20%, at least about 30%, at least about 40%, at least about 50%, at least about 60%, at least about 70%, or at least about 80%. In some embodiments, the mole percentage of VCH x2 produced, based on VCH x2+VCH′-but+but-but equaling 100%, is 0%, more typically at least about 1%, and up to about 35%, up to about 30%, up to about 25%, up to about 20%, up to about 15%, up to about 10%, or up to about 5%. In some embodiments, the mole percentage of but-but produced, based on VCH′x2+VCH′-but+but-but equaling 100%, is at least about 10% and up to about 80%, up to about 70%, up to about 60%, up to about 50%, up to about 40%, up to about 30%, or up to about 20%. All percentages and relative ratios are based on GC-MS as described in the experimental section.

In an embodiment of the disclosure, the PAO product comprises 4,4′-(but-3-ene-1,3-diyl)dicyclohex-1-ene (VCHx2), 4-(6-methylhept-1-en-2-yl)cyclohex-1-ene (VCH-MePent) and 2,8-dimethyl-4-methylenenonane (MePent-MePent). In some embodiments, the mole percentage of VCH-MePent based on the total moles of VCHx2+VCH-MePent+MePent-MePent equaling 100% is at least about 20%, at least about 30%, at least about 40%, at least about 50%, at least about 60%, at least about 70%, or at least about 80%. In some embodiments, the mole percentage of VCHx2 produced, based on VCHx2+VCH-MePent+MePent-MePent equaling 100%, is 0%, more typically at least about 1%, and up to about 35%, up to about 30%, up to about 25%, up to about 20%, up to about 15%, up to about 10%, or up to about 5%. In some embodiments, the mole percentage of MePent-MePent produced, based on VCHx2+VCH-MePent+MePent-MePent equaling 100%, is at least about 10% and up to about 80%, up to about 70%, up to about 60%, up to about 50%, up to about 40%, up to about 30%, or up to about 20%. All percentages and relative ratios are based on GC-MS as described in the experimental section.

In an embodiment of the disclosure, the PAO product comprises but-3-ene-1,3-diyldicyclohexane (VCH x2), (6-methylhept-1-en-2-yl)cyclohexane (VCH′-MePent), and 2,8-dimethyl-4-methylenenonane (MePent-MePent). In some embodiments, the mole percentage of VCH′-MePent based on the total moles of VCH x2+VCH′-MePent+MePent-MePent equaling 100% is at least about 20%, at least about 30%, at least about 40%, at least about 50%, at least about 60%, at least about 70%, or at least about 80%. In some embodiments, the mole percentage of VCH′x2 produced, based on VCH x2+VCH′-MePent+MePent-MePent equaling 100%, is 0%, more typically at least about 1%, and up to about 35%, up to about 30%, up to about 25%, up to about 20%, up to about 15%, up to about 10%, or up to about 5%. In some embodiments, the mole percentage of MePent-MePent produced, based on VCH x2+VCH′-MePent+MePent-MePent equaling 100%, is at least about 10% and up to about 80%, up to about 70%, up to about 60%, up to about 50%, up to about 40%, up to about 30%, or up to about 20%. All percentages and relative ratios are based on GC-MS as described in the experimental section.

In some embodiments of the disclosure when only cyclic alpha-olefins are in the feed, the conversion of cyclic alpha-olefin to dimer is 30% or greater, alternatively 40% or greater, alternatively 50% or greater, alternatively 60% or greater, alternatively 70% or greater, alternatively 80% or greater, alternatively 86% or greater, alternatively 90% or greater, alternatively 92% or greater, alternatively 94% or greater, alternatively 95% or greater, alternatively 96% or greater, or alternatively 98% or greater based on the total amount of feed monomer, including isomerized or hydrogenated monomer, dimers, trimer, tetramers, and higher oligomers, as measured by GC-MS.

In some embodiments of the disclosure, selectivity of forming dimer when only cyclic alpha-olefins are in the feed, is 80% or greater, alternatively 90% or greater, alternatively 94% or greater, alternatively 98% or greater, with 99% or greater being most preferred based on the total amount of dimers, trimer, tetramers, and higher oligomers, as measured by GC-MS.

In some embodiments of the disclosure, selectivity for forming one dimeric species (one isomer) when only cyclic alpha-olefins are in the feed, is 80% or greater, alternatively 85% or greater, alternatively 90% or greater, alternatively 95% or greater, alternatively 98% or greater based on the total amount of dimers, as measured by GC-MS.

In some embodiments of the disclosure, conversion of cyclic alpha-olefin monomer to forming one dimeric species (one isomer) when only cyclic alpha-olefins are in the feed is 30% or greater, alternatively 40% or greater, alternatively 50% or greater, alternatively 60% or greater, alternatively 70% or greater, alternatively 80% or greater, alternatively 86% or greater, alternatively 90% or greater, alternatively 92% or greater, alternatively 94% or greater, alternatively 95% or greater, alternatively 96% or greater, or alternatively 98% or greater based on the amount of the predominant dimer isomer relative to the total amount of feed monomer, including isomerized or hydrogenated monomer, dimers, trimer, tetramers, and higher oligomers as measured by GC-MS.

### Hydrogenation

Some of the unsaturated PAO product can be hydrogenated to obtain an at least partly saturated PAO product. In some embodiments, the treated product is contacted with hydrogen and a hydrogenation catalyst to produce an at least partly saturated, hydrogenated PAO product, e.g., at a temperature from about 25° C. to about 350° C. (e.g., about 100° C. to about 300° C.), for about 5 minutes to about 100 h (e.g., from about 5 minutes to about 24 h), at a hydrogen pressure of about 25 psig to about 2500 psig (i.e., about 170 kPag to about 17 MPag) (e.g., about 100 psig to about 2000 psig (i.e., about 690 kPag to about 14 MPag). Further information on hydrogenation of unsaturated PAO products can be found in U.S. Pat. No. 5,573,657 and “Lubricant Base Oil Hydrogen Refining Processes” (page 119 to 152 of Lubricant Base Oil and Wax Processing, by Avilino Sequeira, Jr., Marcel Dekker, Inc., NY, 1994), which are incorporated herein by reference.

This hydrogenation process can be accomplished, e.g., in a slurry reactor, in a batch operation, or in a continuous stirred tank reactor (CSTR), where the catalyst is 0.001 wt % to 20 wt % of the unsaturated PAO feed (e.g., from 0.01 wt % to 10 wt %), hydrogen, and the uPAOs can be continuously added to the reactor to allow for certain residence time (e.g., 5 minutes to 10 h), to allow desired (e.g., substantially complete) hydrogenation of the unsaturated olefins. The amount of catalyst added may usually be very small, just to compensate for catalyst deactivation. The catalyst and hydrogenated PAO can be continuously withdrawn from the reactor. The product mixture can be filtered, centrifuged, or settled to remove the solid hydrogenation catalyst. The catalyst can be regenerated and reused, if desired. The hydrogenated PAO can be used as-is or further distilled or fractionated to a desired level. In some cases, when the hydrogenation catalyst shows little or no catalyst deactivation over long term operation, the stir tank hydrogenation process can be carried out in a manner in which a fixed amount of catalyst is maintained in the reactor (e.g., from about 0.1 wt % to about 10% of the total reactant), with mostly (or only) hydrogen and PAO feed continuously added at certain feed rates, and with predominantly (or only) hydrogenated PAO withdrawn from the reactor.

The hydrogenation process can additionally or alternatively be accomplished by a fixed bed process, in which the solid catalyst can be packed inside a tubular reactor and heated to reactor temperature. Hydrogen and PAO feed can be fed through the reactor simultaneously from the top or bottom or counter-current, e.g., to maximize the contact between hydrogen, PAO, and catalyst and to allow heat management. The feed rate of the PAO and hydrogen can be adjusted to give proper residence time, e.g., to allow desired (typically substantially complete) hydrogenation of the unsaturated PAOs in the feed. The hydrogenated PAO fluid can be used as-is or further distilled or fractionated to a desired level. Usually, the hydrogenated PAO product can have a bromine number of up to about 2.

In some embodiments, the hydrogenated PAO (hPAO) product comprises a mixture of dimers selected from:

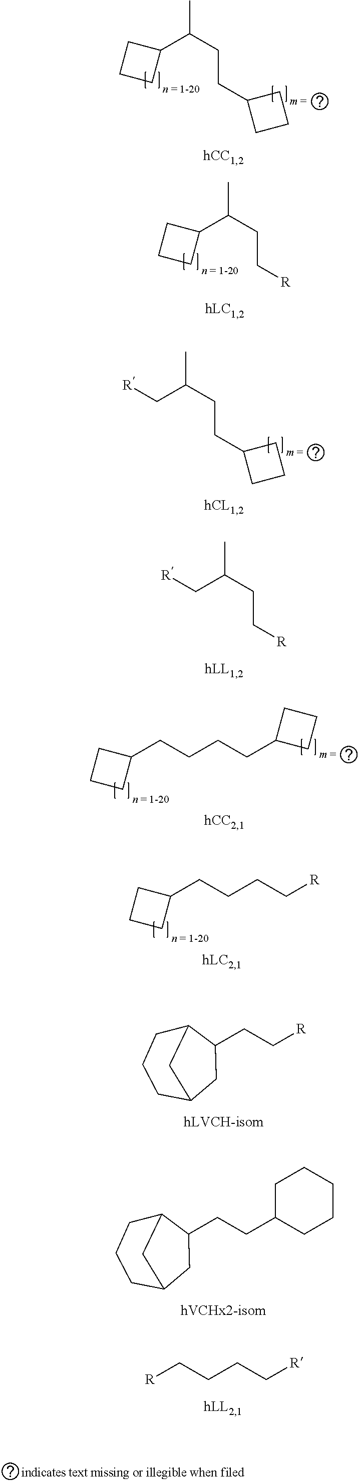

wherein cyclic monomer fragments (A) and (B) are saturated ring structures:

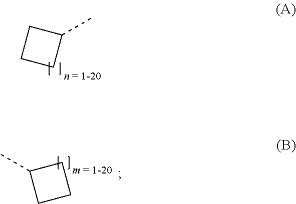

and
wherein: n and m independently indicate the number of additional carbon atoms in the ring structure and can be an integer from 1 to 20 (e.g., 1-12, 1-9, 1-5, 1-3), R is a C₂-C₃₀ hydrocarbyl group, R′ is a C₁-C₂₉ hydrocarbyl group, and wherein at least one of structures hCL_{1,2} or hLC_{1,2} are present in the hydrogenated PAO product mixture.

In some embodiments, independently, n and m are preferably 1-5, more preferably 2-4, and most preferably 3. In some embodiments, R is preferably a C₂-C₈ hydrocarbyl group, more preferably a C₂-C₆ hydrocarbyl group, alternatively a C₂-C₄ hydrocarbyl group, alternatively a C₃-C₄ hydrocarbyl group. In some embodiments, R′ is preferably a C₁-C₇ hydrocarbyl group, more preferably a C₁-C₈ hydrocarbyl group, alternatively a C₁-C₃ hydrocarbyl group, alternatively a C₂-C₃ hydrocarbyl group.

In some embodiments of the disclosure, n and m independently represent an integer from 1 to 5, R is a C₂-C₈ hydrocarbyl group, and R′ is a C₁-C₇ hydrocarbyl group. In some embodiments of the disclosure, n and m are 3, R is a C₃-C₈ hydrocarbyl group, and R′ is a C₂-C₇ hydrocarbyl group.

In some embodiments of the disclosure, hCC_{1,2} and hLC_{1,2} and/or hCL_{1,2} are present in the hPAO product. In some embodiments of the disclosure, hLL_{1,2} and hLC_{1,2} and/or hCL_{1,2} are present in the hPAO product. In some embodiments of the disclosure, hCC_{1,2}, hLL_{1,2}, and hLC_{1,2} and/or hCL_{1,2} are present in the hPAO product.

In some embodiments of the disclosure, hCC_{1,2} is selected from the following structures, wherein each q is, independently, an integer:

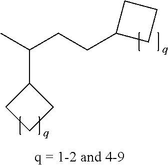

In some embodiments of the disclosure, hLC_{1,2} is selected from the following structures, wherein each p is an integer:

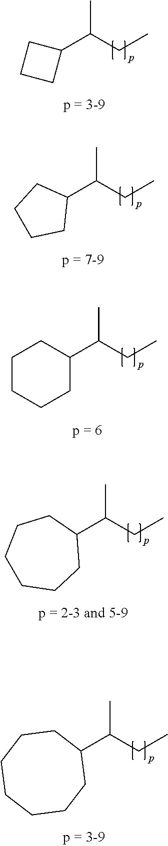

In some embodiments of the disclosure, hCL_{1,2} is selected from the following structures, wherein each p is an integer:

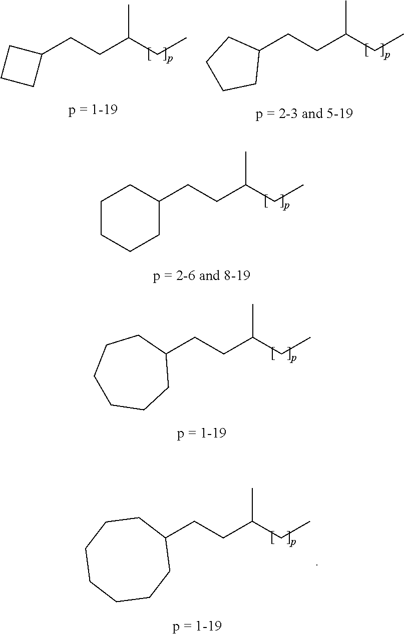

In some embodiments of the disclosure, in the hCL_{1,2} structures illustrated above when p is 1-9, p is preferably 1-9, more preferably 2-5, most preferably 2-3, with 3 being most preferred. For the structure with p=2-3 and 5-19, p is preferably 2-3 and 6-7, most preferably 2 and 3. For the structure with p=2-6 and 8-19, p is preferably 2-6, most preferably 2 and 3.

In some embodiments of the disclosure, the following structures are preferred, wherein p is an integer:

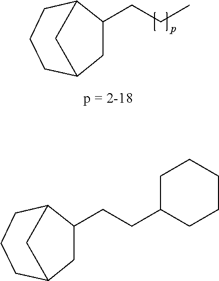

In some embodiments of the disclosure, in the structures illustrated above p is preferably 2-8, more preferably 3-6, most preferably 3-4, with 4 being most preferred.

In an embodiment of the disclosure, the hPAO product comprises 6-(2-cyclohexylethyl)bicyclo[3.2.1]octane.

In an embodiment of the disclosure, the hPAO product comprises 6-hexylbicyclo[3.2.1]octane.

In an embodiment of the disclosure, the hPAO product comprises 6-pentylbicyclo[3.2.1]octane.

In an embodiment of the disclosure, the hPAO product comprises nonan-2-ylcyclohexane.

In an embodiment of the disclosure, the hPAO product comprises (6-methylheptan-2-yl)cyclohexane.

In some embodiments, the hydrogenated PAO is a mixture of saturated dimers produced from two different alpha-olefins wherein at least one alpha-olefin is a cyclic alpha-olefin (C) and at least one alpha-olefin is a linear or branched alpha-olefin (L), and wherein the saturated dimers produced after hydrogenation are represented by the formulas hCC, hCL, and hLL. The saturated dimer product distribution may vary and depends at least in part on the molar ratio of C and L used in the oligomerization reaction. In some embodiments, the ratio of C and L used in the process are chosen such that the percentage of hCL produced after hydrogenation, based on hCC+hCL+hLL equaling 100%, is at least about 20%, at least about 30%, at least about 40%, at least about 50%, at least about 60%, at least about 70%, or at least about 80%. In some embodiments, the percentage of hCC produced, based on hCC+hCL+hLL equaling 100%, is 0%, more typically at least about 1%, and up to about 35%, up to about 30%, up to about 25%, up to about 20%, up to about 15%, up to about 10%, or up to about 5%. In some embodiments, the percentage of hLL produced, based on hCC+hCL+hLL equaling 100%, at least about 10%, and up to about 80%, up to about 70%, up to about 60%, up to about 50%, up to about 40%, up to about 30%, or up to about 20%. All percentages relative to hCC, hCL and hLL ratios are based on GC-MS as described in the experimental section.

In an embodiment of the disclosure, the hPAO product comprises butane-1,3-diyldicyclohexane (hVCHx2), octan-2-ylcyclohexane (hVCH-hex) and 5-methylundecane (hHex-hex). In some embodiments, the mole percentage of h VCH-hex based on the total moles of hVCHx2+hVCH-hex+hHex-hex equaling 100% is at least about 20%, at least about 30%, at least about 40%, at least about 50%, at least about 60%, at least about 70%, or at least about 80%. In some embodiments, the mole percentage of hVCHx2 produced, based on hVCHx2+hVCH-hex+hHex-hex equaling 100%, is 0%, more typically at least about 1%, and up to about 35%, up to about 30%, up to about 25%, up to about 20%, up to about 15%, up to about 10%, or up to about 5%. In some embodiments, the mole percentage of hHex-hex produced, based on hVCHx2+hVCH-hex+hHex-hex equaling 100%, is at least about 10% and up to about 80%, up to about 70%, up to about 60%, up to about 50%, up to about 40%, up to about 30%, or up to about 20%. All percentages and relative ratios are based on GC-MS as described in the experimental section.

In an embodiment of the disclosure, the hPAO product comprises butane-1,3-diyldicyclohexane (hVCHx2), 4-nonan-2-ylcyclohexane (hVCH-pent) and 4-methylnonane (hPent-pent). In some embodiments, the mole percentage of hVCH-pent based on the total moles of hVCHx2+hVCH-pent+hPent-pent equaling 100% is at least about 20%, at least about 30%, at least about 40%, at least about 50%, at least about 60%, at least about 70%, or at least about 80%. In some embodiments, the mole percentage of hVCHx2 produced, based on hVCHx2+hVCH-pent+hPent-pent equaling 100%, is 0%, more typically at least about 1%, and up to about 35%, up to about 30%, up to about 25%, up to about 20%, up to about 15%, up to about 10%, or up to about 5%. In some embodiments, the mole percentage of hPent-pent produced, based on hVCHx2+hVCH-pent+hPent-pent equaling 100%, is at least about 110% and up to about 80%, up to about 70%, up to about 60%, up to about 50%, up to about 40%, up to about 30%, or up to about 20%. All percentages and relative ratios are based on GC-MS as described in the experimental section.

In an embodiment of the disclosure, the hPAO product comprises butane-1,3-diyldicyclohexane (hVCHx2), 4-heptan-2-ylcyclohexane (hVCH-hept) and 6-methyltridecane (hHept-hept). In some embodiments, the mole percentage of hVCH-pent based on the total moles of hVCHx2+hVCH-hept+hHept-hept equaling 100% is at least about 20%, at least about 30%, at least about 40%, at least about 50%, at least about 60%, at least about 70%, or at least about 80%. In some embodiments, the mole percentage of hVCHx2 produced, based on hVCHx2+hVCH-hept+hHept-hept equaling 100%, is 0%, more typically at least about 1%, and up to about 35%, up to about 30%, up to about 25%, up to about 20%, up to about 15%, up to about 10%, or up to about 5%. In some embodiments, the mole percentage of hHept-hept produced, based on hVCHx2+hVCH-hept+hHept-hept equaling 100%, is at least about 10% and up to about 80%, up to about 70%, up to about 60%, up to about 50%, up to about 40%, up to about 30%, or up to about 20%. All percentages and relative ratios are based on GC-MS as described in the experimental section.

In an embodiment of the disclosure, the hPAO product comprises butane-1,3-diyldicyclohexane (hVCHx2), hexan-2-ylcyclohexane (hVCH-but) and 3-methylheptane (hbut-but). In some embodiments, the mole percentage of hVCH-but based on the total moles of hVCHx2+hVCH-but+hbut-but equaling 100% is at least about 20%, at least about 30%, at least about 40%, at least about 50%, at least about 60%, at least about 70%, or at least about 80%. In some embodiments, the mole percentage of hVCHx2 produced, based on hVCHx2+hVCH-but+hbut-but equaling 100%, is 0%, more typically at least about 1%, and up to about 35%, up to about 30%, up to about 25%, up to about 20%, up to about 15%, up to about 10%, or up to about 5%. In some embodiments, the mole percentage of hbut-but produced, based on hVCHx2+hVCH-but+hbut-but equaling 100%, is at least about 10% and up to about 80%, up to about 70%, up to about 60%, up to about 50%, up to about 40%, up to about 30%, or up to about 20%. All percentages and relative ratios are based on GC-MS as described in the experimental section.

In an embodiment of the disclosure, the hPAO product comprises butane-1,3-diyldicyclohexane (hVCHx2), (6-methylheptan-2-yl)cyclohexane (hVCH-MePent) and 4-methylnonane (hMePent-MePent). In some embodiments, the mole percentage of hVCH-MePent based on the total moles of hVCHx2+hVCH-MePent+hMePent-MePent equaling 100% is at least about 20%, at least about 30%, at least about 40%, at least about 50%, at least about 60%, at least about 70%, or at least about 80%. In some embodiments, the mole percentage of hVCHx2 produced, based on hVCHx2+hVCH-MePent+hMePent-MePent equaling 100%, is 0%, more typically at least about 1%, and up to about 35%, up to about 30%, up to about 25%, up to about 20%, up to about 15%, up to about 10%, or up to about 5%. In some embodiments, the mole percentage of hMePent-MePent produced, based on hVCHx2+hVCH-MePent+hMePent-MePent equaling 100%, is at least about 10% and up to about 80%, up to about 70%, up to about 60%, up to about 50%, up to about 40%, up to about 30%, or up to about 20%. All percentages and relative ratios are based on GC-MS as described in the experimental section.

### Functionalization

Some of the unsaturated PAO product can be reacted with a chemical reagent to obtain an at least partly functionalized PAO product. However, due to the individual nature of functionalization reactions, the specificity of potential side products or by-products to be avoided, the breadth of potentially desired functionality, and thus the breadth of potential reaction conditions available or sufficient to attain desired functionality, it can be difficult to specify an appropriately set of conditions, reactors, chemical reagents, and/or catalysts/additives/etc. to encompass them all. Nevertheless, conventional functionalization techniques, as well as their reaction parameters, are known to those skilled in the chemical arts, allowing partially or completely functionalized PAO products with any one or more of a variety of functional groups to be readily attainable. In the case of substantially or completely functionalized PAO products, in some embodiments, the bromine number can be up to about 2.

### Lubricant Base Stock

The unsaturated PAO products and the hydrogenated PAO products described herein can be used as a base stock for lubricating oil compositions. In some embodiments, a hydrogenated PAO having a bromine number up to about 2, or no greater than 2.0, is used as a lubricating oil base stock. The base stock can be at any viscosity grade useful for any particular lubricating oil composition. The base stocks of the present disclosure can be blended with each other, other API Group I, II, III, IV, or V base stocks, lubricating additive packages, and/or the like, to form a lubricating oil composition. “Lubricating oil,” “lubricating oil composition,” and “lubricant” are used herein interchangeably. The lubricants can include internal combustion engine oils, gas turbine oils, automobile drive line fluids, power transfer fluids (e.g., hydraulic oil), processing oils, heat transfer oils (e.g., transformer oils), industrial lubricants, gear box lubricants, and the like, as well as combinations thereof.

In some embodiments, the process to produce PAO dimer further comprises reacting the PAO dimer with a reactant to form a functionalized PAO product followed by hydrogenation.

In some embodiments, the process to produce PAO dimer and/or trimer further comprises hydrogenating the product.

Some embodiments include a fuel comprising the hydrogenated PAO dimer and/or trimer.

Some embodiments include a driveline or electric vehicle fluid comprising a hydrogenated or functionalized derivative, or hydrogenated functionalized derivative of PAO dimer and/or trimer.

Some embodiments include an engine oil comprising a hydrogenated or functionalized derivative, or hydrogenated functionalized derivative of PAO dimer and/or trimer.

Some embodiments include a gear oil comprising a hydrogenated or functionalized derivative, or hydrogenated functionalized derivative of PAO dimer and/or trimer.

Some embodiments include a cooling fluid comprising a hydrogenated or functionalized derivative, or hydrogenated functionalized derivative of PAO dimer and/or trimer.

Some embodiments include a compressor oil comprising a hydrogenated or functionalized derivative, or hydrogenated functionalized derivative of PAO dimer and/or trimer.

Some embodiments include a hydraulic fluid comprising a hydrogenated or functionalized derivative, or hydrogenated functionalized derivative of PAO dimer and/or trimer.

### EXAMPLES

### Catalyst Complexes

Catalyst complexes A-E were prepared as described below. Complex F is commercially available. The terms “catalyst complex,” “complex,” “transition metal complex”, “transition metal compound”, “pre-catalyst,” and “catalyst” are used interchangeably in this document.

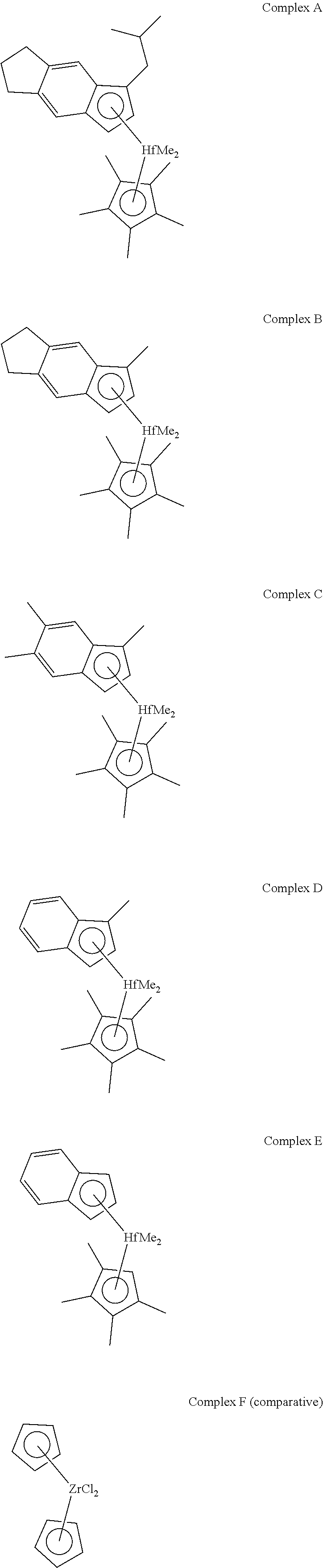

Complex A, (1-isobutyl-3,5,6,7-tetrahydro-s-indacenyl)(pentamethylcyclo-pentadienyl)hafnium dimethyl, and complex B, (1-methyl-3,5,6,7-tetrahydro-s-indacenyl) (pentamethylcyclopentadienyl)hafnium dimethyl, used in the oligomerization runs below can be synthesized according to PCT Pub. No. WO2021/030045, which is incorporated herein by reference for this synthetic method Complex D, (1-methylindenyl)(pentamethylcyclopentadienyl)hafnium dimethyl used below, can be synthesized according to PCT Pub. No. WO2019/157169, which is incorporated by reference herein for this synthetic method.

Catalyst synthesis reactions were conducted in inert and oxygen free conditions (under dinitrogen or similar) using anhydrous solvents and using commercially available reagents.

### Synthesis of Complex C, (1,5,6-trimethylindenyl)(pentamethylcyclopentadienyl)hafnium dimethyl

### Synthesis of (5,6-dimethyl-1H-inden-1-yl)lithium

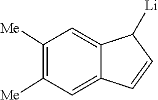

To a light yellow solution of 5,6-dimethylindene (8.94 g, 62.0 mmol, purchased from Boulder Scientific) in diethyl ether (300 mL) at −35° C., n-BuLi in hexanes (25.0 mL, 2.48 M, 62.0 mmol, 1.00 eq) was added. The original amber solution quickly turned cloudy manila with precipitate upon the addition. The reaction turned cloudy peach with white precipitate after stirring for 30 min. The reaction was concentrated in vacuo, leaving peach solid. The solid was washed with pentane (40 mL) and dried in vacuo as a peach powder. Yield: 9.06 g (97%).

¹H NMR (400 MHz, THF-d₈): δ 7.10 (s, 2H), 6.39 (t, J=3.3 Hz, 1H), 5.78 (d, J=3.3 Hz, 2H), 2.24 (s, 6H).

### Synthesis of 1,5,6-trimethyl-1H-indene

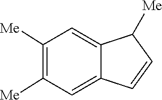 [SMILES: Cc1cc2c(cc1C)C(C)C=C2]

To a colorless solution of iodomethane (17.50 g, 0.123 mmol, 2.08 eq) in diethyl ether (100 mL), (5,6-dimethyl-1H-inden-1-yl)lithium (8.90 g, 59.3 mmol) was added, producing a cloudy, thick light manila mixture. The reaction warmed and turned cloudy light manila, and became less thick after stirring for 20 min. The reaction turned warm, clear amber after stirring for 45 min. After stirring at room temp for 3 hr, the reaction was clear. Dimethoxyethane (11.0 g, 122 mmol, 2.06 eq) was added to give a cloudy manila mixture with precipitate. The reaction was evaporated in vacuo, leaving damp manila solid. This solid was extracted with pentane (100 mL, then 3×20 mL) to give an amber filtrate and white solid. Filtrate was evaporated in vacuo, leaving an amber liquid. Yield: 8.90 g (95%).

¹H NMR (400 MHz, Benzene-d₆): δ 7.08 (d, J=7.6 Hz, 2H), 6.69 (ddd, J=5.5, 2.0, 0.7 Hz, 1H), 6.24 (dd, J=5.5, 2.0 Hz, 1H), 3.36-3.24 (m, 1H), 2.15 (d, J=8.3 Hz, 6H), 1.16 (d, J=7.6 Hz, 3H).

### Synthesis of (3,5,6-trimethyl-1H-inden-1-yl)lithium

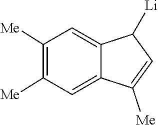

To an amber solution of 1,5,6-trimethyl-1H-indene (8.87 g, 56.1 mmol) in diethyl ether (120 mL) at −35° C., n-BuLi in hexanes (23.0 mL, 2.48 M, 57.0 mmol, 1.02 eq) was added to give a hazy amber solution that rapidly became thick with manila precipitate upon completion of the addition. The reaction mixture was stirred for 30 min, then evaporated in vacuo, leaving a manila solid. The solid was washed with pentane (2×40 mL) and dried in vacuo to give a light manila powder. Yield: 9.20 g (100%).

¹H NMR (400 MHz, THF-d₈): δ 7.04 (s, 2H), 6.20 (dd, J=3.1, 0.8 Hz, 1H), 5.59 (dd, J=3.1, 0.8 Hz, 1H), 2.38 (d, J=0.8 Hz, 3H), 2.25 (d, J=a 13.3 Hz, 6H).

### Synthesis of Hafnium tri(dimethylamido)iodide, Hf(NMe₂)₃I

Hafnium tetrakisdimethylamido (24.92 g, 70.2 mmol) in pentane (150 mL) was added slowly dropwise over 20 min to trimethylsilyliodide (10.00 mL, 1.41 g/mL, 70.3 mmol) to give a cloudy white mixture. After 1 hr, the reaction was white with much precipitate. The reaction was filtered, and the solids washed with pentane (2×40 mL) and dried in vacuo as a white powder. This produced 29.45 g (96%) of hafnium tri(dimethylamido)iodide as a white powder.

¹H NMR (400 MHz, Benzene-d₆): δ 2.82 (s, 13H), 2.59 (s, 6H).

### Synthesis of (pentamethylcyclopentyldienyl)hafnium tri(dimethylamido), (Me₅Cp)Hf(NMe₂)₃

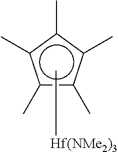

To a white suspension of Hf(NMe₂)₃I (20.00 g, 45.7 mmol) in diethyl ether (100 mL), sodium pentamethylcyclopentyldienide (7.21 g, 4.56 mmol, 0.99 eq) was added. The reaction became a cloudy white mixture with white precipitate after 1 hr. After 5 hr, the reaction was evaporated in vacuo, leaving a white solid. The solid was extracted with pentane (100 mL, then 4×10 mL) to give a colorless filtrate and white solids. The filtrate was evaporated in vacuo, to leave desired product as a white solid. Yield: 20.32 g (100%).

¹H NMR (400 MHz, Benzene-d₆): δ 2.97 (s, 15H), 2.00 (s, 12H).

### Synthesis of (pentamethylcyclopentyldienyl)hafnium trichloride dimethoxyethane Adduct, (Me₅Cp)HfCl₃(dme)

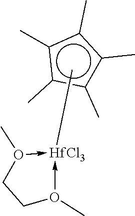

To a pale yellow solution (Me₅Cp)Hf(NMe₂)₃ (20.32 g, 45.6 mmol) in 1,2-dimethoxyethane (75 mL), trimethylsilylchloride (30.00 g, 276 mmol, 6.06 eq) was added. The reaction experienced a slight exotherm and turned nearly colorless upon the addition of trimethylsilylchloride. After a minute, the reaction had formed a white precipitate and became cloudy. After an hour, the reaction was cloudy and light manila in color after stirring. After 2.5 hr, the reaction was evaporated in vacuo, leaving manila solid. The solid was washed with pentane (30 mL) and dried in vacuo to give a yield of 22.86 g (98%) as a pale peach powder.

¹H NMR (400 MHz, Methylene Chloride-d₂): δ 3.81 (s, 4H), 3.56 (s, 6H), 2.23 (s, 15H).

### Synthesis of (pentamethylcyclopentadienyl)(1,5,6-trimethylindenyl)hafnium dichloride, (Me₅Cp)(1,5,6-MesInd)HfCl₂

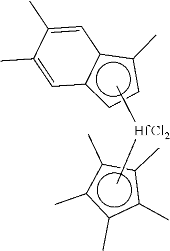

(Me₅Cp)HfCl₃(dme) (2.50 g, 4.90 mmol) was slurried into diethyl ether (35 mL). The slurry received Li[1,5,6-MesInd] (0.81 g, 4.93 mmol, 1.01 eq) to give a cloudy manila-yellow mixture, it was allowed to stir overnight. After 20 hrs, the reaction was evaporated in vacuo, leaving a light yellow solid. The solid was extracted with diethyl ether (2×30 mL) and filtered to give a yellow solution and white solid. The filtrate was evaporated sol in vacuo, leaving light yellow solid. The solid was washed with cold pentane (15 mL) and dried in vacuo to give a yield of 2.30 g (87%) as a light yellow powder.

¹H NMR (400 MHz, Methylene Chloride-d₂): δ 7.30 (s, 1H), 7.06 (s, 1H), 5.87 (dd, J=2.8, 0.7 Hz, 1H), 5.66 (dd, J=2.8, 0.8 Hz, 1H), 2.42-2.30 (m, 9H), 2.05 (s, 15H).

### Synthesis of (pentamethylcyclopentadienyl)(1,5,6-trimethylindenyl)hafnium dimethyl, (Me₅Cp)(1,5,6-Me₃Ind)HfMe₂

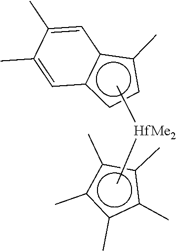

To a solution of (Me₅Cp)(1,5,6-MesInd)HfCl₂ (2.27 g, 4.19 mmol) in toluene (15 mL), potassium fluoride (1.95 g, 33.6 mmol, 8.01 eq) and trimethylaluminum (0.84 mL, 8.76 mmol, 2.10 eq) were added which produced to a cloudy yellow mixture. The reaction warmed slightly and became cloudy after stirring after 1 min. After one hour, the solution was cloudy yellow and was left to stir overnight. After 20 hr, the mixture was cloudy light yellow-white. The reaction was then evaporated in vacuo, leaving a light yellow solid. The solid was extracted with pentane (30 mL, then 4×5 mL), and the pale yellow filtrate was evaporated in vacuo, leaving light yellow solid. Yield: 2.07 g, (99%).

¹H NMR (400 MHz, Benzene-d₆): δ 7.45 (s, 1H), 6.99 (d, J=1.4 Hz, 1H), 5.22 (dd, J=2.8, 0.8 Hz, 1H), 5.10 (dd, J=2.9, 0.6 Hz, 1H), 2.28-2.13 (m, 9H), 1.76 (s, 16H), −1.58 (s, 3H).

### Synthesis of Complex E, (indenyl)(tetramethylcyclopentadienyl)hafnium dimethyl

### Synthesis of hafnium tri(dimethylamido)chloride, Hf(NMe₂)₃Cl

To a colorless solution of Hf(NMe₂)₄ (50.00 g, 141 mmol, 3.01 eq) in dichloromethane (250 mL), HfCl₄ (15.0 g, 46.8 mmol) was added providing a warm, slightly hazy colorless solution. After 1 hr, the reaction was filtered. The filtrate was evaporated in vacuo, leaving a white solid. The solid was dried overnight in vacuo and washed with pentane (2×40 mL) and re-dried in vacuo. Yield: 61.98 g (96%) as a white powder.

¹H NMR (400 MHz, Benzene-d₆): 2.82 (s, 18H)

### Synthesis of (tetramethylcyclopentadienyl)hafnium tri(dimethylamido), (Me₄Cp)Hf(NMe₂)₃

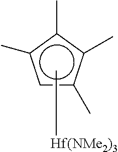

To a white suspension of Hf(NMe₂)₃Cl (15.00 g, 43.3 mmol, 1.02 eq) in diethyl ether (90 mL), sodium tetramethylcyclopentadienide (6.15 g, 42.7 mmol) was added providing a cloudy white mixture. The reaction mixture was left to stir for 3.5 hr as a cloudy pale yellow-white mixture. It was then evaporated in vacuo, leaving white solids. The solids were extracted with pentane (100 mL, then 3×5 mL) and filtered to give a very pale yellow filtrate and white solid. The filtrate was concentrated in vacuo to give desired product as a light manila solid. Yield: 17.59 g (95%).

¹H NMR (400 MHz, Benzene-d₆): δ 6.87 (s, 1H), 2.69 (s, 18H), 1.78 (s, 6H), 1.64 (s, 6H).

### Synthesis of (tetramethylcyclopentyldienyl)hafnium trichloride dimethoxyethane Adduct, (Me₄Cp)HfCl₃(dme)

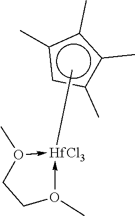

To a pale yellow solution of (Me₄Cp)Hf(NMe₂)₃ (17.55 g, 40.6 mmol) in 1,2-dimethoxyethane (50 mL), trimethylsilyl chloride (27.00 g, 249 mmol, 6.12 eq) was added. The reaction experienced a slight warming and lightened in color upon addition completion. After 3.5 hr, the reaction was a cloudy amber-white mixture. It was then evaporated in vacuo, leaving a manila solid. The solid was washed with pentane (2×20 mL) and dried in vacuo to give light manila powder. Yield: 19.88 g (99%)

¹H NMR (400 MHz, Methylene Chloride-d₂): δ 5.62 (s, 1H), 4.04 (s, 4H), 3.80 (s, 6H), 2.28 (s, 6H), 2.17 (s, 6H).

### Synthesis of (indenyl)(tetramethylcyclopentadienyl)hafnium dichloride, (Ind)(Me₄Cp)HfCl₂

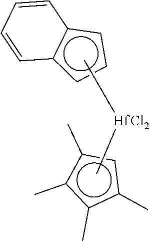

A pale peach suspension of (Me₄Cp)HfCl₃(dme) (2.50 g, 5.02 mmol) in diethyl ether (50 mL) was added to lithium indenide (0.62 g, 5.08 mmol, 1.01 eq) to give a cloudy manila-yellow mixture. The reaction was allowed to stir for 18 hr, and was cloudy light yellow with precipitate. The reaction was evaporated in vacuo to give a light yellow solid. The solid was extracted with dichloromethane (30 mL, then 3×5 mL) and filtered to give a light yellow filtrate and gray solid. The filtrate was evaporated in vacuo, leaving light yellow solid. The solid was washed with pentane (20 mL) and dried in vacuo to give a light yellow powder. Yield: 2.32 g (95%).

¹H NMR (400 MHz, Methylene Chloride-d₂): δ 7.58 (dd, J=6.5, 3.1 Hz, 2H), 7.23 (dd, J=6.6, 3.1 Hz, 2H), 6.65 (t, J=3.3 Hz, 1H), 6.23 (d, J=3.0 Hz, 2H), 5.73 (s, 1H), 2.03 (s, 7H), 1.97 (s, 7H).

### Synthesis of (indenyl)(tetramethylcyclopentadienyl)hafnium dimethyl, (Ind)(Me-Cp)HfMe₂

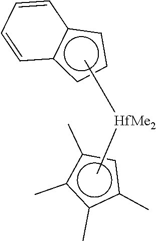

To a cloudy yellow suspension of (Ind)(Me₄Cp)HfCl₂ (2.30 g, 4.73 mmol) in toluene (25 mL), potassium fluoride (2.20 g, 3.79 mmol, 8.00 eq) and trimethylaluminum (0.94 mL, 0.752 g/mL, 9.81 mmol, 2.07 eq) were added proving a cloudy yellow mixture. The reaction was hazy yellow and slightly warm and was allowed to stir overnight. After 18 hr, the reaction mixture was cloudy pale yellow-white. The reaction was evaporated in vacuo, leaving pale yellow-white solid. The solid was extracted with pentane (50 mL, then 3×5 mL) and filtered to give a very pale yellow filtrate and gray solid. The filtrate was evaporated in vacuo, leaving a pale yellow solid. Yield: 2.10 g (100%).

¹H NMR (400 MHz, Benzene-d₆): δ 7.38 (dd, J=6.5, 3.2 Hz, 2H), 7.04 (dd, J=6.5, 3.2 Hz, 2H), 5.84 (d, J=3.2 Hz, 2H), 5.66 (t, J=3.2 Hz, 1H), 4.83 (s, 1H), 1.76 (s, 6H), 1.70 (s, 6H), −0.91 (s, 6H).

### Activator

For catalyst activation, N,N-di(hydrogenated tallow alkyl)methylammonium tetrakis(pentafluorophenyl)borate (M2HTH-D4) can be purchased from Boulder Chemical Company as 10 wt % solution in methylcyclohexane.

### Scavenger

For a scavenger, tri-n-octyl aluminum (neat) can be purchased from Azko Nobel Part #K52296 or similar.

### Monomers

Unless described differently, monomers were sparged with dry nitrogen to remove air, and set over mole sieves (3 Å) to remove moisture prior to use. The monomers were sourced as indicated:
1-butene—Airgas Product #B1 CPLP5, chemically pure grade or similar;
1-pentene—GFS Item #3396, 98% purity or higher;
4-methyl-1-pentene—Sigma Aldrich Part #M67400 or similar;
1-hexene—sourced from Pilot Plant-Chevron Phillips AlphaPlus® 1-hexene or similar;
1-heptene—TCI America Product #H0042-98% or greater by GC;
1-octene—sourced from Pilot Plant-Chevron Phillips AlphaPlus® 1-octene or similar;
1-nonene—TCI America Product #N0613-95% or greater by GC;
1-decene—sourced from Pilot Plant-Chevron Philips AlphaPlus® 1-decene or similar;
4-vinylcyclohex-1-ene—Gelest Product Code ENEV4520-97% pure, with 100-200 ppm BHT (2,6-di-tert-butyl-4-methylphenol) stabilizer, purified by passing through basic alumina, sparged with nitrogen and treated with desiccant (3 Å mol sieves with optional Q5); 4-vinylcyclohexane was purchased from TCI chemicals and purified by sparging with nitrogen and stored above activated molecular sieves (4 Å) and AZ300; and vinyl cyclobutane can be prepared as described in Journal of the American Chemical Society (2011), 133 (23), 8858-8861, and U.S. provisional application No. 63/307,738, filed Feb. 8, 2022, and US Pat. Pub. No. 2023/0250200.

### Additional Reagents

Additional reagents were obtained as described below.
Aluminum Oxide, Basic, Brockmann I—Sigma Aldrich Part #199443 or similar;
Aluminum Oxide, Acidic, Brockmann I—Sigma Aldrich Part #199966 or similar;
Silica Gel—Sigma Aldrich Part #288624 high-purity grade, pore size 60 Å, 70-230 mesh or similar;
Molecular Sieves 3 Å—Sigma Aldrich Part #208582 beads, 8-12 mesh, or similar;
Q-5 Reactant BASF CU-0226 S—From BASF Product Identifier: CU 0226 S 8×14MESH or similar;
AZ300—UOP; and
Celite®—545-Sigma Aldrich #419931.

### Solvents

Unless described differently, solvents were sparged with dry nitrogen to remove air, and set over mole sieves (3 Å) to remove moisture prior to use.
Methylcyclohexane (abbreviated as MCH)—Sigma Aldrich #300306-2L; and
Toluene—Sigma Aldrich #244511-1L

### Oligomerization Runs

Batch oligomerization reactions for examples 1-16 were conducted in a 1 or 2 L stainless steel autoclave reactor equipped with a paddle stirrer, an external water/steam jacket for temperature control, a regulated supply of dry nitrogen, and an inlet for the introduction of other solvents, monomers, pre-catalysts, scavengers and activators. The reactor body was dried by heating the reactor at 110-120° C. under a flow of dry nitrogen for approximately 1 hour prior to use. Typically, 500-1000 mL of monomer was measured by sight glass either as a pre-mixed mixture of two monomers, or as a single monomer addition.

The following abbreviations are used for olefin monomers:
VCH: 4-vinylcyclohex-1-ene, also called 4-vinylcyclohexene, 4-vinyl-1-cyclohexene, and vinylcyclohexene
VCB: vinylcyclobutane
C4: 1-butene, also called butene
C5: 1-pentene, also called pentene
C6: 1-hexene, also called hexene
iC6: 4-methylpent-1-ene, also called 4-methylpentene, 4-methyl-1-pentene, and isohexene
C7: 1-heptene, also called heptene
C8: 1-octene, also called octene
C9: 1-nonene, also called nonene
C10: 1-decene, also called decene

### Oligomerization Examples 1-10

For catalyst addition in Examples 1-10, a double cylinder (also called a double addition tube) consisted of two 25 mL SS Swagelok cylinders with three SS Swagelok ball valves (one valve in the middle and one on each end) was typically used. All catalyst, activator and scavengers were handled in a nitrogen purged drybox. All catalyst and activator solutions were prepared separately, and were loaded into different ends of the double cylinder while in the nitrogen purged drybox. After removal from the drybox, the double addition tube was attached to the reactor such that the activator/scavenger solution entered into the reactor ahead of the catalyst solution.

### Oligomerization Example 1: Typical Co-Oligomerization of C6 and VCH Using Catalyst A

For this example, 1-hexene and 4-vinyl-1-cyclohexene were used. Catalyst A (150-240 mg) was dissolved in 10 mL of methylcyclohexane (MCH) and was added to the rear section of a double addition tube. In the front section, M2HTH-D4 (3.0-4.0 mL of a 10 wt % in MCH) was combined with neat tri-n-octyl aluminum (scavenger, 0.3-0.5 mL) and an additional 5-10 mL of MCH. Dry dinitrogen was used to push the 1000 mL of mixed monomers (˜50:50 by volume) into the reactor; then the double addition tube was attached to the reactor, and to the nitrogen source. Stirring was started (˜500 rpm) and the reactor was then heated to 90° C. Once the temperatures of the monomers and reactor had reached 90° C., dry dinitrogen at ˜80 psi was used to inject the catalyst, scavenger and activator solutions, and then the reactor was heated to 110° C. Timing started at the addition of catalyst to the reactor and was allowed to proceed for 30 to 90 min. After this time period, heating and stirring were ceased. Once cooled to ambient temperature, elevated pressure in the reactor was reduced and the reactor was opened. The contents were then filtered through ˜200 mL of a 1:1 ratio by volume of silica and alumina to give a clear liquid with an approximate volume of 1000 mL.

### Oligomerization Example 2: Typical Co-Oligomerization of C7 and VCH Using Catalyst A

For this example, 1-heptene and 4-vinyl-1-cyclohexene were used. Catalyst A (130-200 mg) was dissolved in 10 mL of MCH and was added to the rear section of a double addition tube. In the front section, M2HTH-D4 (3.6-4.0 mL of a 10 wt % in MCH) was combined with neat tri-n-octyl aluminum (0.3-0.4 mL) and an additional 7 mL of MCH. Dry dinitrogen at 80 psi was used to push the 1000 mL of monomer mixture (˜50:50 by volume) into the reactor; then the double addition tube was attached to the reactor, and to a nitrogen source. Stirring was started (˜500 rpm), and the reactor was then heated to 90° C. Once the temperatures of the monomers and reactor had reached 90° C., dry dinitrogen at ˜80 psi was used to inject the catalyst, scavenger and activator solutions into the reactor which was then heated to 110° C. Timing started at the addition of catalyst to the reactor and was allowed to proceed for 30 to 90 min. After this time period, heating and stirring were ceased. Once cooled to ambient temperature, elevated pressure in the reactor was reduced and the reactor was opened. The contents were then filtered through ˜200 mL of a 1:1 ratio by volume of silica and alumina to give a clear liquid with an approximate volume of 1000 mL.

### Oligomerization Example 3: Typical Co-Oligomerization of C5 and VCH Using Catalyst A

For this example, 1-pentene and 4-vinylcyclohex-1-ene were used. Catalyst A (130-200 mg) was dissolved in 10 mL of MCH and was added to the rear section of a double addition tube. In the front section, M2HTH-D4 (3.6-4.0 mL of a 10 wt % in MCH) was combined with neat tri-n-octyl aluminum (0.3-0.4 mL) and an additional 7 mL of MCH. Dry dinitrogen at 80 psi was used to push the 1000 mL of monomer mixture (˜50:50 by volume) into the reactor; then the double addition tube was attached to the reactor, and to a nitrogen source. Stirring was started (˜500 rpm) and the reactor was then heated to 90° C. Once the temperatures of the monomers and reactor had reached 90° C., dry dinitrogen at ˜80 psi was used to inject the catalyst, scavenger and activator solutions and then heated to 110° C. Timing started at the addition of catalyst to the reactor and was allowed to proceed for 30 to 90 min. After this time period, heating and stirring were ceased. Once cooled to ambient temperature, elevated pressure in the reactor was reduced and the reactor was opened. The contents were then filtered through ˜200 mL of a 1:1 ratio by volume of silica and alumina to give a clear liquid with an approximate volume of 1000 mL.

### Oligomerization Example 4: Typical Oligomerization of iC6 Using Catalyst D

For this example, 4-methylpent-1-ene was used. Catalyst D (22 mg) was dissolved in 9 mL of MCH and was added to the rear section of a double addition tube. In the front section, M2HTH-D4 (0.8 mL of a 10 wt % in MCH), tri-n-octyl aluminum (100 μL) and MCH (8 mL) were combined and added. High pressure dry dinitrogen was used to add 1 L of 4-methylpent-1-ene to the reactor; then the double addition tube was attached to the reactor, and to a nitrogen source. The stirrer was then turned on to 900-1000 rpm. The heat was set to reach 110° C. After the reactor contents reached between 100-110° C., the high pressure dry nitrogen was used to push in the catalyst and activator solutions. Timing started at the addition of the catalyst to the reactor and was allowed to proceed for 1 hour. After this time period, heating and stirring were ceased, pressure was vented from the reactor and the reactor was opened. After combining product from several runs of this type, the products were filtered through Celite® to remove the catalyst residues.

### Oligomerization Example 5: Typical Co-Oligomerization of C5 and C4 Using Catalyst A

For this example, 1-pentene and 1-butene were used. Catalyst A (26 mg) was dissolved in 9 mL of MCH and was added to the rear section of a double addition tube. In the front section, M2HTH-D4 (0.8 mL of a 10 wt % in MCH), tri-n-octyl aluminum (100 μL) and MCH (8 mL) were combined and added. High pressure nitrogen was used to add 300 mL of 1-pentene to the reactor, followed by 250 mL of 1-butene; then the double addition tube was attached to the reactor, and to a nitrogen source. The stirrer was then turned on to 900-1000 rpm. The heat was turned on to reach 110° C. After the reactor reached between 100-110° C., the high pressure dry dinitrogen was used to push in the catalyst and activator solutions. Timing started at the addition of the catalyst to the reactor and was allowed to proceed for 1 hour. After this time period, heating and stirring were ceased, pressure was vented from the reactor and the reactor was opened and lowered exposing the contents to air. The contents were poured in to a pre-weighed container and the weight of product was recorded. After combining product from several runs of this type, the products were filtered through Celite® to remove the catalyst residues.

### Oligomerization Example 6: Typical Co-Oligomerization of VCH and C4 Using Catalyst A

For this example, 4-vinylcyclohex-1-ene and 1-butene were used. Catalyst A (52 mg) was dissolved in 9 mL of MCH and was added to the rear section of a double addition tube. In the front section, M2HTH-D4 (1.60 mL of a 10 wt % in MCH), tri-n-octyl aluminum (200 μL) and MCH (7 mL) were combined and added. High pressure dry dinitrogen was used to add 600 mL of VCH to the reactor, followed by 200 mL of 1-butene (passed through driers as previously described); then the double addition tube was attached to the reactor, and to a nitrogen source. The stirrer was then turned on to 900-1000 rpm. The heat was turned on to reach 110° C. After the reactor reached between 100-110° C., the high pressure dry nitrogen was used to push in the catalyst and activator solutions. Timing started at the addition of the catalyst to the reactor and was allowed to proceed for 1 hour. After this time period, heating and stirring were ceased, pressure was vented from the reactor and the reactor was opened and lowered exposing the contents to air. The contents were poured in to a pre-weighed container and the weight of product was recorded. After combining product from several runs of this type, the products were filtered through Celite® to remove the catalyst residues.

### Oligomerization Example 7: Typical Co-Oligomerization of VCH and iC6 Using Catalyst A

For this example, 4-vinylcyclohex-1-ene and 4-methylpent-1-ene were used. Catalyst A (22 mg) was dissolved in 9 mL of MCH and was added to the rear section of a double addition tube. In the front section, M2HTH-D4 (1.60 mL of a 10 wt % in MCH), tri-n-octyl aluminum (200 μL) and MCH (7 mL) were combined and added. High pressure nitrogen was used to add 500 mL of VCH to the reactor, followed by 500 mL of 4-methylpent-1-ene; then the double addition tube was attached to the reactor, and to a nitrogen source. The stirrer was then turned on to 900-1000 rpm. The heat was turned on to reach 110° C. After the reactor reached between 100-110° C., the high pressure dry dinitrogen was used to push in the catalyst and activator solutions. Timing started at the addition of the catalyst to the reactor and was allowed to proceed for 1 hour. After this time period, heating and stirring were ceased. Elevated pressure was vented from the reactor and the reactor was opened. The contents were poured into a pre-weighed container and the weight of product was recorded. After the addition of several runs, the products were filtered through Celite® to remove the catalyst residues.

### Oligomerization Example 8: Typical Oligomerization of C5 Using Catalyst A

For this example, 1-pentene was used. Catalyst A (26 mg) was dissolved in 9 mL of MCH and was added to the rear section of a double addition tube. In the front section, M2HTH-D4 (0.8 mL of a 10 wt % in MCH) was combined with neat tri-n-octyl aluminum (100 μL) and an additional 8 mL of MCH. High pressure dry dinitrogen was used to add 500 mL of 1-pentene to the reactor; then the double addition tube was attached to the reactor, and to a nitrogen source. The stirrer was then turned on to 900-1000 rpm and temperature set to 110° C. After the reactor reached between 100-110° C., the high pressure dry dinitrogen was used to push in the catalyst and activator solutions. Timing started at the addition of the catalyst to the reactor and was allowed to proceed for 1 hour. After this time period, heating and stirring were ceased, pressure was vented from the reactor and the reactor was opened. After combining product from several runs of this type, the products were filtered through Celite® to remove the catalyst residues.

### Oligomerization Example 9: Typical Oligomerization of C4 Using Catalyst A

For this example, 1-butene was used. Catalyst A (26 mg) was dissolved in 9 mL of MCH and was added to the rear section of a double addition tube. In the front section, M2HTH-D4 (0.8 mL of a 10 wt % in MCH) was combined with neat tri-n-octyl aluminum (200 μL) and an additional 7 mL of MCH. The 1-butene cylinder was attached to the reactor via a drier containing a mixture of desiccants including Q5 and 3 Å molecular sieves. High pressure dry dinitrogen was used to charge 1 L of 1-butene from the cylinder into the reactor; then the double addition tube was attached to the reactor, and to a nitrogen source. After 1 L was added, the stirrer was turned on to 900-1000 rpm. The heat was turned on to reach 110° C. After the reactor reached temperature (between 100° C.-110° C.), the high pressure nitrogen was used to push in the catalyst and activator solutions. Timing started at the addition of the catalyst to the reactor and was allowed to proceed for 1 hour. After this time period, heating and stirring were ceased, excess pressure was vented from the reactor and the reactor was opened. The contents were poured into a pre-weighed container and the weight of the product was recorded. After combining product from several runs of this type, the products were filtered through Celite® to remove the catalyst residues.

### Oligomerization Example 10: Typical Oligomerization of C4 Using Catalyst C

For this example, 1-butene was used. Catalyst C (52 mg) was dissolved in 9 mL of MCH and was added to the rear section of a double addition tube. In the front section, M2HTH-D4 (1.6 mL of a 10 wt % in MCH) was combined with neat tri-n-octyl aluminum (200 μL) and an additional 7 mL of MCH. The 1-butene cylinder was attached to the reactor via a drier containing a mixture of desiccants including Q5 and 3 Å molecular sieves. High pressure dry dinitrogen was used to charge 1 L of 1-butene from the cylinder into the reactor; then the double addition tube was attached to the reactor, and to a nitrogen source. After 1 L was added, the stirrer was turned on to 900-1000 rpm. The heat was turned on to reach 90° C. After the reactor contents reached between 80-90° C., the high pressure dry dinitrogen was used to push in the catalyst and activator solutions into the reactor. Timing started at the addition of the catalyst to the reactor and was allowed to proceed for 1 hour. After this time period, heating and stirring were ceased. The elevated pressure was vented from the reactor and the reactor was opened. The contents were poured into a pre-weighed container and the weight of the product was recorded. After combining product from several runs of this type, the products were filtered through Celite® to remove the catalyst residues.

### Oligomerization Examples 11-15

For catalyst addition in Examples 11-15, a double cylinder (also called a double addition tube) consisted of two 25 mL SS Swagelok cylinders with three SS Swagelok ball valves (one valve in the middle and one on each end) was typically used. All catalyst, activator, and scavengers were handled in a nitrogen purged drybox. For these examples, the catalyst and activator were premixed as a MCH solution, and added to the front section of the addition tube. The rear section of the double addition tube typically contained 10 mL MCH to help flush the catalyst into the reactor. The addition tube orientation when attached to the reactor was such that upon injection, the catalyst solution would first be injected into the reactor followed by the solvent chaser. Scavenger solution was also prepared in the drybox and was placed in a septum sealed vial for cannula delivery of the solution into the reactor.

### Oligomerization Example 11: Typical Oligomerization of C6 Using Catalyst A

For this example, 1-hexene used. Catalyst A (240 mg) was dissolved in 10 mL of MCH in a 20 mL glass vial. M2HTH-D4 (7.4 mL of a 10 wt % in MCH) was added to this vial. The activated catalyst solution was then transferred to one side of the double addition tube. To the other side of the double addition tube, 10 mL of MCH was added. The scavenger solution was prepared by adding tri-n-octyl aluminum (175 μL) to 15 mL of 1-hexene in a 60 mL vial which was then sealed with a septum.

In a 2 L reactor, 1500 mL of dried 1-hexene was pushed into the reactor with high pressure nitrogen. The reactor was vented. The scavenger solution was cannulated into the reactor using low pressure nitrogen (2-5 psi). The double addition tube was then connected to the reactor and to a high pressure nitrogen line. The stirrer was turned on to 400 rpm. The heat was turned on to reach 120° C. After the reactor reached 110° C., high pressure dry nitrogen was used to push in the catalyst solution and solvent chaser into the reactor. Timing started upon the injection of the catalyst and was allowed to proceed for 1 hour. After this time period, heating and stirring was stopped and the reactor was allowed to cool to about 60° C. The reactor was vented then opened. The contents were poured into a tared container, and the weight was recorded (e.g., ˜1200 g typical). The product was then suction filtered through Celite® to remove catalyst residue.

### Oligomerization Example 12: Typical Oligomerization of C8 Using Catalyst A

For this example, 1-octene used. Catalyst A (240 mg) was dissolved in 10 mL of MCH in a 20 mL glass vial. M2HTH-D4 (7.4 mL of a 10 wt % in MCH) was added to this vial. The activated catalyst solution was then transferred to one side of the double addition tube. To the other side of the double addition tube, 10 mL of MCH was added. The scavenger solution was prepared by adding tri-n-octyl aluminum (120 μL) to 15 mL of 1-octene in a 60 mL vial which was then sealed with a septum. Additionally, while in the drybox, 1400 mL of 1-octene was transferred to a 2 L bottle, and sealed with a septum.

To a 2 L reactor, the 1-octene was transferred into the reactor by cannula using low pressure nitrogen (2-5 psi). Next, the scavenger solution was cannulated into the reactor using low pressure nitrogen (2-5 psi). The double addition tube was then connected to the reactor and to a high pressure nitrogen line. The stirrer was turned on to 400 rpm. The heat was turned on to reach 120° C. After the reactor reached 110° C., high pressure dry nitrogen was used to push in the catalyst solution and solvent chaser into the reactor. Timing started upon the injection of the catalyst and was allowed to proceed for 1 hour. After this time period, heating and stirring was stopped and the reactor was allowed to cool to about 60° C. The reactor was vented then opened. The contents were poured into a tared container, and the weight was recorded (e.g., ˜900 g typical). The product was then suction filtered through Celite® to remove catalyst residue.

### Oligomerization Example 13: Typical Co-Oligomerization of C6 (25%) and C8 (75%) Using Catalyst A

For this example, 1-hexene and 1-octene were used. Catalyst A (240 mg) was dissolved in 10 mL of MCH in a 20 mL glass vial. M2HTH-D4 (7.4 mL of a 10 wt % in MCH) was added to this vial. The activated catalyst solution was then transferred to one side of the double addition tube. To the other side of the double addition tube, 10 mL of MCH was added. The 1-octene (1000 mL) and tri-n-octyl aluminum (120 μL) were added to a 2 L glass bottle, and sealed with a septum. The 1-hexene (333 mL) was added to a 1 L glass bottle, and sealed with a septum.

To a 2 L reactor, the 1-octene/tri-n-octyl aluminum was transferred into the reactor by cannula using low pressure nitrogen (2-5 psi). Next, the 1-hexene was cannulated into the reactor using low pressure nitrogen (2-5 psi). The double addition tube was then connected to the reactor and to a high pressure nitrogen line. The stirrer was turned on to 400 rpm. The heat was turned on to reach 120° C. After the reactor reached 110° C., high pressure dry nitrogen was used to push in the catalyst solution and solvent chaser into the reactor. Timing started upon the injection of the catalyst and was allowed to proceed for 1 hour. After this time period, heating and stirring was stopped and the reactor was allowed to cool to about 60° C. The reactor was vented then opened. The contents were poured into a tared container, and the weight was recorded (e.g., ˜900 g typical). The product was then suction filtered through Celite® to remove catalyst residue.

### Oligomerization Example 14: Typical Co-Oligomerization of C6 (50%) and C8 (50%) Using Catalyst A

For this example, 1-hexene and 1-octene were used. Catalyst A (240 mg) was dissolved in 10 mL of MCH in a 20 mL glass vial. M2HTH-D4 (7.4 mL of a 10 wt % in MCH) was added to this vial. The activated catalyst solution was then transferred to one side of the double addition tube. To the other side of the double addition tube, 10 mL of MCH was added. The 1-octene (600 mL) and tri-n-octyl aluminum (120 μL) were added to a 2 L glass bottle, and sealed with a septum. The 1-hexene (600 mL) was added to a 1 L glass bottle, and sealed with a septum.

To a 2 L reactor, the 1-octene/tri-n-octyl aluminum was transferred into the reactor by cannula using low pressure nitrogen (2-5 psi). Next, the 1-hexene was cannulated into the reactor using low pressure nitrogen (2-5 psi). The double addition tube was then connected to the reactor and to a high pressure nitrogen line. The stirrer was turned on to 400 rpm. The heat was turned on to reach 120° C. After the reactor reached 110° C., high pressure dry nitrogen was used to push in the catalyst solution and solvent chaser into the reactor. Timing started upon the injection of the catalyst and was allowed to proceed for 1 hour. After this time period, heating and stirring was stopped and the reactor was allowed to cool to about 60° C. The reactor was vented then opened. The contents were poured into a tared container, and the weight was recorded (e.g., ˜820 g typical). The product was then suction filtered through Celite® to remove catalyst residue.

### Oligomerization Example 15: Typical Co-Oligomerization of C6 (75%) and C8 (25%) Using Catalyst A

For this example, 1-hexene and 1-octene were used. Catalyst A (240 mg) was dissolved in 10 mL of MCH in a 20 mL glass vial. M2HTH-D4 (7.4 mL of a 10 wt % in MCH) was added to this vial. The activated catalyst solution was then transferred to one side of the double addition tube. To the other side of the double addition tube, 10 mL of MCH was added. The 1-hexene (1000 mL) and tri-n-octyl aluminum (120 μL) were added to a 2 L glass bottle, and sealed with a septum. The 1-octene (333 mL) was added to a 1 L glass bottle, and sealed with a septum.

To a 2 L reactor, the 1-hexene/tri-n-octyl aluminum was transferred into the reactor by cannula using low pressure nitrogen (2-5 psi). Next, the 1-octene was cannulated into the reactor using low pressure nitrogen (2-5 psi). The double addition tube was then connected to the reactor and to a high pressure nitrogen line. The stirrer was turned on to 400 rpm. The heat was turned on to reach 120° C. After the reactor reached 110° C., high pressure dry nitrogen was used to push in the catalyst solution and solvent chaser into the reactor. Timing started upon the injection of the catalyst and was allowed to proceed for 1 hour. After this time period, heating and stirring was stopped and the reactor was allowed to cool to about 60° C. The reactor was vented then opened. The contents were poured into a tared container, and the weight was recorded (e.g., ˜920 g typical). The product was then suction filtered through Celite® to remove catalyst residue.

### Oligomerization Examples 16-20

For Examples 16-20, batch oligomerization reactions were conducted in a N2-purged glovebox in a 2 L Ace Glass jacketed reactor equipped with a paddle stirrer, an internal thermocouple, and inlets for the introduction of monomers, pre-catalysts, and activators. Before use, the reactor was cleaned with anhydrous toluene and dried by heating at 120° C. under a flow of dry nitrogen for 1 hr. Monomers and solvents were purified by passing through an activated basic alumina column (50 galumina/Lmonomer), degassed by sparging with nitrogen for 1 hr (1 LN2/min), and dried over activated molecular sieves (3 Å) and AZ300 for at least 12 hrs.

### Oligomerization Example 16: Typical Co-Oligomerization of C8 and VCH Using Catalyst A

For this example, 1-octene and 4-vinylcyclohexene were used. VCH (600 mL, 498 g, 4.61 mol) and 1-octene (600 mL, 429 g, 3.82 mol) were added to the reactor, and the resulting mixture was heated to an internal temperature of 110° C. while stirring at 400 rpm. Tri-n-octyl aluminum (0.24 mL, 0.197 g, 0.5 mmol) was then added as a scavenger. Separately, in a 20 mL scintillation vial, catalyst A (240 mg, 0.432 mmol) was dissolved in MCH (3.3 mL), and then activated by adding a solution of M2HTH-D4 (10 wt % in MCH, 6.7 mL, 0.436 mmol). After stirring the resulting mixture for 1 min, the solution was added into the reactor in 0.5 mL or 1 mL increments. The exothermic reaction caused a rapid increase in temperature, so each addition was delayed by 5-30 min until the reaction temperature decreased below 125° C. To facilitate heterodimer formation, an additional portion of 1-octene (400 mL, 280 g, 2.55 mol) was added to the reactor in 50 mL increments after each injection of catalyst. Over the course of 1.5 hr, all catalyst and 1-octene were added, and the reaction mixture was agitated for an additional 1 hr. The content of the reactor was collected, and subsequently filtered through a column of activated basic alumina, yielding approximately 1.6 L of a colorless liquid.

### Oligomerization Example 17: Typical Co-Oligomerization of C9 and VCH Using Catalyst A

For this example, 1-nonene and 4-vinylcyclohexene were used. VCH (500 mL, 415 g. 3.84 mol) and 1-nonene (50 mL, 37.17 g, 0.294 mol) were added to the reactor, and the resulting mixture was heated to an internal temperature of 120° C. while stirring at 400 rpm. Tri-n-octyl aluminum (0.12 mL, 0.99 g, 0.25 mmol) was then added as a scavenger. Separately, in a 20 mL scintillation vial, catalyst A (120 mg, 0.216 mmol) was dissolved in MCH (5.0 mL), and then activated by adding a solution of M2HTH-D4 (10 wt % in MCH, 3.4 mL, 0.218 mmol). After stirring the resulting mixture for 1 min, the solution was added into the reactor in 0.5 mL or 1 mL increments. The exothermic reaction caused a rapid increase in temperature, so each catalyst addition was delayed by 5-30 min until the reaction temperature decreased below 125° C. To facilitate heterodimer formation, an additional portion of 1-nonene (750 mL, 557 g. 4.41 mol) was added to the reactor in two 200 mL increments and one 150 mL increment after each injection of catalyst. Over the course of 1.5 hrs, all catalyst and 1-nonene were added, and the reaction mixture was agitated for an additional 1 hr. The content of the reactor was collected, and subsequently filtered through a column of activated basic alumina, yielding approximately 1.3 L of a colorless liquid.

### Oligomerization Example 18: Typical Co-Oligomerization of C10 and VCH Using Catalyst A

For this example, 1-decene and 4-vinylcyclohexene. VCH (500 mL, 415 g, 3.84 mol) and 1-decene (100 mL, 74 g, 0.53 mol) were added to the reactor, and the resulting mixture was heated to an internal temperature of 120° C. while stirring at 400 rpm. Tri-n-octyl aluminum (0.24 mL, 0.197 g, 0.5 mmol) was then added as a scavenger. Separately, in a 20 mL scintillation vial, catalyst A (240 mg, 0.432 mmol) was dissolved in MCH (3.3 mL), and then activated by adding a solution of M2HTH-D4 (10 wt % in MCH, 6.7 mL, 0.436 mmol). After stirring the resulting mixture for 1 min, the solution was added into the reactor in 0.5 mL or 1 mL increments. The exothermic reaction caused a rapid increase in temperature, so each catalyst addition was delayed by 5-30 min until the reaction temperature decreased below 125° C. To facilitate heterodimer formation, an additional portion of 1-decene (800 mL, 592 g, 4.22 mol) was added to the reactor in 200 mL increments after each injection of catalyst. Over the course of 1.5 hrs, all catalyst and 1-decene were added, and the reaction mixture was agitated for an additional 1 hr. The content of the reactor was collected, and subsequently filtered through a column of activated basic alumina, yielding approximately 1.4 L of a colorless liquid.

### Oligomerization Example 19: Typical Oligomerization of VCH Using Catalyst E

For this example, 4-vinylcyclohexene was used. VCH (1500 mL, 1245 g, 11.52 mol) was added to the reactor, and the resulting mixture was heated to an internal temperature of 120° C. while stirring at 400 rpm. Tri-n-octyl aluminum (1.05 mL, 0.861 g, 2.30 mmol) was then added as a scavenger. Separately, in a 20 mL scintillation vial, catalyst E (310 mg, 0.697 mmol) was dissolved in toluene (10 mL), and then activated by adding a solution of M2HTH-D4 (10 wt % in MCH, 11.25 mL, 0.729 mmol). After stirring the resulting mixture for 30 min, the solution was added into the reactor in 1.5 mL or 3 mL increments. The exothermic reaction caused a rapid increase in temperature, so each catalyst addition was delayed by 5-30 min until the reaction temperature decreased below 125° C. Over the course of 1.5 hrs, all catalyst was added, and the reaction mixture was agitated for an additional 0.8 hr. The content of the reactor was collected, and subsequently filtered through a column of activated basic alumina, yielding approximately 1.5 L of a colorless liquid.

### Oligomerization Example 20: Typical Oligomerization of VCH Using Catalyst A

For this example, 4-vinylcyclohexene was used. VCH (1000 mL, 830 g, 7.685 mol) was added to the reactor, and the resulting mixture was heated to an internal temperature of 110° C. while stirring at 400 rpm. Tri-n-octyl aluminum (1.1 mL, 0.902 g, 2.50 mmol) was then added as a scavenger. Separately, in a 20 mL scintillation vial, catalyst A (400 mg, 0.721 mmol) was dissolved in MCH (8.3 mL), and the resulting mixture was premixed with the activator M2HTH-D4 (10 wt % in MCH, 11.7 mL, 0.758 mmol). The resulting mixture was stirred for 1 min before the first portion of the solution of the activated catalyst (ca 3 mL) was injected into the reactor. The catalyst solution was then added in small increments (1.5-3.0 mL) over 2.5 hrs causing the temperature to rise to 120° C., and delaying the next injection by 10-20 min until the temperature reached ˜117° C. A second catalyst portion was prepared identically to the above, and similarly, was then injected in increments, causing the reaction to slowly become a dark orange/brown. As more catalyst was added, the exothermic response became less pronounced. After all of the second portion of catalyst had been added over 2.5 hrs, the reaction mixture was stirred for additional 45 min. The contents were then removed from the reactor and passed through a column of activated basic alumina.

### Oligomerization Example 21: Oligomerization of VCB to but-3-ene-1,3-diyldicyclobutane Using Catalyst E

A 20 mL pressure resistant flask was charged with vinylcyclobutane (9.70 g, 118 mmol) and tri-n-octylaluminum (56 mg, 0.153 mmol). Separately, the solution of the catalyst E (20 mg, 0.045 mmol) in toluene (3 mL) was mixed with the activator M2HTH-D4 (10 wt % in methylcyclohexane, 0.72 mL, 0.0465 mmol). The resulting mixture was added to vinylcyclobutane and the flask was sealed and heated to 130° C. The reaction mixture was stirred for 3 hrs. The system was then cooled to ambient temperature and the reaction mixture was filtered through alumina to give a yellow liquid, which was used hydrogenation.

### Hydrogenation Example 22: Hydrogenation of but-3-ene-1,3-diyldicyclobutane to butane-1,3-diyldicyclobutane

The reaction mixture obtained in the previous Example 21 was hydrogenated by Pd/C (50 mg, 10 wt %) at 125° C. for 4 hrs at 40 psi H2 in a pressure resistant flask. Then, toluene and methylcyclohexane were removed by distillation under ambient pressure (ca 1.5 mL), and the residue was distilled under reduced pressure (0.5-1.0 mTorr). The collected product (bp 45-50° C., 1.04 g) was further re-hydrogenated at 125° C. for 4 hrs at 200 psi H2 to remove the traces of unsaturation.

### Oligomerization Example 23: Oligomerization of Vinylcyclohexane Using Catalyst E

For this example, only one monomer was used: 4-vinylcyclohexane. 4-Vinylcyclohexane was purchased from TCI chemicals and purified by sparging with nitrogen and stored above activated molecular sieves (4 Å) and AZ300. 4-Vinylcyclohexane (20.6 g, 187 mmol) and tri-n-octyl aluminum (17.1 μL, 14 mg, 0.0382 mmol) were combined in a 50 mL pressure-resistance flask. Separately, in a 20 mL scintillation vial, catalyst E (10 mg, 0.0225 mmol) was dissolved in methylcyclohexane (2 mL), and the resulting mixture was further premixed with the activator M2HTH-D4 (10 wt % in MCH, 0.35 mL, 0.0232 mmol). The resulting mixture was stirred for 1 min before adding to vinylcyclohexane. The flask was then sealed and heated to 136° C. The reaction mixture was stirred for 2 hrs before cooling and exposing to air. The content was removed from the flask and passed through a column of activated basic alumina to give a colorless liquid.

### Hydrogenation Example 24: Hydrogenation of but-3-ene-1,3-diyldicyclohexane to butane-1,3-diyldicyclohexane

The reaction mixture obtained in previous Example 23 (15 g) was added to the Parr Reactor containing the hydrogenation catalyst (NiSat, 2 wt %, 300 mg) and 50 mL hexane. The reactor was sealed and purged with N₂ for 10 min. Next, it was heated to 232° C., and pressurized with hydrogen (650 psi H2). The reaction mixture was stirred at 400 rpm for 2 hrs before cooling to the ambient temperature. Then, the catalyst was filtered off under anaerobic conditions, and hexane and other low boiling points ingredients were evaporated to give around 15 g of a fully saturated (based on 1H NMR) colorless liquid consisting of 88% of butane-1,3-diyldicyclohexane according to the GC analysis.

¹H NMR (400 MHz, C₆D₆): δ 1.75-1.57 (m, 9H), 1.37 (m, 1H), 1.28-1.10 (m, 11H), 1.08-0.87 (m, 4H), 0.84 (d, J_{HH}=6.7 Hz, 3H). ¹³C NMR (101 MHz, C₆D₆): δ 42.83, 38.39, 38.16, 35.49, 33.70, 33.36, 31.34, 30.76, 28.69, 27.03, 26.94, 26.90, 26.82, 26.55, 26.52, 16.02.

### Oligomerization Example 39 (Comparative): Oligomerization of VCH Using Catalyst F

For this example, 4-vinylcyclohexene was used. VCH (500 mL, 415 g, 3.84 mol) was added to the reactor, and the resulting mixture was heated to an internal temperature of 115° C. while stirring at 400 rpm. Tri-isobutyl aluminum (2.83 mL, 2.22 g, 11.2 mmol) was then added as a scavenger. Separately, in a 20 mL scintillation vial, catalyst F (225 mg, 0.770 mmol) was dissolved in toluene (4 mL), tri-isobutyl aluminum (2.0 mL, 1.57 g. 7.93 mmol) was slowly added, followed by a solution of M2HTH-D4 (10 wt. % in MCH, 13.1 mL, 0.849 mmol). After stirring the resulting catalyst solution for 10 min, 2 ml of the catalyst solution was added into the reactor followed by ˜2 ml increments over the next hour until the entire catalyst solution was added. Additions were made such that the temperature of the reactor was maintained between 115-120° C. After the final catalyst addition, the reaction was allowed to stir for an addition 4.5 hrs. After this time, the mixture was quenched with a few ml of isopropanol, and subsequently filtered through Celite, yielding approximately 0.5 L of a colorless liquid.

### Oligomerization Example 40 (Comparative): Oligomerization of VCH Using Catalyst F

For this example, 4-vinylcyclohexene was used. VCH (500 mL, 415 g, 3.84 mol) was added to the reactor, and the resulting mixture was heated to an internal temperature of 50° C. while stirring at 400 rpm. Tri-isobutyl aluminum (20.0 mL, 15.7 g, 79.3 mmol) was then added as a scavenger. Separately, in a 20 mL scintillation vial, catalyst F (560 mg, 1.92 mmol) was dissolved in toluene (3.0 mL), and tri-isobutyl aluminum (5.0 mL, 3.93 g, 19.8 mmol) was slowly added forming a yellow solution. When the reactor reached 48° C., the catalyst solution was added to the reactor followed by a solution of M2HTH-D4 (10 wt. % in MCH, 30 mL, 1.94 mmol). Upon addition of the catalyst components, the solution slowly warmed to 54° C. and turned a dark orange in color. The temperature of the reactor was maintained at ˜50° C. with stirring for a total of 5 hrs. Afterwards, the reactor contents were quenched with methanol (30 ml) with slow addition since the reaction is exothermic and generated heat, volatiles and a precipitate. Batch wise in 50 ml portions, the quenched reactor product was added to a separatory funnel and washed with 1 M HCL (3×25 ml), deionized water (2×25 ml), and brine (3×25 ml). After washing, the organic layer, a cloudy solution) was collected and dried with MgSO₄. This was then passed thru Celite and activated basic alumina.

### Characterization of Batch Oligomerization Reaction Mixtures by GC-MS

An Agilent 7890 GC with 5977B Inert Plus MSD Turbo EI/CI was used to obtain qualitative measurement by relative peak area % of the contents of the reaction mixture. The following parameters were used:

| | |
|---|---|
| Inlet Temperature | 280° C. |
| Detector Temperature | 280° C. |
| Sample Temp. Program | Initial 50° C. hold for 2 min |
| | Ramp @15° C./min to 250° C. hold for 5 min |
| Column Flow | 2 mL/min; |
| Split | Split mode; 200:1 |
| Injector | Autosampler (0.1 μL) |
| Column Composition | Agilent 19091S-433 HP-5Ms |
| Detection Method | Mass Spectrometry detector |
| Timed Event | MSD shut off 1.25-1.45 min |

Samples were prepared by diluting 50 μL of nonane or undecane (standard) into 500 μL of reaction sample and 500 μL isohexane. Mixtures of homodimers (A-A, B-B), heterodimers (A-B), and in some experiments, homotrimers (A-A-A, B-B-B) and heterotrimers (Ax2-B, Bx2+A) were observed. For some experiments, homotetramers and heterotetramers were also observed. For heterotrimers and heterotetramers, it was not possible to distinguish the order of the monomer units, for example A-A-B vs. A-B-A vs. B-A-A. The tables below represent the heterotrimers in the Ax2-B format. Heterotetramers are represented in a similar format, for example Ax2-Bx2. Each peak of the separated components were identified by mass, and then the amount of each component was determined by the area of each peak in relation to the total area of all the peaks to get a qualitative wt % of the sample, calculated using the following formula where “standard area” is the peak area for nonane (C9) or undecane (C11) depending on the standard used:

$$peak area \% = \frac{area of component}{Sum of all Areas - Standard Area} \times 100$$

Or in examples where standard was not added to the sample, the following formula was used

$$peak area \% = \frac{area of component}{Sum of all Areas} \times 100$$

From the GC chromatogram, retention peaks reported are the peak retention time. This number can vary to a certain degree from sample to sample based on the condition of the column. Peaks less than 1.5% were generally eliminated from the calculations.

The products from batch polymerization reactor runs (typically 12-16 runs) were combined into batches of same composition to obtain quantities from 3-4 gallons and were stored under ambient conditions until further processing. Methylcyclohexane (MCH) in samples is from solvent used for delivering catalyst and/or activator to the reactor.

For homo-oligomerization, the percent monomer conversion to dimer and trimer was calculated as the sum of the area for all dimer and trimer peaks times 100, then divided by the sum of the area of all non-solvent and non-GC-standard peaks (if present). The percent monomer conversion to all dimer products was calculated as the sum of the area for all dimer peaks times 100, then divided by the sum of the area all non-solvent and non-GC-standard peaks (if present). The percent monomer conversion to a single dimer (dimer isomer with greatest peak area) was calculated as the area of the largest dimer peak times 100, then divided by the sum of the area of all non-solvent and non-GC-standard peaks (if present). The percent selectivity to form dimer vs. trimer was calculated as the sum of the area for all dimer peaks times 100, then divided by the sum of the area of all dimer and trimer peaks. The percent selectivity to form one dimer species (one isomer) based on the total dimer formed was calculated as the sum of the area of the largest dimer peak times 100, then divided by the sum of the area of all dimer peaks.

### GC Characterization Example 1: Co-Oligomerized C6 and VCH from Use of Catalyst A

A chromatogram of the oligomerization product of 1-hexene (C6) and 4-vinyl-cyclohex-1-ene (VCH) using Catalyst A was obtained. Table 1A outlines the composition of the sample, and Table 1B summarizes the product composition.

TABLE 1A

| | Retention | Area | Peak Area |
|---|---|---|---|
| Identity | Time (min) | (a.u.) | (%) |
| MCH (solvent) | 1.98 | 12583560 | 1.8 |
| VCH (monomer) | 3.02 | 108593222 | 15.6 |
| nonane | 3.71 | 55163703 | |
| C6-C6 (dimer) | 6.22 | 131264122 | 18.8 |
| VCH-C6 (dimer) | 8.1 | 212666759 | 30.5 |
| C6-C6-C6 (trimer) | 9.31 | 34112188 | 4.9 |
| VCH-VCH (dimer) | 9.89 | 158131378 | 22.6 |
| VCH-C6x2 (trimer) | 10.83 | 40832550 | 5.8 |
| Total Area | | 753347482 | |

TABLE 1B

| Identity | % |
|---|---|
| C6-C6 (dimer) | 22.7 |
| VCH-C6 (dimer) | 36.9 |
| C6-C6-C6 (trimer) | 5.91 |
| VCH-VCH (dimer) | 27.4 |
| VCH-C6x2 (trimer) | 7.1 |
| all dimers | 87.0 |
| all trimers | 13.0 |

### GC Characterization Example 2: Co-Oligomerized C7 and VCH from Use of Catalyst A GC

A chromatogram of the oligomerization product of 1-heptene (C7) and 4-vinyl-cyclohex-1-ene (VCH) using Catalyst A was obtained. Table 2A outlines the composition of the sample, and Table 2B summarizes the product composition.

TABLE 2A

| | Retention | | Peak |
|---|---|---|---|
| Identity | Time (min) | Area (a.u.) | Area (%) |
| MCH (solvent) | 1.98 | 9829815 | 2.2 |
| VCH (monomer) | 3.02 | 82531133 | 18.2 |
| nonane | 3.71 | 35777806 | |
| C7-C7 (dimer) | 7.63 | 76085044 | 16.8 |
| VCH-C7 (dimer) | 8.74 | 153598159 | 33.9 |
| VCH-VCH (dimer) | 9.89 | 87687775 | 19.4 |
| C7-C7-C7 (trimer) | 10.81 | 17024178 | 3.8 |
| VCH-C7x2 (trimer) | 11.79 | 26268025 | 5.8 |

| | |
|---|---|
| Total Area | 48880193 |

TABLE 2B

| Identity | % |
|---|---|
| C7-C7 dimer | 21.1 |
| VCH-C7 (dimer) | 42.6 |
| VCH-VCH dimer | 24.31 |
| C7-C7-C7 (trimer) | 4.72 |
| VCH-C7x2 (trimer) | 7.28 |
| all dimers | 88.00 |
| all trimers | 12.00 |

### GC Characterization Example 3: Co-Oligomerized C5 and VCH from Use of Catalyst A

A chromatogram of the oligomerization product of 1-pentene (C5) and 4-vinyl-cyclohex-1-ene (VCH) using Catalyst A was obtained. Table 3A outlines the composition of the sample, and Table 3B summarizes the product composition.

TABLE 3A

| | Retention | | Peak |
|---|---|---|---|
| Identity | Time (min) | Area (a.u.) | Area (%) |
| MCH (solvent) | 1.99 | 8014984 | 2.2 |
| VCH (monomer) | 3.02 | 105084732 | 28.4 |
| C5 (dimer) | 4.49 | 68875603 | 18.6 |
| VCH-C5 (dimer) | 7.45 | 126646393 | 34.2 |
| VCH-C5 (dimer) | 7.65 | 13708249 | 3.7 |
| VCH-VCH (dimer) | 9.89 | 48334358 | 13.0 |

| | |
|---|---|
| Total Area | 370664319 |

TABLE 3B

| Identity | % |
|---|---|
| C5 (dimer) | 26.7 |
| VCH-C5 (dimer) | 54.5 |
| VCH-VCH (dimer) | 18.8 |
| all dimers | 100.0 |
| all trimers | 0.0 |

### GC Characterization Example 4: Oligomerized iC6 from Use of Catalyst D

A chromatogram of the oligomerization product of 4-methyl-1-pentene (iC6) using Catalyst D was obtained. Table 4A outlines the composition of the sample, and Table 4B summarizes the product composition.

TABLE 4A

| | Retention | | Peak |
|---|---|---|---|
| Identity | Time (min) | Area (a.u.) | Area (%) |
| MCH | 1.99 | 5378185 | 2.5 |
| nonane | 3.7 | 25562275 | |
| iC6-iC6 (dimer) | 5.52 | 164662258 | 75.3 |
| iC6-iC6-iC6 (trimer) | 8.47 | 29908257 | 13.7 |
| iC6-iC6-iC6-iC6 (tetramer) | 10.53 | 18862423 | 8.6 |

| | |
|---|---|
| Total Area | 244373398 |

TABLE 4B

| Identity | % |
|---|---|
| iC6-iC6 (dimer) | 77.1 |
| iC6-iC6-iC6 (trimer) | 14.0 |
| iC6-iC6-iC6-iC6 (tetramer) | 8.8 |

### GC Characterization Example 5: Co-Olioomerized C5 and C4 from Use of Catalyst A

A chromatogram of the oligomerization product of 1-butene (C4) and 1-pentene (C5) using Catalyst A was obtained. Table 5A outlines the composition of the sample, and Table 5B summarizes the product composition.

TABLE 5A

| | Retention | | Peak |
|---|---|---|---|
| Identity | Time (min) | Area (a.u.) | Area (%) |
| MCH (solvent) | 1.98 | 5872679 | 5.7 |
| C4-C4 (dimer) | 2.54 | 14788609 | 14.3 |
| C4-C5 (dimer) | 3.47 | 18050035 | 17.5 |
| C4-C5 (dimer) | 3.57 | 17015718 | 16.5 |
| C5-C5 (dimer) | 4.50 | 21074577 | 20.4 |
| undecane | 5.65 | 10997452 | |
| C4-C4-C4 (trimer) | 5.80 | 2147335 | 2.1 |
| C5-C4x2 (trimer) | 6.42 | 2706930 | 2.6 |
| C5-C4x2 (trimer) | 6.45 | 2568436 | 2.5 |
| C5-C4x2 (trimer) | 6.55 | 2636947 | 2.6 |
| C4-C5x2 (trimer) | 7.01 | 3197010 | 3.1 |
| C4-C5x2 (trimer) | 7.11 | 3320094 | 3.2 |
| C4-C5x2 (trimer) | 7.15 | 3025325 | 2.9 |
| C5-C5-C5 (trimer) | 7.65 | 3776035 | 3.7 |
| C5-C4x3 (tetramer) | 8.46 | 664284 | 0.6 |
| C4x2-C5x2 (tetramer) | 8.92 | 732736 | 0.7 |
| C4x2-C5x2 (tetramer) | 9.00 | 891498 | 0.9 |
| C4-C5x3 (tetramer) | 9.43 | 883954 | 0.9 |

| | |
|---|---|
| Total Area | 114349654 |

TABLE 5B

| Identity | % |
|---|---|
| C4-C4 (dimer) | 15.2 |
| C4-C5 (dimer) | 36.0 |
| C5-C5 (dimer) | 21.6 |
| C4-C4-C4 (trimer) | 2.2 |
| C5-C4x2 (trimer) | 8.1 |
| C4-C5x2 (trimer) | 9.8 |
| C5-C5-C5 (trimer) | 3.9 |
| C5-C4x3 (tetramer) | 0.7 |
| C4x2-C5x2 (tetramer) | 1.7 |
| C4-C5x3 (tetramer) | 0.9 |
| all dimers | 72.8 |
| all trimers | 24.0 |
| all tetramers | 3.3 |

### GC Characterization Example 6: Co-Oligomerized VCH and C4 from Use of Catalyst A

F A chromatogram of the oligomerization product of (1-butene) C4 and 4-vinyl-cyclohex-1-ene (VCH) using Catalyst A was obtained. Table 6A outlines the composition of the sample, and Table 6B summarizes the product composition.

TABLE 6A

| | Retention | | Peak |
|---|---|---|---|
| Identity | Time (min) | Area (a.u.) | Area (%) |
| MCH (solvent) | 1.985 | 5568315 | 2.1 |
| C4-C4 (dimer) | 2.543 | 18655866 | 6.9 |
| VCH (monomer) | 3.019 | 124152839 | 46.2 |
| nonane | 3.703 | 19099666 | |
| C4-C4-C4 (trimer) | 5.795 | 3038404 | 1.1 |
| VCH-C4 (dimer) | 6.795 | 88304468 | 32.9 |
| VCH-C4x2 (trimer) | 8.995 | 10139796 | 3.8 |
| VCH-VCH (dimer) | 9.881 | 18870744 | 7.0 |

| | |
|---|---|
| Total Area | 287830098 |

TABLE 6B

| Identity | % |
|---|---|
| C4-C4 (dimer) | 13.4 |
| C4-C4-C4 (trimer) | 2.2 |
| VCH-C4 (dimer) | 63.5 |
| VCH + C4x2 (trimer) | 7.3 |
| VCH-VCH (dimer) | 13.6 |
| all dimers | 90.5 |
| all trimers | 9.5 |

### GC Characterization Example 7: Co-Oligomerized VCH and iC6 from Use of Catalyst A

A chromatogram of the oligomerization product of 4-methylpent-1-ene (iC6) and 4-vinyl-cyclohex-1-ene (VCH) using Catalyst A was obtained. Table 7A outlines the composition of the sample, and Table 7B summarizes the product composition.

TABLE 7A

| | Retention | | Peak |
|---|---|---|---|
| Identity | Time (min) | Area (a.u.) | Area (%) |
| MCH (solvent) | 1.98 | 5882879 | 1.8 |
| VCH (monomer) | 3.02 | 84903289 | 25.9 |
| nonane | 3.7 | 27603139 | |
| iC6-iC6 (dimer) | 5.51 | 67757018 | 20.6 |
| VCH-iC6 (dimer) | 7.79 | 119548471 | 36.4 |
| iC6-iC6-iC6 (trimer) | 8.47 | 10294715 | 3.1 |
| VCH-VCH (dimer) | 9.88 | 18187810 | 5.5 |
| VCH-iC6x2 (trimer) | 10.279 | 16570117 | 5.0 |
| iC6-iC6-iC6-iC6 (tetramer) | 10.535 | 4990821 | 1.5 |

| | |
|---|---|
| total | 355738259 |

TABLE 7B

| Identity | % |
|---|---|
| iC6-iC6 (dimer) | 28.5 |
| VCH-iC6 (dimer) | 50.4 |
| iC6-iC6-iC6 (trimer) | 4.3 |
| VCH-VCH (dimer) | 7.7 |
| VCH-iC6x2 (trimer) | 7.0 |
| iC6-iC6-iC6-iC6 (tetramer) | 2.1 |
| all dimers | 86.6 |
| all trimers | 11.3 |
| all tetramers | 2.1 |

### GC Characterization Example 8: Oligomerized C5 from Use of Catalyst A

A chromatogram of the oligomerization product of 1-pentene (C5) using Catalyst A was obtained. Table 8A outlines the composition of the sample, and Table 8B summarizes the product composition.

TABLE 8A

| | Retention | | Peak |
|---|---|---|---|
| Identity | Time (min) | Area (a.u.) | Area (%) |
| MCH (solvent) | 1.98 | 13692365 | 3.9 |
| nonane | 3.7 | 28060247 | |
| C5-C5 (dimer) | 4.5 | 191162235 | 54.4 |
| C5-C5-C5 (trimer) | 7.65 | 110017347 | 31.3 |
| C5-C5-C5-C5 (tetramer) | 9.78 | 36743205 | 10.4 |

| | |
|---|---|
| total | 379675399 |

TABLE 8B

| Identity | % |
|---|---|
| C5-C5 (dimer) | 56.6 |
| C5-C5-C5 (trimer) | 32.6 |
| C5-C5-C5-C5 (tetramer) | 10.9 |

### GC Characterization Bramble 9: Olioomerized C4 from Use of Catalyst A

A chromatogram of the oligomerization product of 1-butene (C4) with catalyst A was obtained. Table 9A outlines the composition of the sample, and Table 9B summarizes the product composition.

TABLE 9A

| | Retention Time | Area | Peak Area |
|---|---|---|---|
| Identity | (min) | (a.u.) | (%) |
| C4 (monomer) | 1.17 | 2715816 | 1.3 |
| MCH (solvent) | 1.99 | 5583694 | 2.6 |
| C4-C4 (dimer) | 2.54 | 129208975 | 61.3 |
| nonane | 3.7 | 21692385 | |
| C4-C4-C4 (trimer) | 5.8 | 53915157 | 25.6 |
| C4-C4-C4-C4 (tetramer) | 8 | 8451907 | 4.0 |
| C4-C4-C4-C4 (tetramer) | 8.03 | 10830276 | 5.1 |

| | |
|---|---|
| total | 232398210 |

TABLE 9B

| Identity | % |
|---|---|
| C4-C4 (dimer) | 63.8 |
| C4-C4-C4 (trimer) | 26.6 |
| C4-C4-C4-C4 (tetramer) | 9.5 |

### GC Characterization Example 10; Oligomerized C4 from Use of Catalyst C

A chromatogram of the oligomerization product of 1-butene (C4) with Catalyst C was obtained. Table 10A outlines the composition of the sample, and Table 10B summarizes the product composition.

TABLE 10A

| | Retention Time | Area | Peak Area |
|---|---|---|---|
| Identity | (min) | (a.u) | (%) |
| C4 | 1.17 | 13766304 | 4.4 |
| MCH | 1.99 | 6734296 | 2.2 |
| C4×2 | 2.54 | 99549683 | 31.8 |
| nonane | 3.7 | 28621018 | |
| C4×3 | 5.8 | 84401333 | 27.0 |
| C4x4 | 8 | 62500816 | 20.0 |
| Other oligomers | 9.7 | 46081994 | 14.7 |

| | |
|---|---|
| total | 341655444 |

TABLE 10B

| Identity | % |
|---|---|
| C4-C4 (dimer) | 34.0 |
| C4-C4-C4 (trimer) | 28.9 |
| C4-C4-C4-C4 (tetramer) | 21.4 |
| other oligomers | 15.8 |

### GC Characterization Example 11: Oligomerized C6 from Use of Catalyst A

A chromatogram of the oligomerization product of 1-hexene (C6) with Catalyst A was obtained. Table 11A outlines the composition of the sample, and Table 11B summarizes the product composition.

TABLE 11A

| | Retention Time | Area | |
|---|---|---|---|
| Identity | (min) | (a.u.) | Peak Area (%) |
| MCH (solvent) | 1.99 | 645146 | 1.2 |
| nonane | 3.71 | 8029777 | |
| C6-C6 (dimer) | 6.17 | 1684910 | 3.2 |
| C6-C6 (dimer) | 6.24 | 35692438 | 68.4 |
| C6-C6-C6 (trimer) | 9.32 | 11157997 | 21.4 |
| C6-C6-C6-C6 (tetramer) | 11.51 | 3010095 | 5.8 |

| | |
|---|---|
| Total Area | 60220363 |

TABLE 11B

| Identity | % |
|---|---|
| C6-C6 (dimer) | 72.5 |
| C6-C6-C6 (trimer) | 21.6 |
| C6-C6-C6-C6 (tetramer) | 5.8 |

### GC Characterization Example 12: Oligomerized C8 from Use of Catalyst A

A chromatogram of the oligomerization product of 1-octene (C8) with Catalyst A was obtained. Table 12A outlines the composition of the sample, and Table 12B summarizes the product composition.

TABLE 12A

| | Retention Time | Area | Peak Area |
|---|---|---|---|
| Identity | (min) | (a.u.) | (%) |
| MCH | 1.98 | 524037 | 1.5 |
| nonane | 3.69 | 3158320 | |
| C8-C8 (dimer) | 8.76 | 1522473 | 4.4 |
| C8-C8 (dimer) | 8.89 | 23265298 | 67.7 |
| C8-C8-C8 (trimer) | 12.33 | 7773614 | 22.6 |
| other | | 1263864 | 3.7 |

| | |
|---|---|
| Total Area | 37507606 |

TABLE 12B

| Identity | % |
|---|---|
| C8-C8 (dimer) | 76.1 |
| C8-C8-C8 (trimer) | 23.9 |

### GC Characterization Example 13: Co-Oligomerized C6 (25%) and C8 (75%) from Use of Catalyst A

A chromatogram of the oligomerization product of 1-hexene (C6) and 1-octene (C8) with Catalyst A was obtained. Table 13A outlines the composition of the sample, and Table 13B summarizes the product composition.

TABLE 13A

| | Retention Time | Area | Peak Area |
|---|---|---|---|
| Identity | (min) | (a.u) | (%) |
| MCH (solvent) | 1.98 | 301093 | 1.6 |
| nonane | 3.71 | 1102482 | |
| C6-C6 (dimer) | 6.20 | 860815 | 4.5 |
| C6-C8 (dimer) | 7.62 | 2650859 | 13.7 |
| C6-C8 (dimer) | 7.64 | 2818148 | 14.6 |
| C8-C8 (dimer) | 8.76 | 210541 | 1.1 |
| C8-C8 (dimer) | 8.88 | 7496099 | 38.8 |
| C6-C6-C6 (trimer) | 9.30 | 75222 | 0.4 |
| C8-C6x2 (trimer) | 10.33 | 452027 | 2.3 |
| C8-C6x2 (trimer) | 10.38 | 226337 | 1.2 |
| C6-C8x2 (trimer) | 11.29 | 622561 | 3.2 |
| C6-C8x2 (trimer) | 11.34 | 1389808 | 7.2 |
| C8-C8-C8 (trimer) | 12.33 | 1941472 | 10.1 |
| other oligomers | | 267611 | 1.4 |

| | |
|---|---|
| Total Area | 20415076 |

TABLE 13B

| Identity | % |
|---|---|
| C6-C6 (dimer) | 4.5 |
| C6-C8 (dimer) | 28.8 |
| C8-C8 (dimer) | 40.5 |
| C6-C6-C6 (trimer) | 0.4 |
| C8-C6x2 (trimer) | 3.6 |
| C6-C8x2 (trimer) | 10.6 |
| C8-C8-C8 (trimer) | 10.2 |
| other oligomers | 1.4 |
| all dimers | 73.8 |
| all trimers | 24.8 |
| all other oligomers | 1.4 |

### GC Characterization Example 14: Co-Oligomerized C6 (50%) and C8 (50%) from Use of Catalyst A

A chromatogram of the oligomerization product of 1-hexene (C6) and 1-octene (C8) with Catalyst A was obtained. Table 14A outlines the composition of the sample, and Table 14B summarizes the product composition.

TABLE 14A

| | Retention Time | Area | Peak Area |
|---|---|---|---|
| Identity | (min) | (a.u.) | (%) |
| MCH (solvent) | 1.981 | 670931 | 1.9 |
| nonane | 3.7 | 2624996 | |
| C6-C6 (dimer) | 6.149 | 301852 | 0.8 |
| C6-C6 (dimer) | 6.204 | 6587135 | 18.5 |
| C6-C8 (dimer) | 7.519 | 366719 | 1.0 |
| C6-C8 (dimer) | 7.579 | 321132 | 0.9 |
| C6-C8 (dimer) | 7.617 | 6648483 | 18.7 |
| C6-C8 (dimer) | 7.649 | 6685417 | 18.8 |
| C8-C8 (dimer) | 8.757 | 381554 | 1.1 |
| C8-C8 (dimer) | 8.877 | 6714927 | 18.9 |
| C6-C6-C6 (trimer) | 9.297 | 820675 | 2.3 |
| C8-C6x2 (trimer) | 10.323 | 1584497 | 4.5 |
| C8-C6x2 (trimer) | 10.372 | 765620 | 2.2 |
| C6-C8x2 (trimer) | 11.272 | 627348 | 1.8 |
| C6-C8x2 (trimer) | 11.332 | 1479934 | 4.2 |
| C6-C6-C6-C6 (tetramer) | 11.49 | 127,499 | 0.4 |
| C8-C8-C8 (trimer) | 12.29 | 604,791 | 1.7 |
| C8-C8-C8 (trimer) | 12.41 | 494,893 | 1.4 |
| other | | 421,809 | 1.2 |

| | |
|---|---|
| Total Area | 38230213 |

TABLE 14B

| Identity | % |
|---|---|
| C6-C6 (dimer) | 19.7 |
| C6-C8 (dimer) | 40.1 |
| C8-C8 (dimer) | 20.3 |
| C6-C6-C6 (trimer) | 2.3 |
| C8-C6x2 (trimer) | 6.7 |
| C6-C8x2 (trimer) | 6.0 |
| C6-C6-C6-C6 (tetramer) | 0.4 |
| C8-C8-C8 (trimer) | 3.1 |
| other oligomers | 1.2 |
| all dimers | 80.2 |
| all trimers | 18.3 |
| all tetramers | 0.4 |
| all other oligomers | 1.2 |

### GC Characterization Example 15: Co-Oligomerized C6 (75%) and C8 (25%) from Use of Catalyst A

A chromatogram of the oligomerization product of 1-hexene (C6) and 1-octene (C8) with Catalyst A was obtained. Table 15A outlines the composition of the sample, and Table 15B summarizes the product composition.

TABLE 15A

| | Retention Time | Area | Peak Area |
|---|---|---|---|
| Identity | (min) | (a.u.) | (%) |
| MCH (solvent) | 1.98 | 660592 | 1.6 |
| nonane | 3.70 | 3214678 | |
| C6-C6 (dimer) | 6.15 | 473987 | 1.1 |
| C6-C6 (dimer) | 6.21 | 13680086 | 32.5 |
| C6-C8 (dimer) | 7.52 | 193155 | 0.5 |
| C6-C8 (dimer) | 7.58 | 177673 | 0.4 |
| C6-C8 (dimer) | 7.62 | 6517699 | 15.5 |
| C6-C8 (dimer) | 7.65 | 6682331 | 15.9 |
| C8-C8 (dimer) | 8.87 | 2832279 | 6.7 |
| C6-C6-C6 (trimer) | 9.30 | 3339262 | 7.9 |
| C8-C6x2 (trimer) | 10.32 | 2611531 | 6.2 |
| C8-C6x2 (trimer) | 10.37 | 1287040 | 3.1 |
| C6-C8x2 (trimer) | 11.27 | 407798 | 1.0 |
| C6-C8x2 (trimer) | 11.33 | 921691 | 2.2 |
| C6-C6-C6-C6 (tetramer) | 11.50 | 672084 | 1.6 |
| C8-C8-C8 (trimer) | 12.41 | 1078620 | 2.6 |
| Other oligomers | | 503167 | 1.2 |

| | |
|---|---|
| Total Area | 45253672 |

TABLE 15B

| Identity | % |
|---|---|
| C6-C6 (dimer) | 34.2 |
| C6-C8 (dimer) | 32.8 |
| C8-C8 (dimer) | 6.8 |
| C6-C6-C6 (trimer) | 8.1 |
| C8-C6x2 (trimer) | 9.4 |
| C6-C8x2 (trimer) | 3.2 |
| C6-C6-C6-C6 (tetramer) | 1.6 |
| C8-C8-C8 (trimer) | 2.6 |
| other oligomers | 1.2 |
| all dimers | 73.8 |
| all trimers | 23.3 |
| all tetramers | 1.6 |
| all other oligomers | 1.2 |

### GC Characterization Example 16: Co-Oligomerized C8 and VCH from Nee of Catalyst A

A chromatogram of the oligomerization product of 1-octene (C8) and 4-vinyl-cyclohex-1-ene (VCH) using Catalyst A was obtained. Table 16A outlines the composition of the sample, and Table 16B summarizes the product composition.

TABLE 16A

| | Retention | Area | Peak |
|---|---|---|---|
| Identity | Time (min) | (a.u.) | Area (%) |
| MCH (solvent) | 1.981 | 648206 | 0.9 |
| VCH (monomer) | 3.018 | 11710622 | 16.8 |
| nonane | 3.7 | 5326961 | |
| C8-C8 (dimer) | 8.762 | 457906 | 0.7 |
| C8-C8 (dimer) | 8.888 | 18529695 | 26.5 |
| VCH-C8 (dimer) | 9.21 | 570637 | 0.8 |
| VCH-C8 (dimer) | 9.346 | 28041651 | 40.1 |
| VCH-C8 (dimer) | 9.401 | 664686 | 1.0 |
| VCH-VCH (dimer) | 9.881 | 775149 | 1.1 |
| C8-C8-C8 (trimer) | 12.325 | 3554163 | 5.1 |
| VCH-C8x2 (trimer) | 12.914 | 4917297 | 7.0 |
| Others | | 1566717 | 2.2 |

| | |
|---|---|
| Total Area | 76763691 |

TABLE 16B

| Identity | % |
|---|---|
| C8-C8 (dimer) | 32.1 |
| VCH-C8 (dimer) | 49.6 |
| VCH-VCH (dimer) | 1.3 |
| C8-C8-C8 (trimer) | 6.0 |
| VCH-C8x2 (trimer) | 8.3 |
| other oligomers | 2.7 |
| all dimers | 83.0 |
| all trimers | 14.3 |
| all other oligomers | 2.7 |

### GC Characterization Example 17: Co-Oligomerized C9 and VCH from Use of Catalyst A

A chromatogram of the oligomerization product of 1-nonene (C9) and 4-vinyl-cyclohex-1-ene (VCH) using Catalyst A was obtained. Table 17A outlines the composition of the sample, and Table 17B summarizes the product composition.

TABLE 17A

| | Retention | Area | Peak |
|---|---|---|---|
| Identity | Time (min) | (a.u.) | Area (%) |
| VCH (monomer) | 3.017 | 802750 | 1.1 |
| nonane | 3.7 | 4531198 | |
| VCH-C9 (dimer) | 9.771 | 1806152 | 2.5 |
| VCH-VCH (dimer) | 9.875 | 1091757 | 1.5 |
| VCH-C9 (dimer) | 9.935 | 37114155 | 52.1 |
| C9-C9 (dimer) | 10.022 | 20556424 | 28.9 |
| C9-C9 (dimer) | 10.126 | 869773 | 1.2 |
| C9-C9 (dimer) | 10.224 | 734377 | 1.0 |
| C9-C9-C9 (trimer) | 14.627 | 6463961 | 9.1 |
| Others | | 1740086 | 2.4 |
| Total Area | 75710635 | | |

TABLE 17B

| Identity | % |
|---|---|
| VCH-C9 (dimer) | 55.3 |
| VCH-VCH (dimer) | 1.6 |
| C9-C9 (dimer) | 31.5 |
| C9-C9-C9 (trimer) | 9.2 |
| other oligomers | 2.5 |
| all dimers | 88.3 |
| all trimers | 9.2 |
| all other oligomers | 2.5 |

### GC Characterization Example 18: Co-Oligomerized C10 and VCH from Use of Catalyst A

A chromatogram of the oligomerization product of 1-decene (C10) and 4-vinyl-cyclohex-1-ene (VCH) using Catalyst A. Table 18A outlines the composition of the sample, and Table 18B summarizes the product composition.

TABLE 18A

| | Retention | Area | Peak |
|---|---|---|---|
| Identity | Time (min) | (a.u.) | Area (%) |
| MCH (solvent) | 1.992 | 244883 | 0.3 |
| VCH (monomer) | 3.018 | 9136809 | 9.8 |
| nonane | 3.705 | 6364016 | |
| VCH-VCH (dimer) | 9.875 | 1585328 | 1.7 |
| VCH-C10 (dimer) | 10.328 | 1127871 | 1.2 |
| VCH-C10 (dimer) | 10.508 | 47759132 | 51.2 |
| C10-C10 (dimer) | 10.928 | 858750 | 0.9 |
| C10-C10 (dimer) | 11.097 | 22858001 | 24.5 |
| C10-C10-C10 (trimer) | 17.747 | 3779525 | 4.1 |
| VCH-C10x2 (trimer) | 20.366 | 1211591 | 1.3 |
| Others | | 4666537 | 5.0 |

| | |
|---|---|
| Total Area | 99592442 |

TABLE 18B

| Identity | % |
|---|---|
| VCH-VCH (dimer) | 1.9 |
| VCH-C10 (dimer) | 58.3 |
| C10-C10 (dimer) | 28.3 |
| C10-C10-C10 (trimer) | 4.5 |
| VCH-C10x2 (trimer) | 1.4 |
| other oligomers | 5.6 |
| all dimers | 88.5 |
| all trimers | 6.0 |
| all other oligomers | 5.6 |

### GC Characterization Example 19: Oligomerized VCH from Use of Catalyst E

A chromatogram of the oligomerization product of 4-vinyl-cyclohex-1-ene (VCH) using Catalyst E was obtained. Table 19A outlines the composition of the sample, and Table 19B summarizes the product composition. Based on GC-MS analysis, VCH conversion to dimer and trimer was 90.6%, VCH conversion to all dimer products was 81.3%, and VCH conversion to a single dimer (dimer isomer with greatest peak area) was 65.1%. Selectivity to form dimer vs. trimer was 89.8%, and selectivity to form one dimer species (one isomer) based on the total dimer formed was 80.0%.

TABLE 19A

| | Retention | Area | Peak Area |
|---|---|---|---|
| Identity | Time (min) | (a.u.) | (%) |
| MCH (solvent) | 1.986 | 192047 | 0.4 |
| VCH (monomer) | 3.017 | 3075139 | 6.8 |
| VCH isomerized | 3.356 | 326339 | 0.7 |
| VCH isomerized | 3.405 | 477656 | 1.1 |
| VCH isomerized | 3.678 | 384375 | 0.8 |
| nonane | 3.705 | 3400871 | |
| VCH-VCH (dimer) | 9.755 | 1059205 | 2.3 |
| VCH-VCH (dimer) | 9.82 | 1924713 | 4.2 |
| VCH-VCH (dimer) | 9.902 | 29408035 | 64.8 |
| VCH-VCH (dimer) | 10 | 3670966 | 8.1 |
| VCH-VCH (dimer) | 10.082 | 689535 | 1.5 |
| VCH-VCH-VCH (trimer) | 17.234 | 2036959 | 4.5 |
| VCH-VCH-VCH(trimer) | 17.982 | 2125775 | 4.7 |

| | |
|---|---|
| Total Area | 48771615 |

TABLE 19B

| Identity | % |
|---|---|
| VCH-VCH (dimer) | 89.8 |
| VCH-VCH-VCH (trimer) | 10.2 |

### GC Characterization Example 20: Oligomerized VCH from Use of Catalyst A

A chromatogram of the oligomerization product of 4-vinyl-cyclohex-1-ene (VCH) using Catalyst A was obtained. Table 20A outlines the composition of the sample, and Table 20B summarizes the product composition. Based on GC-MS analysis, VCH conversion to dimer was 96.2% (no trimer was observed), VCH conversion to all dimer products was 96.2%, and VCH conversion to a single dimer (dimer isomer with greatest peak area) was 94.5%. Selectivity to form dimer vs. trimer was 100%, and selectivity to form one dimer species (one isomer) based on the total dimer formed was 98.2%.

TABLE 20A

| | Retention | Area | Peak |
|---|---|---|---|
| Identity | Time (min) | (a.u.) | Area (%) |
| MCH | 1.986 | 120326 | 2.5 |
| VCH | 3.039 | 183171 | 3.7 |
| nonane | 3.748 | 217020 | |
| VCH-VCH (dimer) | 9.875 | 4525935 | 92.2 |
| VCH-VCH (dimer) | 10.017 | 81257 | 1.7 |

| | |
|---|---|
| Total Area | 5127710 |

TABLE 20B

| Identity | % |
|---|---|
| VCH-VCH (dimer) | 100.0 |

### GC Characterization Example 21: Oligomerized VCB to but-3-ene-1,3-diyldicyclobutane From Use of Catalyst E

A chromatogram of the oligomerization product of 4-vinylcyclobutane (VCB) using Catalyst E was obtained. Table 21A outlines the composition of the sample, and Table 21B summarizes the product composition. Based on GC-MS analysis, VCB conversion to dimer, trimer and higher oligomers was 98.1%, VCB conversion to all dimer products was 50.4%, and VCB conversion to a single dimer (dimer isomer with greatest peak area) was 37.1%. Selectivity to form dimer vs. trimer and higher oligomers was 51.4%, and selectivity to form one dimer species (one isomer) based on the total dimer formed was 73.7%.

TABLE 21A

| | Retention | | |
|---|---|---|---|
| | Time | Area | Peak |
| Identity | (min) | (a.u.) | Area, % |
| VCB (monomer) | 1.485 | 374802 | 1.0 |
| MCH (solvent) | 1.976 | 8578979 | 22.5 |
| Toluene (solvent) | 2.352 | 9770857 | 25.6 |
| nonane | 3.694 | 3951342 | |
| VCB (dimer) | 6.607 | 272368 | 0.7 |
| VCB (dimer) | 6.656 | 1037655 | 2.7 |
| VCB (dimer) | 6.869 | 7334573 | 19.2 |
| VCB (dimer) | 6.984 | 1312135 | 3.4 |
| VCB (trimer) | 10.093 | 494698 | 1.3 |
| VCB (trimer) | 10.344 | 2552003 | 6.7 |
| VCB (trimer) | 10.513 | 1035593 | 2.7 |
| VCB (trimer) | 10.743 | 1769215 | 4.6 |
| VCB (trimer) | 11.026 | 950958 | 2.5 |
| VCB (oligomers) | 13.219 | 1278664 | 3.4 |
| VCB (oligomers) | 14.289 | 1348071 | 3.5 |

| | |
|---|---|
| Total Area | 42061913 |

TABLE 21B

| Identity | % |
|---|---|
| VCB-VCB (dimer) | 51.4 |
| VCB-VCB-VCB (trimer) | 35.1 |
| VCB oligomers | 13.5 |

### GC Characterization Example 22: Hydrogenation of but-3-ene-1,3-diyldicyclobutane to butane-1,3-diyldicyclobutane

A chromatogram of the hydrogenation product of but-3-ene-1,3-diyldicyclobutane using Catalyst E was obtained. Table 22A outlines the composition of the sample, and Table 22B summarizes the product composition.

TABLE 22A

| | Retention | | |
|---|---|---|---|
| | Time | Area | Peak |
| Identity | (min) | (a.u.) | Area, % |
| MCH (solvent) | 1.981 | 153558 | 1.1 |
| Toluene (solvent) | 2.396 | 199962 | 1.4 |
| nonane | 3.694 | 1355186 | |
| hydrogenated (dimer) | 6.411 | 2696830 | 18.8 |
| hydrogenated (dimer) | 6.668 | 11320361 | 78.8 |

| | |
|---|---|
| Total Area | 15725897 |

TABLE 22B

| Identity | % |
|---|---|
| Hydrogenated VCB-VCB (dimer) | 100.0 |

### GC Characterization Example 23: Oligomerized Vinylcyclohexane to but-3-ene-1,3-diyldicyclohexane From Use of Catalyst E

A chromatogram of the oligomerization product of 4-vinylcyclohexane (vch) using Catalyst E was obtained. Table 23A outlines the composition of the sample, and Table 23B summarizes the product composition. Vinylcyclohexane conversion based on GC sample composition was 98%. Based on GC-MS analysis, vch conversion to dimer and trimer was 92.7%, vch conversion to all dimer products was 88.1%, and vch conversion to a single dimer (dimer isomer with greatest peak area) was 85.1%. Selectivity to form dimer vs. trimer was 95.0%, and selectivity to form one dimer species (one isomer) based on the total dimer formed was 96.6%

TABLE 23A

| | Retention | | Peak |
|---|---|---|---|
| | Time | Area | Area |
| Identity | (min) | (a.u.) | (%) |
| Methylcyclohexane (solvent) | 1.976 | 3106133 | 5.4 |
| 4-Vinylcyclohexane (monomer) | 2.881 | 1102836 | 1.9 |
| Ethylcyclohexane (impurity) | 3.012 | 129703 | 0.2 |
| 1-ethyl-cyclohexene (monomer isom) | 3.394 | 2897099 | 5.0 |
| nonane | 3.7 | 5064702 | |
| 4-Vinylcyclohexane (dimer) | 9.499 | 510679 | 0.9 |
| 4-Vinylcyclohexane (dimer) | 9.673 | 46568881 | 80.4 |
| 4-Vinylcyclohexane (dimer) | 9.815 | 580800 | 1.0 |
| 4-Vinylcyclohexane (dimer) | 9.892 | 524735 | 0.9 |
| 4-Vinylcyclohexane (trimer) | 14.223 | 2512395 | 4.3 |

| | |
|---|---|
| Total Area | 62997963 |

TABLE 23B

| Identity | % |
|---|---|
| vch-vch (dimer) | 95.0 |
| vch-vch-vch (trimer) | 5.0 |

### GC Characterization Example 24: Hydrogenation of but-3-ene-1,3-diyldicyclohexane to butane-1,3-diyldicyclohexane

A chromatogram of the hydrogenation product of but-3-ene-1,3-diyldicyclohexane using Catalyst E was obtained. Table 24A outlines the composition of the sample, and Table 24B summarizes the product composition.

TABLE 24A

| | Retention | | Peak |
|---|---|---|---|
| Identity | Time (min) | Area (a.u.) | Area (%) |
| hexane (solvent) | 1.501 | 410318 | 0.8 |
| MCH(solvent) | 1.987 | 130493 | 0.3 |
| ethylcyclohexane (hydro- | 3.001 | 1290524 | 2.5 |
| monomer) | | | |
| nonane (GC standard) | 3.7 | 4800896 | |
| hydro (dimer) | 9.706 | 45844852 | 87.9 |
| hydro (dimer) | 9.864 | 1657857 | 3.2 |
| hydro (trimers) | 14.387 | 2795970 | 5.4 |

TABLE 24B

| Identity | % |
|---|---|
| h-dimers | 94.4 |
| h-trimers | 5.6 |

### GC Characterization Example 39 (Comparative): Oligomerization of VCH Using Catalyst F

A chromatogram of the oligomerization product of 4-vinyl-cyclohex-1-ene (VCH) using Catalyst F was obtained. Table 39A outlines the composition of the sample, and Table 39B summarizes the product composition. Based on GC-MS analysis, VCH conversion to dimer and trimer was 41.2%, VCH conversion to all dimer products was 36.6%, and VCH conversion to a single dimer (dimer isomer with greatest peak area) was 28.1%. Selectivity to form dimer vs. trimer was 89.0%, and selectivity to form one dimer species (one isomer) based on the total dimer formed was 76.7%.

TABLE 39A

| | Retention | | Peak |
|---|---|---|---|
| Identity | Time (min) | Area (a.u.) | Area (%) |
| MCH | 1.981 | 686012 | 1.9 |
| toluene | 2.434 | 301037 | 0.8 |
| VCH | 3.012 | 12739392 | 34.8 |
| VCH + H2 | 3.187 | 940895 | 2.6 |
| VCH-H2 | 3.329 | 1077145 | 2.9 |
| VCH + H2 | 3.394 | 1129419 | 3.1 |
| VCH isom | 3.667 | 3666673 | 10.0 |
| nonane | 3.694 | 3528742 | |
| VCH isom | 3.809 | 254246 | 0.7 |
| VCH isom | 3.918 | 343553 | 0.9 |
| VCH isom | 3.951 | 809983 | 2.2 |
| VCH dimer isom? | 9.668 | 202034 | 0.6 |
| VCH dimer isom? | 9.761 | 719622 | 2.0 |
| VCH dimer | 9.821 | 482790 | 1.3 |
| VCH dimer | 9.881 | 10001749 | 27.3 |
| VCH dimer | 10.001 | 400766 | 1.1 |
| VCH dimer | 10.093 | 850123 | 2.3 |
| VCH dimer | 10.230 | 135402 | 0.4 |
| VCH dimer | 10.284 | 255184 | 0.7 |
| VCH trimer | 18.293 | 1616958 | 4.4 |
| Total Area | | 40141727 | |

TABLE 39B

| Identity | % |
|---|---|
| VCH-VCH (dimer) | 89.0 |
| VCH-VCH-VCH (trimer) | 11.0 |

### GC Characterization Example 40 (Comparative): Oligomerization of VCH Using Catalyst F

A chromatogram of the oligomerization product of 4-vinyl-cyclohex-1-ene (VCH) using Catalyst F was obtained. Table 40A outlines the composition of the sample, and Table 40B summarizes the product composition. Based on GC-MS analysis, VCH conversion to dimer and trimer was 32.4%, VCH conversion to all dimer products was 30.0%, and VCH conversion to a single dimer (dimer isomer with greatest peak area) was 15.5%. Selectivity to form dimer vs. trimer was 92.7%, and selectivity to form one dimer species (one isomer) based on the total dimer formed was 51.7%.

TABLE 40A

| | Retention | |
|---|---|---|
| Identity | Time (min) | Area (a.u) |
| MCH | 1.976 | 2316765 |
| tol | 2.429 | 463659 |
| VCH | 3.023 | 24330311 |
| VCH + 1H2 | 3.181 | 2499553 |
| nonane | 3.694 | 5183432 |
| VCH dimer | 9.881 | 5498257 |
| VCH dimer + H2 | 9.919 | 6163456 |
| VCH dimer + H2 | 10.017 | 263175 |
| trimer | 17.436 | 324114 |
| trimer | 18.145 | 614611 |

| | |
|---|---|
| Total Area | 47657333 |

TABLE 40B

| Identity | % |
|---|---|
| VCH-VCH (dimer) | 92.7 |
| VCH-VCH-VCH (trimer) | 7.3 |

### NMR Characterization of Batch Oligomerization Examples

### Quantitative Characterization of Reaction Mixture by Proton NMR

Specifically, an NMR instrument of 500 MHz is run under the following conditions: a ˜30° flip angle RF pulse, 128 scans, with a relaxation delay of ˜5 s between pulses; sample (60-100 mg) dissolved in CDCl₃ (deuterated chloroform) in a 5 mm NMR tube; and signal collection temperature at ˜25° C. The following approach is taken in determining the concentrations of the various olefins among all of the olefins from an NMR spectrum. First, peaks corresponding to different types of hydrogen atoms in vinyls (T1), vinylidenes (T2), di-substituted vinylenes (T3), and tri-substituted vinylenes (T4) are identified at the peak regions which will vary by monomer as shown in Table 25. Second, areas of each of the above peaks (A1, A2, A3, and A4, respectively) are then integrated. Third, quantities of each type of olefins (Q1, Q2, Q3, and Q4, respectively) in moles are calculated (as A1/2, A2/2, A3/2, and A4, respectively). Fourth, the total quantity of all olefins (Qt) in moles is calculated as the sum total of all four types (Qt=Q1+Q2+Q3+Q4). Finally, the molar concentrations (C1, C2, C3, and C4, respectively, in mol %) of each type of olefin, on the basis of the total molar quantity of all of the olefins, is then calculated (in each case, Ci=100*Qi/Qt). This procedure was used when end-group analysis was quantified. Other conditions/solvents for proton spectra may have been used for general characterization.

TABLE 25

| Hydrogen Atoms | | Peak | | Number of | | Concentration |
|---|---|---|---|---|---|---|
| Type | Olefin | Region | Peak | Hydrogen | Quantity of | of Olefin |
| No. | Structure | (ppm) | Area | Atoms | Olefin (mol) | (mol %) |
| T1 | CH₂═CH—R¹ | varies | A1 | 2 | Q1 = A1/2 | C1 |
| T2 | CH₂═CR¹R² | varies | A2 | 2 | Q2 = A2/2 | C2 |
| T3 | CHR¹═CHR² | varies | A3 | 2 | Q3 = A3/2 | C3 |
| T4 | CR¹R²═CH R³ | varies | A4 | 1 | Q4 = A4 | C4 |

### NMR Spectra of Examples 1-24

A ¹H NMR spectrum of the reaction mixture of a co-oligomerization reaction of 1-hexene and vinylcyclohexene using Catalyst A (Example 1) was obtained.

A ¹H NMR spectrum of the reaction mixture of a co-oligomerization reaction of 1-heptene and vinylcyclohexene using Catalyst A (Example 2) was obtained.

A ¹H NMR spectrum of the reaction mixture of a co-oligomerization reaction of 1-pentene and vinylcyclohexene using Catalyst A (Example 3) was obtained.

A ¹H NMR spectrum of the reaction mixture of an oligomerization reaction using 4-methylpent-1-ene using Catalyst D (Example 4) was obtained.

A ¹H NMR spectrum of the reaction mixture of an oligomerization reaction of the monomers 1-butene and 1-pentene using Catalyst A (Example 5) was obtained. Table 26 shows the calculated olefinic composition.

TABLE 26

| Hydrogen Atoms | | Peak | | Number of | Quantity of | Concentration |
|---|---|---|---|---|---|---|
| | Olefin | Region | Peak | Hydrogen | Olefin | of Olefin |
| Type No. | Structure | (ppm) | Area | Atoms | (mol) | (mol %) |
| Saturated | N/A | 0.00-2.30 | 1004.6 | | | |
| T1 | CH₂═CH—R¹ | 4.90-5.08 | 1.66 | 2 | 0.83 | 1.59 |
| T2 | CH₂═CR¹R² | 4.50-4.90 | 100.00 | 2 | 50.0 | 95.6 |
| T3 | CHR¹═CHR² | 5.35-5.55 | 0.91 | 2 | 0.455 | 0.87 |
| T4 | CR¹R²═CHR³ | 5.08-5.35 | 1.00 | 1 | 1.00 | 1.91 |

A ¹H NMR spectrum of the reaction mixture of a co-oligomerization reaction of 1-butene and vinylcyclohexene using Catalyst A (Example 6) was obtained.

A ¹H NMR spectrum of the reaction mixture of an oligomerization reaction of the monomer 1-pentene using Catalyst A (Example 8) was obtained. Table 27 shows the calculated olefinic composition.

TABLE 27

| Hydrogen Atoms | | Peak | | Number of | Quantity of | Concentration |
|---|---|---|---|---|---|---|
| | Olefin | Region | Peak | Hydrogen | Olefin | of Olefin |
| Type No. | Structure | (ppm) | Area | Atoms | (mol) | (mol %) |
| Saturated | N/A | 0.00-2.50 | 1107.9 | | | |
| T1 | CH₂═CH—R¹ | 4.91-5.05 | 1.31 | 2 | 0.655 | 1.26 |
| T2 | CH₂═CR¹R² | 4.49-4.88 | 100.00 | 2 | 50 | 96.4 |
| T3 | CHR¹═CHR² | 5.37-5.55 | 0.44 | 2 | 0.22 | 0.42 |
| T4 | CR¹R²═CHR³ | 5.07-5.29 | 0.99 | 1 | 0.495 | 1.91 |

A ¹H NMR spectrum of the reaction mixture of an oligomerization reaction of the monomer 1-butene using Catalyst A (Example 9) was obtained. Table 28 shows the calculated olefinic composition.

TABLE 28

| Hydrogen Atoms | | Peak | | Number of | Quantity of | Concentration |
|---|---|---|---|---|---|---|
| | Olefin | Region | Peak | Hydrogen | Olefin | of Olefin |
| Type No. | Structure | (ppm) | Area | Atoms | (mol) | (mol %) |
| Saturated | N/A | 0.00-2.2 | 833 | | | |
| T1 | CH₂═CH—R¹ | 4.90-5.08 | 0.79 | 2 | 0.395 | 0.76 |
| T2 | CH₂═CR¹R² | 4.50-4.90 | 100.00 | 2 | 50 | 96.5 |
| T3 | CHR¹═CHR² | 5.35-5.55 | 0.87 | 2 | 0.435 | 0.84 |
| T4 | CR¹R²═CHR³ | 5.08-5.35 | 1.01 | 1 | 1.01 | 1.95 |

A ¹H NMR spectrum of the reaction mixture of an oligomerization reaction of the monomer 1-butene using Catalyst C (Example 10) was obtained. Table 29 shows the calculated olefinic composition.

TABLE 29

| Hydrogen Atoms | | Peak | | Number of | Quantity of | Concentration |
|---|---|---|---|---|---|---|
| | Olefin | Region | Peak | Hydrogen | Olefin | of Olefin |
| Type No. | Structure | (ppm) | Area | Atoms | (mol) | (mol %) |
| Saturated | N/A | 0.00-2.75 | 1104.7 | | | |
| T1 | CH₂═CH—R¹ | 4.89-5.07 | 4.88 | 2 | 2.44 | 4.60% |
| T2 | CH₂═CR¹R² | 4.52-4.88 | 100.00 | 2 | 50.0 | 94.1% |
| T3 | CHR¹═CHR² | 5.35-5.55 | 0.07 | 2 | 0.035 | 0.066% |
| T4 | CR¹R²═CHR³ | 5.07-5.33 | 0.65 | 1 | 0.65 | 1.2% |

A ¹H NMR spectrum of the reaction mixture of an oligomerization reaction of 1-hexene using Catalyst A (Example 11) was obtained. Table 30 shows the calculated olefinic composition.

TABLE 30

| Hydrogen Atoms | | Peak | | Number of | Quantity of | Concentration |
|---|---|---|---|---|---|---|
| | Olefin | Region | Peak | Hydrogen | Olefin | of Olefin |
| Type No. | Structure | (ppm) | Area | Atoms | (mol) | (mol %) |
| Saturated | N/A | 0.00-2.50 | 1247.7 | | | |
| T1 | CH₂═CH—R¹ | 4.88-5.10 | 0.87 | 2 | 0.435 | 0.82 |
| T2 | CH₂═CR¹R² | 4.50-4.88 | 100.00 | 2 | 50 | 94.7 |
| T3 | CHR¹═CHR² | 5.17-5.55 | 2.29 | 2 | 1.145 | 2.17 |
| T4 | CR¹R²═CHR³ | 5.10-5.17 | 1.22 | 1 | 1.22 | 2.31 |

A ¹H NMR spectrum of the reaction mixture of an oligomerization reaction of 1-octene using Catalyst A (Example 12) was obtained. Table 31A shows the calculated olefinic composition.

TABLE 31A

| | | | | Number | | |
|---|---|---|---|---|---|---|
| Hydrogen Atoms | | Peak | | of | Quantity | Concentration |
| | Olefin | Region | Peak | Hydrogen | of Olefin | of Olefin |
| Type No. | Structure | (ppm) | Area | Atoms | (mol) | (mol %) |
| Saturated | N/A | 0.00-2.50 | 1720 | | | |
| T1 | CH₂═CH—R¹ | 4.88-5.10 | 0.50 | 2 | 0.25 | 0.47 |
| T2 | CH₂═CR¹R² | 4.50-4.88 | 100.00 | 2 | 50.0 | 94.3 |
| T3 | CHR¹═CHR² | 5.17-5.55 | 2.38 | 2 | 1.19 | 2.24 |
| T4 | CR¹R²═CHR³ | 5.10-5.17 | 1.61 | 1 | 0.805 | 3.03 |

A ¹H NMR spectrum of the reaction mixture of a co-oligimerization reaction of 1-hexene (25%) and 1-octene (75%) using Catalyst A (Example 13) was obtained. Table 31B shows the calculated olefinic composition.

TABLE 31B

| Hydrogen Atoms | | Peak | | Number of | Quantity of | Concentration |
|---|---|---|---|---|---|---|
| | Olefin | Region | Peak | Hydrogen | Olefin | of Olefin |
| Type No. | Structure | (ppm) | Area | Atoms | (mol) | (mol %) |
| Saturated | N/A | 0.00-2.50 | 1644 | | | |
| T1 | CH₂═CH—R¹ | 4.87-5.08 | 0.52 | 2 | 0.26 | 0.50 |
| T2 | CH₂═CR¹R² | 4.50-4.87 | 100.00 | 2 | 50 | 96.0 |
| T3 | CHR¹═CHR² | 5.16-5.55 | 1.58 | 2 | 0.79 | 1.52 |
| T4 | CR¹R²═CHR³ | 5.08-5.16 | 1.02 | 1 | 1.02 | 1.96 |

A ¹H NMR spectrum of the reaction mixture of a co-oligimerization reaction of 1-hexene (50%) and 1-octene (50%) using Catalyst A (Example 14) was obtained. Table 32 shows the calculated olefinic composition.

TABLE 32

| Hydrogen Atoms | | Peak | | Number of | Quantity of | Concentration |
|---|---|---|---|---|---|---|
| | Olefin | Region | Peak | Hydrogen | Olefin | of Olefin |
| Type No. | Structure | (ppm) | Area | Atoms | (mol) | (mol %) |
| Saturated | N/A | 0.00-2.30 | 1516 | | | |
| T1 | CH₂═CH—R¹ | 4.88-5.10 | 0.77 | 2 | 0.385 | 0.72 |
| T2 | CH₂═CR¹R² | 4.50-4.88 | 100.00 | 2 | 50 | 93.1 |
| T3 | CHR¹═CHR² | 5.16-5.55 | 2.62 | 2 | 1.31 | 2.44 |
| T4 | CR¹R²═CHR³ | 5.10-5.16 | 1.99 | 1 | 1.99 | 3.71 |

A ¹H NMR spectrum of the reaction mixture of a co-oligimerization reaction of 1-hexene (75%) and 1-octene (25%) using Catalyst A (Example 15) was obtained. Table 33 shows the calculated olefinic composition.

TABLE 33

| Hydrogen Atoms | | Peak | | Number of | Quantity of | Concentration |
|---|---|---|---|---|---|---|
| | Olefin | Region | Peak | Hydrogen | Olefin | of Olefin |
| Type No. | Structure | (ppm) | Area | Atoms | (mol) | (mol %) |
| Saturated | N/A | 0.00-2.30 | 1380 | | | |
| T1 | CH₂═CH—R¹ | 4.87-5.09 | 0.23 | 2 | 0.115 | 0.22 |
| T2 | CH₂═CR¹R² | 4.50-4.87 | 100.00 | 2 | 50 | 95.8 |
| T3 | CHR¹═CHR² | 5.16-5.55 | 1.86 | 2 | 0.93 | 1.78 |
| T4 | CR¹R²═CHR³ | 5.09-5.15 | 1.13 | 1 | 1.13 | 2.17 |

A ¹H NMR spectrum of the reaction mixture of a co-oligomerization reaction of C8 and VCH using Catalyst A (Example 16) was obtained.

A ¹H NMR spectrum of the reaction mixture of a co-oligomerization reaction of C9 and VCH using Catalyst A (Example 17) was obtained.

A ¹H NMR spectrum of the reaction mixture of a co-oligomerization reaction of C10 and VCH using Catalyst A (Example 18) was obtained.

A ¹H NMR spectrum of the reaction mixture of an oligomerization reaction of VCH using Catalyst E (Example 18) was obtained.

¹H NMR and ¹³C NMR spectra of the reaction mixture of an oligomerization reaction of VCH using Catalyst A (Example 20) were obtained.

A ¹H NMR spectrum of the reaction mixture of an oligomerization reaction of VCB to but-3-ene-1,3-diyldicyclobutane using Catalyst E (Example 21) was obtained.

¹H NMR and ¹³C NMR spectra of the reaction mixture of a hydrogenation reaction of but-3-ene-1,3-diyldicyclobutane to butane-1,3-diyldicyclobutane (Example 22) were obtained.

A ¹H NMR spectrum of the reaction mixture of an oligomerization reaction of vinylcyclohexane to but-3-ene-1,3-diyldicyclohexane using Catalyst E (Example 23) was obtained.

¹H NMR and ¹³C NMR spectra of the reaction mixture of a hydrogenation reaction of but-3-ene-1,3-diyldicyclohexane to butane-1,3-diyldicyclohexane (Example 24) were obtained.

### Continuous Polymerization Examples

Oligomerizations were carried out in a continuous stirred tank reactor system with two autoclave reactors in series configuration. Both of the reactors were 1 L in volume. The autoclave reactors were equipped with a stirrer, a pressure controller, and a water cooling/steam (or alternatively hot oil heating for polymerization above 130° C.) heating element with a temperature controller. The reactor was operated in liquid fill condition at a reactor pressure in excess of the bubbling point pressure of the reactant mixture, keeping the reactants in liquid phase. Pentene, hexene, or vinylcyclohexene (VCH) was fed either under N₂ head pressure in a holding tank or through a metering pump. All flow rates of liquid were controlled using a Coriolis mass flow controller (Quantim series from Brooks). The mixture was then fed to the reactor through a single line. Scavenger solution was added to the combined monomer stream just before it entered the reactor to further reduce any catalyst poisons. Similarly, catalyst solution was fed to the reactor using an ISCO syringe pump through a separated line. All monomers and solvents were purified over beds of alumina and molecular sieves.

All the monomers (pentene, hexane, and VCH), catalyst solution, and scavenger solution were fed into the first reactor. The content (including oligomers produced and active catalyst) of the first reactor flowed directly into the second reactor. The two reactors were operated under the same temperature. Reactor effluent exited the second reactor through a back pressure control valve that reduced the pressure to atmospheric pressure. This caused some of the unconverted monomers in the solution to flash into a vapor phase which was vented from the top of a vapor liquid separator. The liquid phase, comprising mainly oligomeric products, solvent and unconverted monomers, was collected for product recovery. The collected liquid samples were weighed and reported as liquid collected in the examples listed in Tables 34-38. All the reactions were carried out at a pressure of about 2.4 MPa/g unless otherwise mentioned.

Tri-n-octyl aluminum (TNOA) (25 wt % in hexane, Sigma Aldrich) was used as the scavenger. The scavenger was diluted to a concentration of about 1˜4 micromole/mL in either methylcyclohexane (MCH) or toluene. M2HTH-D4 (Boulder Scientific Company) was used as the activator for all experiments listed in Tables 34-38. Both catalyst and activator were dissolved in either methylcyclohexane or toluene. The catalyst solution and activator solution were fed separately into the reactor unless otherwise mentioned.

The molar ratio of the catalyst feed rate to the activator feed rate was about 1:1. The scavenger feed rate was adjusted to optimize the catalyst efficiency and the feed rate varied from 0 (no scavenger) to 15 μmol/min. The catalyst feed rates may also be adjusted according to the level of impurities in the system to reach the targeted conversions listed.

### Oligomerization of 1-Pentene in a Continuous Reactor

Examples P-1 and P-2 were produced using the general procedure described above using 1-pentene as the monomer. Catalyst A was used as the catalyst. Both catalyst and activator were dissolved in MCH separately. A toluene solution of tri-n-octyl aluminum (TNOA) (25 wt % in hexane, Sigma Aldrich) was used as the scavenger solution. The detailed polymerization process conditions and some product analysis by GC-MS are listed in Table 34A. Tables 34B and 34 C outline the composition of the samples determined by GC-MS.

TABLE 34A

| Example # | P-1 | P-2 |
|---|---|---|
| Temperature (° C.) | 130 | 130 |
| Pentene feed rate(g/min) | 10.70 | 10.70 |
| MCH feed rate (g/min) | 2.31 | 3.08 |
| Toluene feed rate (g/min) | 2.33 | 2.36 |
| Catalyst A feed rate (mol/min) | 1.201E−05 | 1.601E−05 |
| M2HTH-D4 feed rate (mol/min) | 1.225E−05 | 1.634E−05 |
| TNOA feed rate (mol/min) | 7.170E−06 | 7.170E−06 |
| Total liquid feed rate (g/min) | 15.3 | 16.1 |
| Residence time (min) | 89.2 | 85.3 |
| Liquid collected (g/min) | 10.4 | 11.7 |

Product analysis by GC-MS

| | | |
|---|---|---|
| C5-C5 (dimer) (%) | 81.68 | 87.58 |
| C5-C5-C5 (trimer) (%) | 15.71 | 11.54 |
| C5-C5-C5-C5 (tetramer) (%) | 2.60 | 0.88 |

TABLE 34B

| | Retention | | Peak |
|---|---|---|---|
| Identity | Time (min) | Area (a.u.) | Area (%) |
| MCH (solvent) | 1.981 | 1446980 | 5.6 |
| toluene (solvent) | 2.374 | 1067299 | 4.1 |
| nonane | 3.699 | 3258481 | |
| C5-C5 (dimer) | 4.507 | 19029936 | 73.7 |
| C5-C5-C5 (trimer) | 7.644 | 3660917 | 14.2 |
| C5-C5-C5-C5 (tetramer) | 9.771 | 606849 | 2.4 |

| | |
|---|---|
| Total Area | 29070462 |

TABLE 34C

| | Retention | | Peak |
|---|---|---|---|
| Identity | Time (min) | Area (a.u.) | Area (%) |
| MCH (solvent) | 1.981 | 2830135 | 7.8 |
| toluene (solvent) | 2.363 | 2383249 | 6.6 |
| nonane | 3.705 | 4405977 | |
| C5-C5 (dimer) | 4.513 | 27140309 | 75.0 |
| C5-C5-C5 (trimer) | 7.644 | 3577421 | 9.9 |
| C5-C5-C5-C5 (tetramer) | 9.772 | 271694 | 0.8 |

| | |
|---|---|
| Total Area | 40608785 |

### Oligomerization of 1-Hexene in a Continuous Reactor

Hexene oligomers in Examples H-1 to H-3 were produced using the general procedure described above. Catalyst A was used as the catalyst. Both catalyst and activator were dissolved in MCH separately. A MCH solution of tri-n-octyl aluminum (TNOA) (25 wt % in hexane, Sigma Aldrich) was used as the scavenger solution. Examples H-4 to H-6 were produced using the general procedure described above except that a 1 L single oil heated autoclave reactor was used. Toluene was used as the carrying solvent for catalyst, activator, and scavenger. The detailed polymerization process conditions and some product analysis by GC-MS are listed in Table 35.

TABLE 35

| Example # | H-1 | H-2 | H-3 | H-4 | H-5 | H6 |
|---|---|---|---|---|---|---|
| Temperature (° C.) | 130 | 130 | 130 | 140 | 155 | 170 |
| Hexene feed rate | 22.50 | 22.50 | 11.20 | 5.00 | 5.00 | 5.00 |
| (g/min) | | | | | | |
| MCH feed rate | 3.08 | 3.47 | 2.50 | — | — | — |
| (g/min) | | | | | | |
| Toluene feed rate | — | — | — | 4.32 | 4.32 | 4.32 |
| (g/min) | | | | | | |
| Catalyst A feed | 6.005E−06 | 8.007E−06 | 6.005E−06 | 1.201E−05 | 1.201E−05 | 1.201E−05 |
| rate (mol/min) | | | | | | |
| M2HTH-D4 feed | 6.127E−06 | 8.170E−06 | 6.127E−06 | 1.225E−05 | 1.225E−05 | 1.225E−05 |
| rate (mol/min) | | | | | | |
| TNOA feed rate | 3.452E−06 | 3.452E−06 | 3.452E−06 | 5.471E−06 | 5.471E−06 | 5.471E−06 |
| (mol/min) | | | | | | |
| Total liquid feed | 25.6 | 26.0 | 13.7 | 9.3 | 9.3 | 9.3 |
| rate (g/min) | | | | | | |
| Residence time | 53.4 | 52.7 | 100.5 | 80.5 | 80.5 | 80.5 |
| (min) | | | | | | |
| Liquid collected | 11.9 | 16.5 | 9.8 | 10.8 | 10.7 | 10.4 |
| (g/min) | | | | | | |

Product analysis by GC-MS

| | | | | | | |
|---|---|---|---|---|---|---|
| C6—C6 (dimer) | 65.09 | 67.70 | 72.17 | 95.11 | 96.58 | 98.16 |
| (%) | | | | | | |
| C6—C6—C6 | 25.39 | 24.17 | 22.15 | 4.89 | 3.42 | 1.84 |
| (trimer) (%) | | | | | | |
| C6—C6—C6—C6 | 9.52 | 8.13 | 5.67 | — | — | — |
| (tetramer) (%) | | | | | | |

Tables 35A-35C outline the composition of Examples H1-H3, respectively, determined by GC-MS.

TABLE 35A

| | Retention | | Peak |
|---|---|---|---|
| Identity | Time (min) | Area (a.u.) | Area (%) |
| MCH (solvent) | 1.981 | 1044031 | 2.2 |
| nonane | 3.705 | 4974985 | |
| C6-C6 (dimer) | 6.16 | 489640 | 1.0 |
| C6-C6 (dimer) | 6.231 | 29809007 | 62.6 |
| C6-C6-C6 (trimer) | 9.313 | 11816732 | 24.8 |
| C6-C6-C6-C6 (tetramer) | 11.506 | 4431625 | 9.3 |

| | |
|---|---|
| Total Area | 52566018 |

TABLE 35B

| | Retention | | Peak |
|---|---|---|---|
| Identity | Time (min) | Area (a.u.) | Area (%) |
| MCH (solvent) | 1.981 | 2599959 | 4.8 |
| nonane | 3.705 | 5558114 | |
| C6-C6 (dimer) | 6.154 | 638535 | 1.2 |
| C6-C6 (dimer) | 6.223 | 34489240 | 63.3 |
| C6-C6-C6 (trimer) | 9.318 | 12542752 | 23.0 |
| C6-C6-C6-C6 (tetramer) | 11.506 | 4217377 | 7.7 |

| | |
|---|---|
| Total Area | 60045978 |

TABLE 35C

| | Retention | | Peak |
|---|---|---|---|
| Identity | Time (min) | Area (a.u.) | Area (%) |
| MCH (solvent) | 1.981 | 2890284 | 5.5 |
| nonane | 3.705 | 5416355 | |
| C6-C6 (dimer) | 6.154 | 727203 | 1.4 |
| C6-C6 (dimer) | 6.236 | 34893221 | 66.8 |
| C6-C6-C6 (trimer) | 9.313 | 10934123 | 20.9 |
| C6-C6-C6-C6 (tetramer) | 11.506 | 2800345 | 5.4 |

| | |
|---|---|
| Total Area | 57661531 |

Tables 35D-35F outline the composition of Examples H4-H6, respectively, determined by GC-MS.

TABLE 35D

| | Retention | | Peak |
|---|---|---|---|
| Identity | Time (min) | Area (a.u.) | Area (%) |
| MCH (solvent) | 1.976 | 881972 | 1.6 |
| toluene (solvent) | 2.358 | 25945861 | 46.5 |
| nonane | 3.694 | 3946363 | |
| C6-C6 (dimer) | 6.144 | 3653489 | 6.5 |
| C6-C6 (dimer) | 6.215 | 23927399 | 42.9 |
| C6-C6-C6 (trimer) | 9.302 | 1418627 | 2.5 |

| | | |
|---|---|---|
| Total Area | 59773711 | 100 |
| Total Area-nonane area | 55827348 | |

TABLE 35E

| | Retention | | Peak |
|---|---|---|---|
| Identity | Time (min) | Area (a.u.) | Area (%) |
| MCH (solvent) | 1.981 | 758374 | 1.6 |
| toluene (solvent) | 2.358 | 21677397 | 46.2 |
| nonane | 3.694 | 4328046 | |
| C6-C6 (dimer) | 6.144 | 2723246 | 5.8 |
| C6-C6 (dimer) | 6.209 | 20938230 | 44.6 |
| C6-C6-C6 (trimer) | 9.302 | 839127 | 1.8 |

| | |
|---|---|
| Total Area | 51264421 |

TABLE 35F

| | Retention | | Peak |
|---|---|---|---|
| Identity | Time (min) | Area (a.u.) | Area (%) |
| C6 (monomer) | 1.485 | 320317 | 0.9 |
| MCH (solvent) | 1.981 | 552058 | 1.5 |
| toluene (solvent) | 2.358 | 19670293 | 52.2 |
| nonane | 3.7 | 4013895 | |
| C6-C6 (dimer) | 6.144 | 1925287 | 5.1 |
| C6-C6 (dimer) | 6.209 | 14876269 | 39.5 |
| C6-C6-C6 (trimer) | 9.302 | 315754 | 0.8 |

| | |
|---|---|
| Total Area | 41673874 |

### Oligomerization of VCH in a Continuous Reactor

VCH oligomers in Examples V-1 to V-3 were produced using the general procedure described above. Catalyst E was used as the catalyst. MCH was used as the carrying solvent for catalyst, activator and scavenger in Example V-1. Toluene was used as the solvent for both catalyst and activator. Tri-n-octyl aluminum (TNOA) was diluted using MCH for the scavenger solution. For Example V-3, both catalyst and activator were dissolved in MCH separately. A toluene solution of tri-n-octyl aluminum (TNOA) (25 wt % in hexane, Sigma Aldrich) was used as the scavenger solution. The detailed polymerization process conditions and some product analysis by GC-MS are listed in Table 36A.

TABLE 36A

| Example # | V-1 | V-2 | V-3 |
|---|---|---|---|
| Temperature (° C.) | 130 | 130 | 130 |
| VCH feed rate (g/min) | 27.50 | 13.80 | 9.20 |
| MCH feed rate (g/min) | 2.31 | 2.71 | 1.16 |
| Toluene feed rate (g/min) | — | 1.30 | 2.33 |
| Catalyst E feed rate (mol/min) | 4.526E−06 | 6.789E−06 | 7.492E−06 |
| M2HTH-D4 feed rate | 4.618E−06 | 6.927E−06 | 7.645E−06 |
| (mol/min) | | | |
| TNOA feed rate (mol/min) | 3.452E−06 | 4.860E−06 | 7.428E−06 |
| Total liquid feed rate (g/min) | 29.8 | 17.8 | 12.7 |
| Residence time (min) | 55.3 | 92.4 | 107.8 |
| Liquid collected (g/min) | 26.3 | 12.9 | 11.5 |

Product analysis by GC-MS

| | | | |
|---|---|---|---|
| VCH-VCH (dimer) (%) | 100.00 | 100.00 | 92.40 |
| all dimers (%) | 100.00 | 100.00 | 92.40 |
| Unidentified (%) | — | — | 7.6 |

Tables 36B-36D outline the composition of Samples VI-V-3, respectively, determined by GC-MS.

TABLE 36B

| | Retention | | Peak |
|---|---|---|---|
| Identity | Time (min) | Area (a.u.) | Area (%) |
| MCH (solvent) | 1.981 | 5289473 | 10.9 |
| VCH (monomer) | 3.039 | 31899625 | 65.8 |
| nonane | 3.705 | 5336823 | |
| VCH-VCH (dimer) | 9.886 | 10663505 | 22.0 |
| VCH-VCH (dimer) | 10.022 | 625493 | 1.3 |

| | |
|---|---|
| Total Area | 53814919 |

TABLE 36C

| | Retention | | Peak |
|---|---|---|---|
| Identity | Time (min) | Area (a.u.) | Area (%) |
| MCH (solvent) | 1.981 | 3039281 | 4.9 |
| toluene (solvent) | 2.357 | 6654943 | 10.8 |
| VCH (monomer) | 3.034 | 26554212 | 43.0 |
| nonane | 3.705 | 5397950 | |
| VCH-VCH (dimer) | 9.76 | 505652 | 0.8 |
| VCH-VCH (dimer) | 9.826 | 809345 | 1.3 |
| VCH-VCH (dimer) | 9.897 | 21718343 | 35.2 |
| VCH-VCH (dimer) | 10.022 | 1984120 | 3.2 |
| VCH-VCH (dimer) | 10.088 | 452981 | 0.7 |

| | |
|---|---|
| Total Area | 67116828 |

TABLE 36D

| | Retention | | Peak |
|---|---|---|---|
| Identity | Time (min) | Area (a.u.) | Area (%) |
| MCH (solvent) | 1.981 | 3287078 | 4.9 |
| toluene (solvent) | 2.358 | 8390524 | 12.4 |
| VCH (monomer) | 3.018 | 1473316 | 2.2 |
| VCH isom* | 3.323 | 2470946 | 3.7 |
| VCH isom | 3.394 | 1645994 | 2.4 |
| nonane | 3.7 | 3970728 | |
| unk (wide baseline) | 6.237 | 3788534 | 5.6 |
| VCH-VCH (dimer) | 9.766 | 2934077 | 4.4 |
| VCH-VCH (dimer) | 9.826 | 4563438 | 6.8 |
| VCH-VCH (dimer) | 9.897 | 27926005 | 41.4 |
| VCH-VCH (dimer) | 10.006 | 7187892 | 10.7 |
| VCH-VCH (dimer) | 10.093 | 1205607 | 1.8 |
| VCH-VCH (dimer) | 10.153 | 741271 | 1.1 |
| VCH-VCH (dimer) | 10.241 | 1815281 | 2.7 |

| | |
|---|---|
| Total Area | 71400691 |

*isom refers to isomerization of the VCH monomer

### Co-Oligomerization of 1-Pentene and VCH in a Continuous Reactor

Pentene-VCH oligomers in Examples VP-1 to VP-3 were produced using the general procedure described above. Catalyst A was used as the catalyst. MCH was used as the carrying solvent for all catalyst, activator and scavenger. Example VP-4 followed the same procedure used for VP-1 to VP-3 except that no scavenger was used. Example VP-5 followed the same procedure used for VP-1 to VP-3 except that Catalyst B was used and toluene was used as the solvent for tri-n-octyl aluminum in Example VP-5. The detailed polymerization process conditions and some product analysis by GC-MS are listed in Table 37A.

TABLE 37A

| Example # | VP-1 | VP-2 | VP-3 | VP-4 | VP-5 |
|---|---|---|---|---|---|
| Temperature (° C.) | 130 | 130 | 130 | 130 | 130 |
| Pentene feed rate(g/min) | 9.75 | 6.50 | 8.94 | 4.90 | 4.90 |
| VCH feed rate (g/min) | 15.00 | 10.00 | 6.90 | 7.50 | 7.50 |
| MCH feed rate (g/min) | 4.24 | 3.08 | 3.08 | 3.08 | 2.31 |
| Toluene feed rate (g/min) | — | — | — | — | 2.33 |
| Catalyst B feed rate (mol/min) | — | — | — | — | 1.300E−05 |
| Catalyst A feed rate (mol/min) | 1.201E−05 | 1.201E−05 | 1.201E−05 | 1.601E−05 | — |
| M2HTH-D4 feed rate (mol/min) | 1.225E−05 | 1.225E−05 | 1.225E−05 | 1.634E−05 | 1.326E−05 |
| TNOA feed rate (mol/min) | 3.452E−06 | 3.452E−06 | 3.452E−06 | — | 7.170E−06 |
| Total liquid feed rate (g/min) | 29.0 | 19.6 | 18.9 | 15.5 | 17.0 |
| Residence time (min) | 51.5 | 76.3 | 76.1 | 96.6 | 89.3 |
| Liquid collected (g/min) | 21.6 | 14.8 | 11.5 | 12.8 | 13.1 |

Product analysis by GC-MS

| | | | | | |
|---|---|---|---|---|---|
| C5-C5 (dimer) (%) | 34.63 | 26.52 | 35.97 | 14.07 | 11.04 |
| VCH-C5 (dimer) (%) | 51.33 | 61.95 | 47.67 | 71.74 | 72.35 |
| C5-C5-C5 (trimer) (%) | 5.23 | 3.16 | 7.26 | — | — |
| VCH-C5-C5 (trimer) (%) | — | — | — | 1.12 | 2.09 |
| C5-C5-C5-C5 (tetramer) (%) | 0.74 | — | 1.09 | — | — |
| VCH-VCH (dimer) (%) | 8.08 | 8.37 | 8.00 | 13.07 | 14.52 |
| all dimers (%) | 94.03 | 96.84 | 91.64 | 98.88 | 97.91 |
| all trimers (%) | 5.23 | 3.16 | 7.26 | 1.12 | 2.09 |
| all tetramers (%) | 0.74 | — | 1.09 | — | — |

Tables 37B-37D outline the composition of the Examples VP-1. VP-2, and VP-3 determined by GC-MS.

TABLE 37B

| | Retention | | Peak |
|---|---|---|---|
| Identity | Time (min) | Area (a.u.) | Area (%) |
| C5 (monomer) | 1.234 | 749804 | 1.3 |
| MCH (solvent) | 1.975 | 7218799 | 12.3 |
| VCH (monomer) | 3.023 | 19891338 | 33.8 |
| nonane | 3.699 | 5119255 | |
| C5-C5 (dimer) | 4.49 | 10749213 | 18.2 |
| VCH-C5 (dimer) | 7.453 | 15934291 | 27.1 |
| C5-C5-C5 (trimer) | 7.649 | 1622615 | 2.8 |
| C5-C5-C5-C5 (tetramer) | 9.782 | 229992 | 0.4 |
| VCH-VCH (dimer) | 9.886 | 2508439 | 4.3 |

| | |
|---|---|
| Total Area | 64023745 |

TABLE 37C

| | Retention | | Peak |
|---|---|---|---|
| Identity | Time (min) | Area (a.u.) | Area (%) |
| MCH (solvent) | 1.981 | 4985618 | 8.1 |
| VCH (monomer) | 3.023 | 14396434 | 23.5 |
| nonane | 3.705 | 5066908 | |
| C5-C5 (dimer) | 4.496 | 11099847 | 18.1 |
| VCH-C5 (dimer) | 7.458 | 25933539 | 42.3 |
| C5-C5-C5 (trimer) | 7.649 | 1324903 | 2.2 |
| VCH-VCH (dimer) | 9.886 | 3503867 | 5.7 |

| | |
|---|---|
| Total Area | 66311115 |

TABLE 37D

| | Retention | | Peak |
|---|---|---|---|
| Identity | Time (min) | Area (a.u.) | Area (%) |
| C5 (monomer) | 1.234 | 369860 | 0.6 |
| MCH (solvent) | 1.981 | 5281133 | 8.3 |
| VCH (monomer) | 3.023 | 14899152 | 23.5 |
| nonane | 3.705 | 4899567 | |
| C5-C5 (dimer) | 4.496 | 15427160 | 24.3 |
| VCH-C5 (dimer) | 7.453 | 20444696 | 32.2 |
| C5-C5-C5 (trimer) | 7.649 | 3115559 | 4.9 |
| C5-C5-C5-C5 (tetramer) | 9.777 | 467700 | 0.7 |
| VCH-VCH (dimer) | 9.881 | 3429774 | 5.4 |

| | |
|---|---|
| Total Area | 68334601 |

Tables 37E and 37F outline the composition of Samples VP-4 and VP-5 determined by GC-MS.

TABLE 37E

| | Retention | | Peak |
|---|---|---|---|
| Identity | Time (min) | Area (a.u.) | Area (%) |
| MCH (solvent) | 1.981 | 3149116 | 5.4 |
| toluene (solvent) | 2.396 | 503727 | 0.9 |
| VCH (monomer) | 3.017 | 2449540 | 4.2 |
| nonane | 3.705 | 4857411 | |
| C5-C5 (dimer) | 4.49 | 5784108 | 9.9 |
| VCH-C5 (dimer) | 7.409 | 2460179 | 4.2 |
| VCH-C5 (dimer) | 7.469 | 34727379 | 59.4 |
| VCH-C5 (dimer) | 7.567 | 709123 | 1.2 |
| VCH-VCH (dimer) | 9.88 | 7606798 | 13.0 |
| VCH-C5x2 (trimer) | 10.229 | 1095461 | 1.9 |

| | |
|---|---|
| Total Area | 63342842 |

TABLE 37F

| | Retention | | Peak |
|---|---|---|---|
| Identity | Time (min) | Area (a.u.) | Area (%) |
| MCH (solvent) | 1.981 | 2325157 | 5.3 |
| toluene (solvent) | 2.368 | 1701817 | 3.9 |
| VCH (monomer) | 3.017 | 1417304 | 3.3 |
| nonane | 3.699 | 3833804 | |
| C5-C5 (dimer) | 4.485 | 4752246 | 10.9 |
| VCH-C5 (dimer) | 7.409 | 1507081 | 3.5 |
| VCH-C5 (dimer) | 7.458 | 25658940 | 58.9 |
| VCH-C5 (dimer) | 7.567 | 455681 | 1.0 |
| VCH-VCH (dimer) | 9.875 | 5087126 | 11.7 |
| VCH-C5x2 (trimer) | 10.229 | 683473 | 1.6 |

| | |
|---|---|
| Total Area | 47422630 |

### Co-Oligomerization of I-Hexene and VCH in a Continuous Reactor

Hexene-VCH oligomers in Examples VH-1 to VH-2 were produced using the general procedure described above. Catalyst A was used as the catalyst. MCH was used as the solvent for catalyst and activator. Toluene was used as the carrying solvent for the scavenger. Hexene-VCH oligomers in Examples VH-3 to VH-4 were produced using the general procedure described above except that a 1-liter single oil heated autoclave reactor was used. Catalyst A was used as the catalyst. Toluene was used for all catalyst, activator and scavenger. The detailed polymerization process conditions and some product analysis by GC-MS are listed in Table 38A.

TABLE 38A

| Example # | VH-1 | VH-2 | VH-3 | VH-4 |
|---|---|---|---|---|
| Temperature (° C.) | 130 | 130 | 140 | 155 |
| Hexene feed rate (g/min) | 7.00 | 7.00 | 2.24 | 2.24 |
| VCH feed rate (g/min) | 9.00 | 9.00 | 2.76 | 2.76 |
| MCH feed rate (g/min) | 2.31 | 3.08 | — | — |
| Toluene feed rate (g/min) | 2.33 | 1.38 | 4.32 | 4.32 |
| Catalyst A feed rate (mol/min) | 1.201E−05 | 1.601E−05 | 1.201E−05 | 1.201E−05 |
| M2HTH-D4 feed rate (mol/min) | 1.225E−05 | 1.634E−05 | 1.225E−05 | 1.225E−05 |
| TNOA feed rate (mol/min) | 7.428E−06 | 4.249E−06 | 5.471E−06 | 5.471E−06 |
| Total liquid feed rate (g/min) | 20.6 | 20.5 | 9.3 | 9.3 |
| Residence time (min) | 74.2 | 74.5 | 85.8 | 85.8 |
| Liquid collected (g/min) | 18.2 | 17.4 | 10.7 | 10.5 |

Product analysis by GC-MS

| | | | | |
|---|---|---|---|---|
| VCH-VCH (dimer) (%) | 3.03 | 14.49 | 3.43 | 3.22 |
| C6-C6 (dimer) (%) | 25.74 | 11.96 | 22.98 | 20.58 |
| VCH-C6 (dimer) (%) | 62.19 | 72.09 | 71.10 | 76.21 |
| C6-C6-C6 (trimer) (%) | 3.64 | — | 1.28 | — |
| VCH-C6-C6 (trimer) (%) | 5.40 | 1.47 | 1.20 | — |
| all dimers (%) | 90.96 | 98.53 | 97.51 | 100.00 |
| all trimers (%) | 9.04 | 1.47 | 2.49 | — |

Tables 38B and 38C outline the composition of the Examples VH-1 and VH-2 determined by GC-MS.

TABLE 38B

| | Retention | | Peak |
|---|---|---|---|
| Identity | Time (min) | Area (a.u.) | Area (%) |
| MCH (solvent) | 1.981 | 836671 | 1.5 |
| toluene (solvent) | 2.363 | 2278490 | 4.0 |
| VCH (monomer) | 3.012 | 5740392 | 10.2 |
| nonane | 3.699 | 5002545 | |
| C6-C6 (dimer) | 6.209 | 12205636 | 21.7 |
| VCH-C6 (dimer) | 8.02 | 554907 | 1.0 |
| VCH-C6 (dimer) | 8.113 | 28933055 | 51.4 |
| C6-C6-C6 (trimer) | 9.302 | 1724539 | 3.1 |
| VCH-VCH (dimer) | 9.88 | 1435390 | 2.6 |
| VCH-C6x2 (trimer) | 10.829 | 2561002 | 4.6 |

| | |
|---|---|
| Total Area | 61272627 |

TABLE 38C

| | Retention | | Peak |
|---|---|---|---|
| Identity | Time (min) | Area (a.u.) | Area (%) |
| MCH (solvent) | 1.981 | 1539066 | 3.2 |
| toluene (solvent) | 2.357 | 4013837 | 8.2 |
| VCH (monomer) | 3.012 | 2606113 | 5.3 |
| nonane | 3.699 | 3746937 | |
| C6-C6 (dimer) | 6.149 | 291754 | 0.6 |
| C6-C6 (dimer) | 6.203 | 6321852 | 13.0 |
| VCH-C6 (dimer) | 8.02 | 1355980 | 2.8 |
| VCH-C6 (dimer) | 8.113 | 27291552 | 55.9 |
| VCH-VCH (dimer) | 9.88 | 4422730 | 9.1 |
| VCH-C6x2 (trimer) | 10.829 | 942579 | 1.9 |

| | |
|---|---|
| Total Area | 52532399 |

Tables 38D and 38E outline the composition of the Examples VH-3 and VH-4 determined by GC-MS.

TABLE 38D

| | Retention | | Peak |
|---|---|---|---|
| Identity | Time (min) | Area (a.u.) | Area (%) |
| MCH (solvent) | 1.981 | 599370 | 1.2 |
| toluene (solvent) | 2.358 | 20538126 | 40.0 |
| VCH (monomer) | 3.012 | 1934397 | 3.8 |
| nonane | 3.694 | 4957845 | |
| C6-C6 (dimer) | 6.144 | 408270 | 0.8 |
| C6-C6 (dimer) | 6.198 | 6081631 | 11.9 |
| VCH-C6 (dimer) | 8.015 | 1093236 | 2.1 |
| VCH-C6 (dimer) | 8.097 | 18981394 | 37.0 |
| C6-C6-C6 (trimer) | 9.302 | 362676 | 0.7 |
| VCH-VCH (dimer) | 9.875 | 969439 | 1.9 |
| VCH-C6x2 (trimer) | 10.824 | 339205 | 0.7 |

| | |
|---|---|
| Total Area | 56265588 |

TABLE 38E

| | Retention | | Peak |
|---|---|---|---|
| Identity | Time (min) | Area (a.u.) | Area (%) |
| MCH (solvent) | 1.981 | 657467 | 1.3 |
| toluene (solvent) | 2.358 | 21826176 | 43.6 |
| VCH (monomer) | 3.018 | 2946833 | 5.9 |
| nonane | 3.7 | 4551181 | |
| C6-C6 (dimer) | 6.149 | 295970 | 0.6 |
| C6-C6 (dimer) | 6.204 | 4769028 | 9.5 |
| VCH-C6 (dimer) | 8.02 | 1012824 | 2.0 |
| VCH-C6 (dimer) | 8.097 | 17744312 | 35.5 |
| VCH-VCH (dimer) | 9.875 | 791332 | 1.6 |

| | |
|---|---|
| Total Area | 54595123 |

### Small Scale Oligomerizations of VCH

Solvents, polymerization grade toluene and/or isohexanes were supplied by ExxonMobil Chemical Co. and were purified by passing through a series of columns: two 500 cc Oxyclear cylinders in series from Labclear (Oakland, Calif.), followed by two 500 cc columns in series packed with dried 3 Å molecular sieves (8-12 mesh: Aldrich Chemical Company), and two 500 cc columns in series packed with dried 5 Å molecular sieves (8-12 mesh: Aldrich Chemical Company). 4-Vinylcyclohexene was purified as previously described.

All complexes and the activators were added to the reactor as dilute solutions in isohexane. Pre-catalyst solutions were 8.0 mmol/L in isohexane. Scavengers, tri-n-octylaluminum (TNOA) and triisobutylaluminum (TIBA) were purchased from Akzo Nobel (now Nouryon) as neat reagents. Scavengers were diluted and used as 0.100 mol/L solutions in isohexane. The activator, M2HTH-D4, was purchased from Boulder Chemical Company as 10 wt % solution in methylcyclohexane. This solution was further diluted with isohexane to make a 5.0 wt % solution.

Reactor Description and Preparation. Polymerizations were conducted in an inert atmosphere (N₂) drybox using autoclaves equipped with an external heater for temperature control, glass inserts (internal volume of reactor=23.5 mL), septum inlets, regulated supply of nitrogen, and equipped with disposable polyether ether ketone mechanical stirrers (800 RPM). The autoclaves were prepared by purging with dry nitrogen at 110° C. or 115° C. for 5 hours and then at 25° C. for 5 hours.

For VCH oligomerization runs, the reactor was prepared as described above. Isohexane (enough to eventually bring the total solution volume to 5.0 ml), and VCH (1.0 ml) was added via syringe at room temperature and atmospheric pressure. The reactor was then brought to process temperature (110° C.). Next, the stirrers where set to 800 RPM and the cells were pressurized to 80 PSI with N2. Scavenger solution (e.g., TNOA or TIBA) was then added via syringe to the reactor at process conditions. Exact amounts added are listed in Table 41 below. Activator solution was added via syringe to the reactor at process conditions, followed by the pre-catalyst solution via syringe to the reactor at process conditions. Reactor temperature was monitored and typically maintained within +/−1° C. Polymerizations were halted after 120 minutes of reaction time by the addition of approximately 50 psi of ultra air gas to the autoclaves for approximately 30 seconds. The reactors were then cooled and vented. For some experiments, 200 μl of the product solution was removed, prior to removing solvent, unreacted monomer and other volatiles. The final product was isolated after the solvent, unreacted monomers, and other volatiles were removed in vacuo. Yields reported include total weight of the non-volatile product and residual catalyst. Catalyst activity is reported as grams of product per mmol transition metal compound per hour of reaction time (g/mmol·h) and is based on the weight of the isolated product. For samples having 200 μl of the product solution removed for GC-MS analysis, product weights and activity reported are not corrected for the removal of the material (Examples 50-55, 62-67, 74-79, and 86-91). Solution aliquots (200 μl) removed were diluted with 500 μl toluene for GC-MS analysis. Oligomerization results are reported in Table 41. Examples 50-73 are inventive and use catalyst A. Examples 74-97 are comparative and use comparative catalyst F.

GC-MS analysis of samples followed the protocol earlier described. GC-MS calculations reported in Table 41, are as follows:
The percent monomer conversion to dimer and trimer was calculated as the sum of the area for all dimer and trimer peaks times 100, then divided by the sum of the area of all non-solvent peaks and excluding product unknown peaks (if present). This is reported as VCH conversion (%) in Table 41.

The percent of unreacted VCH is calculated at 100 minus the percent monomer conversion to dimer and trimer. This value includes VCH that has been isomerized, hydrogenated and/or dehydrogenated. This value is reported as unreacted VCH (%) in Table 41.

The percent monomer conversion to all dimer products was calculated as the sum of the area for all dimer peaks times 100, then divided by the sum of the area all non-solvent peaks and excluding product unknown peaks (if present). This value is reported as VCH conversion to dimer (%) in Table 41.

The percent monomer conversion to a single dimer (dimer isomer with greatest peak area) was calculated as the area of the largest dimer peak times 100, then divided by the sum of the area of all non-solvent peaks and excluding product unknown peaks (if present). This value is reported as VCH conversion to single cyclic dimer species (%) in Table 41.

The percent selectivity to form dimer vs. trimer was calculated as the sum of the area for all dimer peaks times 100, then divided by the sum of the area of all dimer and trimer peaks. This value is reported as dimer (%) in Table 41.

The percent selectivity to form trimer vs. dimer was calculated as the sum of the area for all trimer peaks times 100, then divided by the sum of the area of all dimer and trimer peaks. This value is reported as trimer (%) in Table 41.

The percent selectivity to form one dimer species (one isomer) based on the total dimer formed was calculated as the sum of the area of the largest dimer peak times 100, then divided by the sum of the area of all dimer peaks. This value is reported as selectivity for a single cyclic dimer species (%).

TABLE 41
Small scale oligomerization of VCH
General reaction conditions include 1.4 μmol pre-catalyst, 1.1 equiv. M2HTH-D4 activator, 1.00 ml VCH, 22 μL methylcyclohexane
(partial diluent for activator solution), varying amounts of TNOA or TiBA scavenger as indicated in the table below, ~4.0 mL isohexane
added, total liquid reactor volume of 5.0 ml, 110° C. reactor temperature, and 120 minutes of reaction time. Abreviation in the table
below: Ex# is the example number; “Scav” refers to scavenger and identifies the type and amount; Al/M is that aluminum (from the
scavenger) to pre-catalyst molar ratio; yield is the amount of oligomer isolated as described above.

| | | | | | | | | | | VCH | | | selectivity |
|---|---|---|---|---|---|---|---|---|---|---|---|---|---|
| | | | | | | | | | | conversion | | | for a |
| | | | | | | | | | | to single | | | single |
| | | | | | | | | un- | VCH | cyclic | | | cyclic |
| | | | | | | Activity | VCH | reacted | conversion | dimer | | | dimer |
| | Pre- | | Scav | | yield | (g/ | conversion | VCH | to dimer | species | dimer | trimer | species |
| Ex# | catalyst | Scav | (μmol) | Al/M | (g) | mmol · h) | (%) | (%) | (%) | (%) | (%) | (%) | (%) |
| 50 | A | TIBA | 2.5 | 1.8 | 0.2039 | 73 | 63.6 | 36.4 | 63.6 | 62.7 | 100.0 | 0.0 | 98.6 |
| 51 | A | TIBA | 5 | 3.6 | 0.2307 | 82 | 66.1 | 33.9 | 66.1 | 65.3 | 100.0 | 0.0 | 98.7 |
| 52 | A | TIBA | 10 | 7.1 | 0.2352 | 84 | 65.5 | 34.5 | 65.5 | 64.7 | 100.0 | 0.0 | 98.7 |
| 53 | A | TIBA | 20 | 14.3 | 0.2154 | 77 | 64.5 | 35.5 | 64.5 | 63.5 | 100.0 | 0.0 | 98.4 |
| 54 | A | TIBA | 30 | 21.4 | 0.2144 | 77 | 60.1 | 39.9 | 60.1 | 59.3 | 100.0 | 0.0 | 98.8 |
| 55 | A | TIBA | 40 | 28.6 | 0.2152 | 77 | 60.8 | 39.2 | 60.8 | 59.6 | 100.0 | 0.0 | 98.1 |
| 56 | A | TIBA | 2.5 | 1.8 | 0.2819 | 101 | | | | | | | |
| 57 | A | TIBA | 5 | 3.6 | 0.2919 | 104 | | | | | | | |
| 58 | A | TIBA | 10 | 7.1 | 0.2892 | 103 | | | | | | | |
| 59 | A | TIBA | 20 | 14.3 | 0.2022 | 72 | | | | | | | |
| 60 | A | TIBA | 30 | 21.4 | 0.2645 | 94 | | | | | | | |
| 61 | A | TIBA | 40 | 28.6 | 0.2549 | 91 | | | | | | | |
| 62 | A | TNOA | 2.5 | 1.8 | 0.2550 | 91 | 62.0 | 38.0 | 62.0 | 60.9 | 100.0 | 0.0 | 98.3 |
| 63 | A | TNOA | 5 | 3.6 | 0.2032 | 73 | 62.6 | 37.4 | 62.6 | 61.5 | 100.0 | 0.0 | 98.3 |
| 64 | A | TNOA | 10 | 7.1 | 0.1490 | 53 | 48.1 | 51.9 | 48.1 | 47.4 | 100.0 | 0.0 | 98.5 |
| 65 | A | TNOA | 20 | 14.3 | 0.0696 | 25 | 36.1 | 63.9 | 36.1 | 34.0 | 100.0 | 0.0 | 94.2 |
| 66 | A | TNOA | 30 | 21.4 | 0.0481 | 17 | 29.7 | 70.3 | 29..7 | 26.2 | 100.0 | 0.0 | 88.5 |
| 67 | A | TNOA | 40 | 28.6 | 0.0447 | 16 | 23.7 | 76.3 | 30.1 | 20.5 | 100.0 | 0.0 | 86.4 |
| 68 | A | TNOA | 2.5 | 1.8 | 0.3037 | 108 | | | | | | | |
| 69 | A | TNOA | 5 | 3.6 | 0.2381 | 85 | | | | | | | |
| 70 | A | TNOA | 10 | 7.1 | 0.1791 | 64 | | | | | | | |
| 71 | A | TNOA | 20 | 14.3 | 0.1015 | 36 | | | | | | | |
| 72 | A | TNOA | 30 | 21.4 | 0.0680 | 24 | | | | | | | |
| 73 | A | TNOA | 40 | 28.6 | 0.0579 | 21 | | | | | | | |
| 74 | F | TIBA | 2.5 | 1.8 | 0.0481 | 17 | 12.2 | 87.8 | 8.0 | 8.0 | 65.7 | 34.3 | 100.0 |
| 75 | F | TIBA | 5 | 3.6 | 0.0821 | 29 | 20.8 | 79.2 | 15.1 | 15.1 | 72.8 | 27.2 | 100.0 |
| 76 | F | TIBA | 10 | 7.1 | 0.0947 | 34 | 27.0 | 73.0 | 20.0 | 16.5 | 74.2 | 25.8 | 82.3 |
| 77 | F | TIBA | 20 | 14.3 | 0.1150 | 41 | 34.8 | 65.2 | 20.9 | 16.6 | 60.2 | 39.8 | 79.1 |
| 78 | F | TIBA | 30 | 21.4 | 0.1361 | 49 | 31.3 | 68.7 | 23.6 | 17.8 | 75.4 | 24.6 | 75.3 |
| 79 | F | TIBA | 40 | 28.6 | 0.1502 | 54 | 38.5 | 61.5 | 30.2 | 22.8 | 78.5 | 21.5 | 75.6 |
| 80 | F | TIBA | 2.5 | 1.8 | 0.0569 | 20 | | | | | | | |
| 81 | F | TIBA | 5 | 3.6 | 0.0991 | 35 | | | | | | | |
| 82 | F | TIBA | 10 | 7.1 | 0.1206 | 43 | | | | | | | |
| 83 | F | TIBA | 20 | 14.3 | 0.1421 | 51 | | | | | | | |
| 84 | F | TIBA | 30 | 21.4 | 0.1794 | 64 | | | | | | | |
| 85 | F | TIBA | 40 | 28.6 | 0.2013 | 72 | | | | | | | |
| 86 | F | TNOA | 2.5 | 1.8 | 0.0528 | 19 | 13.6 | 86.4 | 13.6 | 13.6 | 100.0 | 0.0 | 100.0 |
| 87 | F | TNOA | 5 | 3.6 | 0.0860 | 31 | 33.3 | 66.7 | 27.3 | 20.9 | 81.9 | 18.1 | 76.5 |
| 88 | F | TNOA | 10 | 7.1 | 0.1118 | 40 | 30.2 | 69.8 | 24.5 | 19.2 | 81.2 | 18.8 | 78.2 |
| 89 | F | TNOA | 20 | 14.3 | 0.1485 | 53 | 39.7 | 60.3 | 33.0 | 23.1 | 83.1 | 16.9 | 64.1 |
| 90 | F | TNOA | 30 | 21.4 | 0.1745 | 62 | 49.6 | 50.4 | 40.2 | 26.1 | 81.0 | 19.0 | 65.0 |
| 91 | F | TNOA | 40 | 28.6 | 0.1792 | 64 | 46.1 | 53.9 | 39.5 | 26.7 | 85.7 | 14.3 | 67.6 |
| 92 | F | TNOA | 2.5 | 1.8 | * | 0 | | | | | | | |
| 93 | F | TNOA | 5 | 3.6 | 0.0968 | 35 | | | | | | | |
| 94 | F | TNOA | 10 | 7.1 | 0.1325 | 47 | | | | | | | |
| 95 | F | TNOA | 20 | 14.3 | 0.1717 | 61 | | | | | | | |
| 96 | F | TNOA | 30 | 21.4 | 0.2096 | 75 | | | | | | | |
| 97 | F | TNOA | 40 | 28.6 | 0.2178 | 78 | | | | | | | |

* Vial broke prior to weighing

Table 41 shows that the selectivity for dimer over trimer is 100% for inventive catalyst A while typically below 90% for comparative catalyst F. Additionally, conversion of VCH to product is greater than 60% for catalyst A when TIBA is used as the scavenger or when lover levels of TNOA are used as the scavenger. For comparative catalyst F, higher level of TNOA or TIBA are required for higher VCH conversion to product and conversion never exceeds 50%. While catalyst A produces higher yield and activity at lower scavenger levels, the opposite is true for catalyst F. At the lower scavenger levels, catalyst A has selectivity for a single dimer product of around 98%, and is only lower when higher levels of TNOA are used. Similarly, catalyst F requires lower scavenger levels to achieve higher selectivity for one dimer product, but at the same time, yield and catalyst activity are substantially decreased, and in most cases, more trimer is also produced. Overall, in some non-limiting embodiments, there may be one or more benefits in using catalyst A over catalyst F including, e.g., needing to use less scavenger while achieving better selectivity for dimer vs. trimer, and overall higher yields and catalyst activity.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

1. A process for producing a poly alpha-olefin (PAO) from two or more different alpha-olefins, the process comprising:
contacting a feed comprising one or more C₆-C₃₂ cyclic alpha-olefins and one or more C₄-C₃₂ linear and/or branched alpha-olefins with a catalyst system comprising a metallocene compound in a polymerization reactor under polymerization conditions to effect a polymerization reaction to obtain a polymerization reaction mixture, the polymerization reaction mixture comprising a mixture of PAOs (e.g., PAO molecules) having vinylidenes, tri-substituted vinylenes, di-substituted vinylenes and optionally vinyl unsaturation, and
obtaining an unsaturated PAO product from the polymerization reaction mixture.

2. The process of claim 1, wherein the unsaturated PAO product comprises a mixture of PAO molecules having vinylidenes, tri-substituted vinylenes, di-substituted vinylenes, and optionally vinyl unsaturation, and, optionally, is substantially free of the alpha-olefin feed.

3. The process of claim 1, wherein one of the one or more C₆-C₃₂ cyclic alpha-olefins comprises a ring unsaturation, and the unsaturated PAO product further comprises cyclic di-substituted vinylenes.

4. The process of claim 1, wherein the unsaturated PAO product comprises dimer and/or trimer molecules having vinylidenes, tri-substituted vinylenes, di-substituted vinylenes and optionally vinyl unsaturation.

5-14. (canceled)

15. The process of claim 1, wherein the one or more cyclic C₆-C₃₂ alpha-olefins are selected from vinylcyclobutane, vinylcyclopentane, vinylcyclohexane, 4-vinylcyclohex-1-ene, vinylcycloheptane, vinylcyclooctane, vinylcyclononane, vinylcyclodecane, vinylcycloundecane, vinylcyclododecane, 5-vinylnorbornane, 5-vinyl-2-norbornene, allylcyclohexane, and allylcyclooctane.

16. The process of claim 15, wherein the one or more cyclic C₆-C₃₂ alpha-olefins are selected from vinylcyclobutane, vinylcyclopentane, vinylcyclohexane, and 4-vinylcyclohex-1-ene.

17. The process of claim 1, wherein the one or more C₄-C₃₂ linear and/or branched alpha-olefins are selected from 1-butene, 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, 1-heneicosene, 1-docosene, 1-tricosene, 1-tetracosene, 1-pentacosene, 1-hexacosene, 1-heptacosene, 1-octacosene, 1-nonacosene, 1-triacontene, 4-methyl-1-pentene, 3-methyl-1-pentene, 5-methyl-1-nonene, and 3,5,5-trimethyl-1-hexene.

18. The process of claim 17, wherein the one or more C₄-C₃₂ linear and/or branched alpha-olefins are selected from 1-butene, 1-pentene, 1-hexene, 1-heptene, 1-octene, 1-nonene, 1-decene, 4-methyl-1-pentene, 3-methyl-1-pentene, 5-methyl-1-nonene, and 3,5,5-trimethyl-1-hexene.

19. The process of claim 1, wherein the one or more C₄-C₃₂ linear alpha-olefins comprise C₄-C₂₀ linear alpha-olefins, C₄-C₁₂ linear alpha-olefins, C₄-C₈ linear alpha-olefins, C₅-C₈ linear alpha olefins, or C₅-C₆ linear alpha olefins, wherein the one or more C₄-C₃₂ branched alpha-olefins comprise C₅-C₂₀ branched alpha-olefins, C₅-C₁₂ branched alpha-olefins, C₅-C₁₀ branched alpha-olefins, C₆-C₉ branched alpha olefins, or C₆-C₈ branched alpha olefins, and wherein the one or more C₆-C₃₂ cyclic alpha-olefins comprise C₆-C₂₀ cyclic alpha-olefins, C₆-C₁₄ cyclic alpha-olefins, or C₈-C₁₂ cyclic alpha-olefins.

20-41. (canceled)

42. The process of claim 1, wherein the metallocene compound is represented by formula (I): 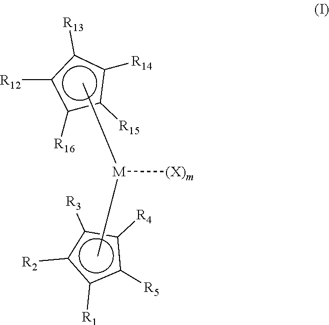
wherein:
R¹, R², and R³ are each independently hydrogen or a substituted or unsubstituted linear, branched, or cyclic C₁-C₂₀ hydrocarbyl or silylcarbyl group;
R⁴ and R⁵ are each independently a substituted or unsubstituted linear, branched, or cyclic C₁-C₃₀ hydrocarbyl or silylcarbyl group where R⁴ and R⁵, taken together with the carbon atoms in the first cyclopentadienyl ring to which they are directly connected, collectively form one or more substituted or unsubstituted rings annelated to the first cyclopentadienyl ring;
R¹², R¹³, R¹⁴, R¹⁵, and R¹⁶ are each independently a hydrogen or a substituted or unsubstituted linear, branched, or cyclic C₁-C₂₀ hydrocarbyl, silylcarbyl, or germanyl group, and at least four of R¹², R¹³, R¹⁴, R¹⁵, and R¹⁶ are not hydrogen;
M is a Group 3, 4, or 5 transition metal having an integer coordination number of v, wherein v is 3, 4, or 5;
each X is independently a halogen, a hydride, an amide, an alkoxide, a sulfide, a phosphide, a diene, an amine, a phosphine, an ether, or a C₁-C₂₀ substituted or unsubstituted linear, branched, or cyclic hydrocarbyl group, or optionally two or more X moieties may together form a fused ring or ring system; and
m is an integer equal to v-2.

43. The process of claim 1, wherein the metallocene compound is represented by formula (II): 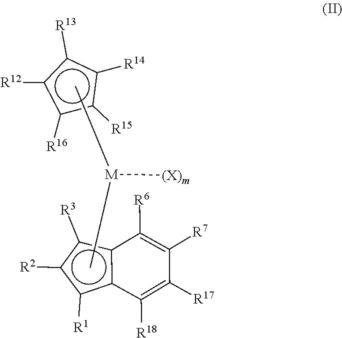
wherein:
R¹, R², and R³ are each independently hydrogen or a substituted or unsubstituted linear, branched, or cyclic C₁-C₂₀ hydrocarbyl group;
R⁶, R⁷, R¹⁷, and R¹⁸ are each independently hydrogen, a substituted or unsubstituted linear, branched, or a cyclic C₁-C₃₀ hydrocarbyl group, or R⁶ and R⁷, R⁷ and R¹⁷, or R¹⁷ and R¹⁸ taken together with the carbon atoms in the indenyl ring to which they are directly connected, collectively form one or more substituted or unsubstituted rings annelated to the indenyl ring;
R¹², R¹³, R¹⁴, and R¹⁵ are each independently a substituted or unsubstituted linear, branched, or cyclic C₁-C₂₀ hydrocarbyl group;
R¹⁶ is hydrogen or a substituted or unsubstituted linear, branched, or cyclic C₁-C₂₀ hydrocarbyl group or silylcarbyl group;
each X is independently a halogen, a hydride, an amide, an alkoxide, a sulfide, a phosphide, a diene, an amine, a phosphine, an ether, a C₁-C₂₀ substituted or unsubstituted linear, branched, or cyclic hydrocarbyl group, or two or more X moieties together form a fused ring or ring system;
M is a Group 3, 4, or 5 transition metal having an integer coordination number of v, wherein v is 3, 4, or 5; and
m is an integer equal to v-2.

44. The process of claim 1, wherein the metallocene compound is represented by formula (III): 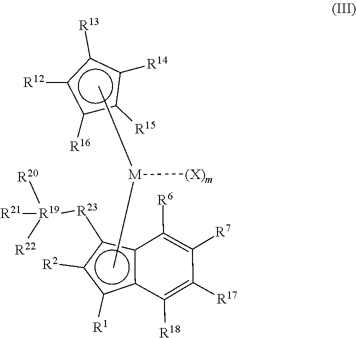
wherein:
R¹ and R² are hydrogen;
R²³ and R¹⁹ comprise, independently, Group 14 atoms, such as C, Ge, or Si (e.g., R²³ includes C and R¹⁹ includes C or Si);
R²⁰, R²¹, and R²² are independently hydrogen or a substituted or unsubstituted linear, branched, or cyclic C₁-C₂₀ hydrocarbyl group and at least two of R²⁰, R²¹, and R²² are independently a substituted or unsubstituted linear, branched, or cyclic C₁-C₂₀ hydrocarbyl group;
R⁶, R⁷, R¹⁷, and R¹⁸ are each independently hydrogen, a substituted or unsubstituted linear, branched, or cyclic C₁-C₃₀ hydrocarbyl group, or R⁶ and R⁷, R⁷ and R¹⁷, or R¹⁷ and R¹⁸, taken together with the carbon atoms in the indenyl ring to which they are directly connected, collectively form one or more substituted or unsubstituted rings annelated to the indenyl ring;
R¹², R¹³, R¹⁴, R¹⁵, and R¹⁶ are each independently a substituted or unsubstituted linear, branched, or cyclic C₁-C₂₀ hydrocarbyl group;
each X is independently a halogen, a hydride, an amide, an alkoxide, a sulfide, a phosphide, a diene, an amine, a phosphine, an ether, or a C₁-C₂₀ substituted or unsubstituted linear, branched, or cyclic hydrocarbyl group, or two or more X moieties together form a fused ring or ring system;
M is a Group 3, 4, or 5 transition metal having an integer coordination number of v, wherein v is 3, 4 or 5; and
m is an integer equal to v-2.

45. The process of claim 1, wherein the metallocene compound is represented by formula (IV): 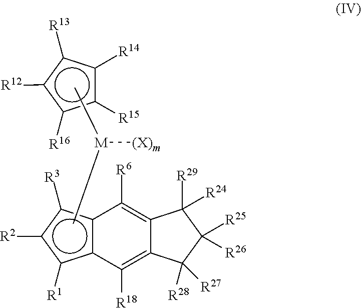
wherein:
R¹ and R² are hydrogen;
R³ is a substituted or unsubstituted linear, branched, or cyclic C₁-C₂₀ hydrocarbyl group;
R⁶ and R¹⁸ are each independently hydrogen, or a substituted or unsubstituted linear, branched, or cyclic C₁-C₃₀ hydrocarbyl group;
R²⁴, R²⁵, R²⁶, R²⁷, R²⁸, and R²⁹ are each independently hydrogen, or a substituted or unsubstituted linear, branched, or cyclic C₁-C₈ hydrocarbyl group;
R¹², R¹³, R¹⁴, R¹⁵, and R¹⁶ are each independently a substituted or unsubstituted linear, branched, or cyclic C₁-C₂₀ hydrocarbyl group;
each X is independently a halogen, a hydride, an amide, an alkoxide, a sulfide, a phosphide, a diene, an amine, a phosphine, an ether, or a C₁-C₂₀ substituted or unsubstituted linear, branched, or cyclic hydrocarbyl group, or two or more X moieties together form a fused ring or ring system;
M is a Group 3, 4, or 5 transition metal having an integer coordination number of v, wherein v is 3, 4 or 5; and
m is an integer equal to v-2.

46. The process of claim 1, wherein the metallocene compound is represented by formula (V): 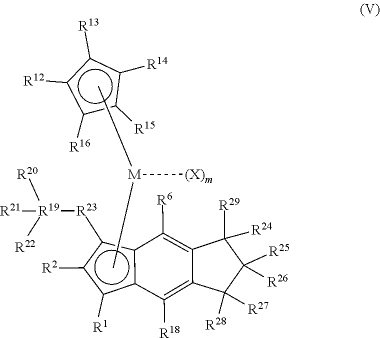
wherein:
R¹ and R² are hydrogen;
R²³ and R¹⁹ comprise, independently, C, Ge, or Si (e.g., R²³ includes C; and R¹⁹ includes C or Si);
R²⁰, R²¹, and R²² are each independently hydrogen or a substituted or unsubstituted linear, branched, or cyclic C₁-C₂₀ hydrocarbyl group and at least two of R²⁰, R²¹, and R²² are independently a substituted or unsubstituted linear, branched, or cyclic C₁-C₂₀ hydrocarbyl group;
R⁶ and R¹⁸ are each independently hydrogen, or a substituted or unsubstituted linear, branched, or cyclic C₁-C₃₀ hydrocarbyl group;
R²⁴, R²⁵, R²⁶, R²⁷, R²⁸, and R²⁹ are each independently hydrogen, or a substituted or unsubstituted linear, branched, or cyclic C₁-C₈ hydrocarbyl group;
R¹², R¹³, R¹⁴, R¹⁵, and R¹⁶ are each independently a substituted or unsubstituted linear, branched, or cyclic C₁-C₂₀ hydrocarbyl group;
each X is independently a halogen, a hydride, an amide, an alkoxide, a sulfide, a phosphide, a diene, an amine, a phosphine, an ether, or a C₁-C₂₀ substituted or unsubstituted linear, branched, or cyclic hydrocarbyl group, or two or more X moieties together form a fused ring or ring system;
M is a Group 3, 4, or 5 transition metal having an integer coordination number of v, wherein v is 3, 4 or 5; and
m is an integer equal to v-2.

47-48. (canceled)

49. The process of claim 1, wherein the metallocene compound is selected from:
(pentamethylcyclopentadienyl)(1-methyl-1,5,6,7-tetrahydro-s-indacenyl)hafnium dimethyl,
(pentamethylcyclopentadienyl)(1-ethyl-1,5,6,7-tetrahydro-s-indacenyl)hafnium dimethyl,
(pentamethylcyclopentadienyl)(1-n-propyl-1,5,6,7-tetrahydro-s-indacenyl)hafnium dimethyl,
(pentamethylcyclopentadienyl)(1-isopropyl-1,5,6,7-tetrahydro-s-indacenyl)hafnium dimethyl,
(pentamethylcyclopentadienyl)(1-n-butyl-1,5,6,7-tetrahydro-s-indacenyl)hafnium dimethyl,
(pentamethylcyclopentadienyl)(1-isobutyl-1,5,6,7-tetrahydro-s-indacenyl)hafnium dimethyl,
(pentamethylcyclopentadienyl)(1,6,6-trimethyl-1,5,6,7-tetrahydro-s-indacenyl)hafnium dimethyl,
(pentamethylcyclopentadienyl)(1-isobutyl-6,6-dimethyl-1,5,6,7-tetrahydro-s-indacenyl)hafnium dimethyl,
(pentamethylcyclopentadienyl)(1-methyl-6,6-diethyl-1,5,6,7-tetrahydro-s-indacenyl)hafnium dimethyl,
(pentamethylcyclopentadienyl)(1,6,6-triethyl-1,5,6,7-tetrahydro-s-indacenyl)hafnium dimethyl,
(pentamethylcyclopentadienyl)(1-isobutyl-6,6-diethyl-1,5,6,7-tetrahydro-s-indacenyl)hafnium dimethyl,
(pentamethylcyclopentadienyl)(1-methylindenyl)hafnium dimethyl,
(pentamethylcyclopentadienyl)(1-isobutylindenyl)hafnium dimethyl,
(pentamethylcyclopentadienyl)(1-methyl-3,6,7,8-tetrahydro-as-indacenyl)hafnium dimethyl,
(pentamethylcyclopentadienyl)(1-isobutyl-3,6,7,8-tetrahydro-as-indacenyl)hafnium dimethyl,
(pentamethylcyclopentadienyl)(1-methyl-5,6,7,8-tetrahydro-1H-cyclopenta[b]naphthalene)hafnium dimethyl,
(pentamethylcyclopentadienyl)(1-isobutyl-5,6,7,8-tetrahydro-1H-cyclopenta[b]naphthalene)hafnium dimethyl,
(pentamethylcyclopentadienyl)(1-methyl-6,7,8,9-tetrahydro-1H-cyclopenta[a]naphthalene)hafnium dimethyl,
(pentamethylcyclopentadienyl)(1-isobutyl-6,7,8,9-tetrahydro-1H-cyclopenta[a]naphthalene)hafnium dimethyl,
(pentamethylcyclopentadienyl)(1,5,6-trimethylindenyl)hafnium dimethyl, and
(pentamethylcyclopentadienyl)(1-isobuty-5,6-dimethyllindenyl)hafnium dimethyl.

50. (canceled)

51. The process of claim 1, wherein the catalyst system comprises an activator.

52. The process of claim 51, wherein the activator is selected from:
[N,N-di(hydrogenated tallow)methylammonium][tetrakis(perfluorophenyl)borate],
[N-methyl-4-nonadecyl-N-octadecylanilinium][tetrakis(perfluorophenyl)borate],
[N-methyl-4-hexadecyl-N-octadecylanilinium][tetrakis(perfluorophenyl)borate],
[N-methyl-4-tetradecyl-N-octadecylanilinium][tetrakis(perfluorophenyl)borate],
[N-methyl-4-dodecyl-N-octadecylanilinium][tetrakis(perfluorophenyl)borate],
[N-methyl-4-decyl-N-octadecylanilinium][tetrakis(perfluorophenyl)borate],
[N-methyl-4-octyl-N-octadecylanilinium][tetrakis(perfluorophenyl)borate],
[N-methyl-4-hexyl-N-octadecylanilinium][tetrakis(perfluorophenyl)borate],
[N-methyl-4-butyl-N-octadecylanilinium][tetrakis(perfluorophenyl)borate],
[N-methyl-4-octadecyl-N-decylanilinium][tetrakis(perfluorophenyl)borate],
[N-methyl-4-nonadecyl-N-dodecylanilinium][tetrakis(perfluorophenyl)borate],
[N-methyl-4-nonadecyl-N-tetradecylanilinium][tetrakis(perfluorophenyl)borate],
[N-methyl-4-nonadecyl-N-hexadecylanilinium][tetrakis(perfluorophenyl)borate],
[N-ethyl-4-nonadecyl-N-octadecylanilinium][tetrakis(perfluorophenyl)borate],
[N-methyl-N,N-dioctadecylammonium][tetrakis(perfluorophenyl)borate],
[N-methyl-N,N-dihexadecylammonium][tetrakis(perfluorophenyl)borate],
[N-methyl-N,N-ditetradecylammonium][tetrakis(perfluorophenyl)borate],
[N-methyl-N,N-didodecylammonium][tetrakis(perfluorophenyl)borate],
[N-methyl-N,N-didecylammonium][tetrakis(perfluorophenyl)borate],
[N-methyl-N,N-dioctylammonium][tetrakis(perfluorophenyl)borate],
[N-ethyl-N,N-dioctadecylammonium][tetrakis(perfluorophenyl)borate],
[N,N-di(octadecyl)tolylammonium][tetrakis(perfluorophenyl)borate],
[N,N-di(hexadecyl)tolylammonium][tetrakis(perfluorophenyl)borate],
[N,N-di(tetradecyl)tolylammonium][tetrakis(perfluorophenyl)borate],
[N,N-di(dodecyl)tolylammonium][tetrakis(perfluorophenyl)borate],
[N-octadecyl-N-hexadecyl-tolylammonium][tetrakis(perfluorophenyl)borate],
[N-octadecyl-N-hexadecyl-tolylammonium][tetrakis(perfluorophenyl)borate],
[N-octadecyl-N-tetradecyl-tolylammonium][tetrakis(perfluorophenyl)borate],
[N-octadecyl-N-dodecyl-tolylammonium][tetrakis(perfluorophenyl)borate],
[N-octadecyl-N-decyl-tolylammonium][tetrakis(perfluorophenyl)borate],
[N-hexadecyl-N-tetradecyl-tolylammonium][tetrakis(perfluorophenyl)borate],
[N-hexadecyl-N-dodecyl-tolylammonium][tetrakis(perfluorophenyl)borate],
[N-hexadecyl-N-decyl-tolylammonium][tetrakis(perfluorophenyl)borate],
[N-tetradecyl-N-dodecyl-tolylammonium][tetrakis(perfluorophenyl)borate],
[N-tetradecyl-N-decyl-tolylammonium][tetrakis(perfluorophenyl)borate],
[N-dodecyl-N-decyl-tolylammonium][tetrakis(perfluorophenyl)borate],
[N-methyl-N-octadecylanilinium][tetrakis(perfluorophenyl)borate],
[N-methyl-N-hexadecylanilinium][tetrakis(perfluorophenyl)borate],
[N-methyl-N-tetradecylanilinium][tetrakis(perfluorophenyl)borate],
[N-methyl-N-dodecylanilinium][tetrakis(perfluorophenyl)borate],
[N-methyl-N-decylanilinium][tetrakis(perfluorophenyl)borate],
[N-methyl-N-octylanilinium][tetrakis(perfluorophenyl)borate],
N,N-dimethylanilinium tetrakis(perfluorophenyl)borate,
N,N-dimethylanilinium tetrakis(3,5-bis(trifluoromethyl)phenyl)borate,
triphenylcarbenium tetrakis(3,5-bis(trifluoromethyl)phenyl)borate,
triphenylcarbenium tetrakis(perfluorophenyl)borate,
trimethylammonium tetrakis(perfluorophenyl)borate, and
tri-n-butylammonium tetrakis(perfluorophenyl)borate.

53-54. (canceled)

55. The process of claim 1, wherein the process is a continuous process, a batch process, or a semi-batch process.

56. The process of claim 55, wherein the process is a continuous process comprising: continuously introducing the feed into the polymerization reactor, continuously introducing the catalyst system into the polymerization reactor, and continuously withdrawing the polymerization reaction mixture from the polymerization reactor.

57. The process of claim 56, wherein the polymerization reactor comprises a continuous stirred tank reactor or a plug flow reactor.

58. (canceled)

59. The process of claim 55, wherein the process is a batch process or a semi-batch process, comprising:
introducing two or more different alpha-olefins into the polymerization reactor,
adding the catalyst system into the polymerization reactor, and
stirring the polymerization reactor contents for about 10 minutes to about 24 hours prior to withdrawing the polymerization reaction mixture from the polymerization reactor.

60-65. (canceled)

66. The process of claim 55, wherein the polymerization reaction conditions comprise a temperature of 120° C. or greater, 130° C. or greater, or 140° C. or greater; and/or a reactor pressure of 15 psia to 1600 psia.

67-70. (canceled)

71. A poly alpha-olefin (PAO) produced from a process comprising:
contacting a feed comprising one or more C₆-C₃₂ cyclic alpha-olefins and one or more C₄-C₃₂ linear and/or branched alpha-olefins with a catalyst system comprising a metallocene compound in a polymerization reactor under polymerization conditions to effect a polymerization reaction to obtain a polymerization reaction mixture, the polymerization reaction mixture comprising a mixture of PAOs having vinylidenes, tri-substituted vinylenes, di-substituted vinylenes and optionally vinyl unsaturation, and
optionally obtaining an unsaturated PAO product from the polymerization reaction mixture.

72. (canceled)

73. The PAO produced from a process of claim 71, wherein one of the one or more C₆-C₃₂ cyclic alpha-olefins comprises a ring unsaturation, and wherein the unsaturated PAO product further comprises cyclic di-substituted vinylenes.

74. The PAO produced from a process of claim 71, wherein the unsaturated PAO product comprises dimer and/or trimer molecules having vinylidenes, tri-substituted vinylenes, di-substituted vinylenes, and optionally vinyl unsaturation.

75. The PAO produced from a process of claim 71, wherein the unsaturated PAO product comprises one or more compounds represented by CC-v, LC-v, CL-v, CC-t1, LC-t1, CL-t1, CC-t2, LC-t2, CL-t2, LL-v, LL-t1, LL-t2, CC_{2,1}-t1, CC_{2,1}-v11, CC_{2,1}-v12, CC_{2,1}-v13, CC_{2,1}-v11, LC_{2,1}-v11, LC_{2,1}-v12, LC_{2,1}-v13, LL-vd, LVCH-iso, and/or VCHx2-isom,
wherein the cyclic monomer fragments (A) and (B) are independently saturated if the cyclic alpha-olefin has a saturated ring structure or partially unsaturated if the cyclic alpha-olefin has a partially unsaturated ring structure, 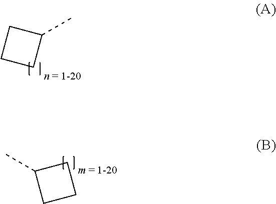
n and m represent the number of additional carbon atoms in the ring structure of cyclic monomer fragments (A) and (B), respectively, and independently represent an integer from 1 to 20,
R is a C₂-C₃₀ hydrocarbyl group,
R′ is a C₁-C₂₉ hydrocarbyl group, and
at least one of CL-v and LC-v are present in the unsaturated PAO product or a mixture thereof.

76. The PAO produced from a process of claim 75, wherein n and m independently represent an integer from 1 to 5, R is a C₂-C₈ hydrocarbyl group, and R′ is a C₁-C₇ hydrocarbyl group.

77. The PAO produced from a process of claim 75, wherein n and m are 3, R is a C₃-C₈ hydrocarbyl group, R′ is a C₂-C₇ hydrocarbyl group, and the cyclic monomer fragments (A) and (B) have a partially unsaturated ring structure.

78. The PAO produced from a process of claim 75, wherein LL-v is present in the unsaturated PAO product or a mixture thereof.

79. The PAO produced from a process of claim 75, wherein CC-v and LL-v are present in the unsaturated PAO product or a mixture thereof.

80. The PAO produced from a process of claim 71, wherein the unsaturated PAO product comprises greater than or equal to 60 mol %, 70 mol %, or 80 mol % vinylidenes and tri-substituted vinylenes and less than or equal to 10 mol % vinyls, based on total moles of vinyls, vinylidenes, non-cyclic di-substituted vinylenes, and tri-substituted vinylenes in the unsaturated PAO product.

81. The PAO produced from a process of claim 71, wherein the unsaturated PAO product comprises greater than or equal to 50%, 60%, 70%, 80%, 90%, or 95% dimers based on a total amount of dimers, trimer, tetramers, and higher oligomers in the unsaturated PAO product as measured by GC-MS.

82. The PAO produced from a process of claim 71, wherein the unsaturated PAO product comprises greater than or equal to 70%, 80%, 85%, 90%, 95%, or 97% dimers and trimers, based on the total amount of dimers, trimer, tetramers, and higher oligomers the PAO product as measured by GC-MS.

83. The PAO produced from a process of claim 71, wherein the unsaturated PAO product comprises one or more of:
first dimers (CC) formed by a reaction of two of the one or more C₆-C₃₂ cyclic alpha-olefins;
second dimers (CL) formed by a reaction of one of the C₆-C₃₂ cyclic alpha-olefins and one of the C₄-C₃₂ linear and/or branched alpha-olefins; and
third dimers (LL) formed by two of the C₄-C₃₂ linear and/or branched alpha-olefins.

84. The PAO produced from a process of claim 83, wherein a percentage of CL in the unsaturated PAO product, based on CC+CL+LL equaling 100%, is 20% or greater, 30% or greater, 40% or greater, 50% or greater, 60% or greater, 70% or greater, or 80% or greater based on GC-MS.

85. The PAO produced from a process of claim 83, wherein a percentage of CC in the unsaturated PAO product, based on CC+CL+LL equaling 100%, is 0% or greater and 35% or less, 30% or less, 25% or less, 20% or less, 15% or less, 10% or less, or 5% or less based on GC-MS.

86. The PAO produced from a process of claim 83, wherein a percentage of LL in the unsaturated PAO product, based on CC+CL+LL equaling 100%, is 10% or greater and 80% or less, 70% or less, 60% or less, 50% or less, 40% or less, 30% or less, or 20% or less based on GC-MS.

87-212. (canceled)
